(19) United States
(12) Patent Application Publication
(10) Pub. No.: US 2025/0351878 A1
(43) Pub. Date: Nov. 20, 2025

(54) AEROSOL-GENERATING SYSTEM WITH A PIN HEATER AND A NARROW CONSUMABLE

(71) Applicant: Philip Morris Products S.A., Neuchatel (CH)

(72) Inventors: Matteo BOLOGNA, Lausanne (CH); Farhang MOHSENI, Neuchâtel (CH); Jerome UTHURRY, Neuchâtel (CH)

(73) Assignee: Philip Morris Products S.A., Neuchatel (CH)

(21) Appl. No.: 19/122,465

(22) PCT Filed: Oct. 27, 2023
(86) PCT No.: PCT/EP2023/080155

§ 371 Date: Apr. 18, 2025

(30) Foreign Application Priority Data
Oct. 27, 2022 (EP) 22204177.4

(51) Int. Cl. A24F 40/46; A24D 1/20; A24F 40/20; A24F 40/465; H05B 3/42

(52) U.S. Cl. CPC A24F 40/46; A24D 1/20; A24F 40/20; A24F 40/465; H05B 3/42

(57) ABSTRACT

An aerosol-generating system is provided, including: an aerosol-generating article including a rod of aerosol-generating substrate having a rod width of less than or equal to 7 millimetres; and an aerosol-generating device including a heating element in the form of a pin configured for insertion into the rod of aerosol-generating substrate of the aerosol-generating article, the pin having a pin width that is greater than or equal to 2.5 millimetres.

The present disclosure relates to an aerosol-generating system comprising an aerosol-generating article and an aerosol-generating device.

It is known to provide an aerosol-generating device for generating an inhalable vapor. Such a device may heat an aerosol-generating substrate contained in an aerosol-generating article without burning the aerosol-generating substrate. The aerosol-generating article may have a rod shape configured for insertion of a portion of the aerosol-generating article into a device cavity of the aerosol-generating device. The aerosol-generating device may also comprise a heating element. The heating element may be in the form of a pin configured for insertion into the rod of aerosol-generating substrate. The pin may be located in the device cavity. When the aerosol-generating substrate of the aerosol-generating article is received in the device cavity, the pin heating element may penetrate the aerosol-generating substrate, and be inserted into the aerosol-generating substrate to heat the aerosol-generating substrate from the inside.

During use, the outer, peripheral portions of the aerosol-generating substrate furthest away from the pin heating element may not receive sufficient heat from the pin heating element to vaporize the volatile compounds in the substrate to form aerosol.

It would be desirable to provide an aerosol-generating system that provides improved heating of an aerosol-generating substrate in an aerosol-generating article. It would also be desirable to provide an aerosol-generating system that provides more homogenous heating of an aerosol-generating substrate in an aerosol-generating article. It would also be desirable to reduce or eliminate waste of aerosol-generating substrate in an aerosol-generating system. It would also be desirable to provide an aerosol-generating system which requires less aerosol-generating substrate to deliver a desired amount of aerosol.

According to the present invention there is provided an aerosol-generating system. The aerosol-generating system may comprise an aerosol-generating article and an aerosol-generating device. The aerosol-generating article may comprise a rod of aerosol-generating substrate having a rod width. The aerosol-generating device may comprise a heating element in the form of a pin. The pin may have a pin width. The pin may be configured for insertion into the rod of aerosol-generating substrate of the aerosol-generating article.

According to the present invention there is provided an aerosol-generating system. The aerosol-generating system comprises an aerosol-generating article and an aerosol-generating device. The aerosol-generating article comprises a rod of aerosol-generating substrate having a rod width. The rod width is less than or equal to 7 millimetres. The aerosol-generating device comprises a heating element in the form of a pin. The pin has a pin width. The pin is configured for insertion into the rod of aerosol-generating substrate of the aerosol-generating article. The pin width is greater than or equal to 2.5 millimetres.

Advantageously, providing an aerosol-generating article with a rod of aerosol-generating substrate having a rod width of less than or equal to 7 millimetres, and an aerosol-generating device with a heating element in the form of a pin having a pin width of greater than or equal to 2.5 millimetres may provide improved heat transfer from the pin to the outer, peripheral portions of the rod of aerosol-generating substrate. It has been surprisingly found through experimental data that such improved heat transfer may provide more efficient aerosol delivery, and an increased amount of aerosol delivered per unit mass of aerosol-generating substrate. This may also result in a more homogenous heating of the rod of aerosol-generating substrate.

Improved heat transfer from the pin to the outer, peripheral portions of the aerosol-generating substrate may reduce the amount of aerosol-generating substrate in the aerosol-generating article that is wasted due to not being heated to the necessary temperature to vaporise the volatile compounds and generate aerosol. Reducing the amount of wasted aerosol-generating substrate may enable the amount of aerosol-generating substrate provided in the aerosol-generating article to be reduced, which may also reduce the cost of the aerosol-generating article.

Improved heat transfer from the pin to the outer, peripheral portions of the rod of aerosol-generating substrate may enable less power to be used to generate a desired amount of aerosol from a given amount of aerosol-generating substrate. Reducing power usage may increase the duration of use of the aerosol-generating device before recharging or replacement of the power source is required. Reducing power usage may enable the size of the power source to be reduced. This may enable the overall size of the aerosol-generating device to be reduced.

As used herein, the term ‘aerosol-generating substrate’ denotes a substrate capable of releasing volatile compounds upon heating, which can condense to form an aerosol.

As used herein, the term “aerosol” denotes a dispersion of solid particles, or liquid droplets, or a combination of solid particles and liquid droplets, in a gas. The aerosol may be visible or invisible. The aerosol may include vapours of substances that are ordinarily liquid or solid at room temperature as well as solid particles, or liquid droplets, or a combination of solid particles and liquid droplets.

As used herein, the term “aerosol-generating article” denotes an article comprising an aerosol-generating substrate that is capable of releasing volatile compounds that can form an aerosol. An aerosol-generating article may be disposable.

As used herein, the term “aerosol-generating device” denotes a device that interacts with an aerosol-generating substrate to generate an aerosol. An aerosol-generating device may interact with an aerosol-generating article comprising an aerosol-generating substrate. In some examples, the aerosol-generating device heats the aerosol-generating substrate to facilitate release of volatile compounds from the substrate.

As used herein, the term “aerosol-generating system” denotes a combination of an aerosol-generating device and an aerosol-generating substrate. When the aerosol-generating substrate forms part of an aerosol-generating article, the aerosol-generating system refers to the combination of the aerosol-generating device and the aerosol-generating article. In the aerosol-generating system, the aerosol-generating substrate and the aerosol-generating device cooperate to generate an aerosol.

As used herein, the terms ‘upstream’, ‘downstream’, proximal' and ‘distal’ are used to describe the relative positions of elements, or portions of elements, of aerosol-generating articles, aerosol-generating devices and aerosol-generating systems according to the disclosure. Aerosol-generating articles as described herein comprise a proximal end through which, in use, an aerosol exits the aerosol-generating article. The proximal end may also be referred to as the mouth end. In use, a user draws on the proximal end or mouth end of the aerosol-generating article in order to inhale an aerosol generated by the aerosol-generating article. The aerosol-generating article comprises a distal end opposite the proximal end or mouth end. The proximal end or mouth end of the aerosol-generating article may also be referred to as the downstream end. The distal end of the aerosol-generating article may also be referred to as the upstream end. Components, or portions of components, of the aerosol-generating article may be described as being upstream or downstream of one another based on their relative positions between the proximal or downstream end and the distal or upstream end of the aerosol-generating article.

As used herein the term ‘longitudinal’ is used to describe the direction between the downstream end or proximal end and the opposed upstream end or distal end of aerosol-generating articles, aerosol-generating devices and aerosol-generating systems according to the invention.

As used herein, the term ‘length’ is used to describe the maximum dimension of elements, or portions of elements, of aerosol-generating articles, aerosol-generating devices and aerosol-generating systems according to the disclosure in the longitudinal direction.

As used herein, the term ‘transverse’ is used to describe the direction perpendicular to the longitudinal direction.

As used herein, the term ‘width’ is used to describe the maximum transverse dimension of elements, or portions of elements, of aerosol-generating articles, aerosol-generating devices and aerosol-generating systems according to the disclosure. For the avoidance of doubt, as used herein the term ‘diameter’ may also be used to refer to the ‘width’ of elements, or portions of elements, of aerosol-generating articles, aerosol-generating devices and aerosol-generating systems according to the disclosure, which have a circular transverse cross-section.

Unless otherwise stated, references to the “cross-section” of the aerosol-generating article or a component of the aerosol-generating article refer to the transverse cross-section, perpendicular to the longitudinal direction or axis.

The rod of aerosol-generating substrate has a rod width. The rod of aerosol-generating substrate may also have a rod length. The rod length is the maximum dimension of the rod in a longitudinal direction of the aerosol-generating article. The rod width is the maximum dimension of the rod in a transverse direction, perpendicular to the longitudinal direction.

For the avoidance of doubt, the rod width before the pin heating element is inserted into the rod is substantially the same as the rod width when the pin heating element is fully inserted into the rod.

The rod width may be substantially uniform along the length of the rod.

The rod width may be measured at a position 50% along the length of the rod from an end of the rod.

The rod width may be greater than or equal to 5 millimetres, greater than or equal to 5.3 millimetres, greater than or equal to 5.5 millimetres, greater than or equal to 5.7 millimetres, greater than or equal to 6.1 millimetres, greater than or equal to 6.3 millimetres, or greater than or equal to 6.7 millimetres.

The rod width is less than or equal to 7 millimetres, and may be less than or equal to 6.7 millimetres, less than or equal to 6.3 millimetres, less than or equal to 6.1 millimetres, less than or equal to 5.7 millimetres, less than or equal to 5.5 millimetres, less than or equal to 5.3 millimetres or less than or equal to 5 millimetres.

The rod width may be between 5 millimetres and 7 millimetres, between 5 millimetres and 6.7 millimetres, between 5 millimetres and 6.3 millimetres, between 5 millimetres and 6.1 millimetres, between 5 millimetres and 5.7 millimetres, between 5 millimetres and 5.5 millimetres, between 5 millimetres and 5.3 millimetres, between 5.3 millimetres and 7 millimetres, between 5.3 millimetres and 6.7 millimetres, between 5.3 millimetres and 6.3 millimetres, between 5.3 millimetres and 6.1 millimetres, optionally between 5.3 millimetres and 5.7 millimetres, between 5.3 millimetres and 5.5 millimetres, between 5.5 millimetres and 7 millimetres, between 5.5 millimetres and 6.7 millimetres, between 5.5 millimetres and 6.3 millimetres, between 5.5 millimetres and 6.1 millimetres, between 5.5 millimetres and 5.7 millimetres, between 5.7 millimetres and 7 millimetres, between 5.7 millimetres and 6.7 millimetres, between 5.7 millimetres and 6.3 millimetres, between 5.7 millimetres and 6.1 millimetres, between 6.1 millimetres and 7 millimetres, between 6.1 millimetres and 6.7 millimetres, between 6.1 millimetres and 6.3 millimetres, between 6.3 millimetres and 7 millimetres, between 6.3 millimetres and 6.7 millimetres, or between 6.7 millimetres and 7 millimetres.

The aerosol-generating system has a rod cross-sectional area perpendicular to the rod length. The rod cross-sectional area may be the cross-sectional area of the rod measured at a position 50 percent along the length of the rod from an end of the rod.

The rod cross-sectional area may be substantially uniform along the rod length.

The rod cross-sectional area may be less than or equal to 38.5 millimetres squared, less than or equal to 35.3 millimetres squared, less than or equal to 31.2 millimetres squared, less than or equal to 29.2 millimetres squared, less than or equal to 25.5 millimetres squared, less than or equal to 23.8 millimetres squared, less than or equal to 22.1 millimetres squared, or less than or equal to 19.6 millimetres squared.

The rod cross-sectional area may be greater than or equal to 19.6 millimetres squared, greater than or equal to 22.1 millimetres squared, greater than or equal to 23.8 millimetres squared, greater than or equal to 25.5 millimetres squared, greater than or equal to 29.2 millimetres squared, greater than or equal to 31.2 millimetres squared, or greater than or equal to 35.3 millimetres squared.

The rod cross-sectional area may be between 19.6 millimetres squared and 38.5 millimetres squared, between 19.6 millimetres squared and 35.3 millimetres squared, between 19.6 millimetres squared and 31.2 millimetres squared, between 19.6 millimetres squared and 29.2 millimetres squared, between 19.6 millimetres squared and 25.5 millimetres squared, between 19.6 millimetres squared and 23.8 millimetres squared, between 19.6 millimetres squared and 22.1 millimetres squared, between 22.1 millimetres squared and 38.5 millimetres squared, between 22.1 millimetres squared and 35.3 millimetres squared, between 22.1 millimetres squared and 31.2 millimetres squared, between 22.1 millimetres squared and 29.2 millimetres squared, between 22.1 millimetres squared and 25.5 millimetres squared, between 22.1 millimetres squared and 23.8 millimetres squared, between 23.8 millimetres squared and 38.5 millimetres squared, between 23.8 millimetres squared and 35.3 millimetres squared, between 23.8 millimetres squared and 31.2 millimetres squared, between 23.8 millimetres squared and 29.2 millimetres squared, between 23.8 millimetres squared and 25.5 millimetres squared, between 25.5 millimetres squared and 38.5 millimetres squared, between 25.5 millimetres squared and 35.3 millimetres squared, between 25.5 millimetres squared and 31.2 millimetres squared, between 25.5 millimetres squared and 29.2 millimetres squared, between 29.2 millimetres squared and 38.5 millimetres squared, between 29.2 millimetres squared and 35.3 millimetres squared, between 29.2 millimetres squared and 31.2 millimetres squared, between 31.2 millimetres squared and 38.5 millimetres squared, between 31.2 millimetres squared and 35.3 millimetres squared, or between 35.3 millimetres squared and 38.5 millimetres squared.

The pin has a pin width. The pin may also have a pin length. The pin length is the maximum dimension of the pin in a longitudinal direction of the aerosol-generating device. The pin width is the maximum dimension of the pin in a transverse direction, perpendicular to the longitudinal direction.

The pin may have a tip. The tip may have a tip length. The tip may be configured to penetrate the rod of aerosol-generating substrate. The end of the tip may be defined as the most extreme point along the tip length. The end of the tip may be defined as the most extreme point of the pin along the pin length. The tip may be one of tapered, pointed or sharpened towards the end of the tip. The tip may be defined as the portion of the pin along which the width of the pin decreases. The tip may be defined as the portion of the pin which is tapered, pointed or sharpened.

The tip may have a tip length of greater than or equal to 0.1 millimetres, greater than or equal to 0.2 millimetres, greater than or equal to 0.5 millimetres, greater than or equal to 0.8 millimetres, greater than or equal to 1 millimetre, greater than or equal to 1.2 millimetres, or greater than or equal to 1.5 millimetres.

The tip may have a tip length of less than or equal to 1.8 millimetres, less than or equal to 1.5 millimetres, less than or equal to 1.2 millimetres, less than or equal to 1 millimetre, less than or equal to 0.8 millimetres, less than or equal to 0.5 millimetres, less than or equal to 0.2 millimetres, or less than or equal to 0.1 millimetres.

The tip may have a tip length of greater than or equal to 1 percent of the pin length, greater than or equal to 2 percent of the pin length, greater than or equal to 4 percent of the pin length, greater than or equal to 6 percent of the pin length, greater than or equal to 8 percent of the pin length, greater than or equal to 10 percent of the pin length, greater than or equal to 12 percent of the pin length, greater than or equal to 15 percent of the pin length, greater than or equal to 18 percent of the pin length, or greater than or equal to 20 percent of the pin length.

The tip may have a tip length of less than or equal to 25 percent of the pin length, less than or equal to 20 percent of the pin length, less than or equal to 18 percent of the pin length, less than or equal to 15 percent of the pin length, less than or equal to 12 percent of the pin length, less than or equal to 10 percent of the pin length, less than or equal to 8 percent of the pin length, less than or equal to 6 percent of the pin length, less than or equal to 4 percent of the pin length, less than or equal to 2 percent of the pin length, or less than or equal to 1 percent of the pin length.

The width of the tip measured at a distance of 1 millimetre from the end of the tip may be less than or equal to 2 millimetres, less than or equal to 1.8 millimetres, less than or equal to 1.5 millimetres, less than or equal to 1.2 millimetres, less than or equal to 1 millimetre, less than or equal to 0.8 millimetres, less than or equal to 0.5 millimetres, or less than or equal to 0.2 millimetres.

Advantageously, providing a width of the tip measured at a distance of 1 millimetre from the end of the tip which is less than or equal to 2 millimetres may facilitate ease of insertion of the pin into the rod of aerosol-generating substrate.

Returning to the pin width, it is envisioned that the pin width may be measured in various suitable ways.

The pin width may be measured at a distance of one of 2 millimetres, 3 millimetres, 4 millimetres, 5 millimetres, or 6 millimetres from the end of the tip. Preferably, the pin width may be measured at a distance of 3 millimetres, or 4 millimetres from the end of the tip, and most preferably at a distance of 4 millimetres from the end of the tip.

The pin width may be the maximum pin width. The maximum pin width refers to the largest width of the pin along the length of the pin.

The pin width may be the width of the pin measured at the position along the section of the pin that is configured to be inserted into the rod of aerosol-generating substrate that is the furthest distance from the end of the tip of the pin.

The pin width may be measured at a plurality of positions along the length of the pin excluding the tip. The pin width may be measured at more than one of a distance of 2 millimetres, 3 millimetres, 4 millimetres, 5 millimetres, or 6 millimetres from the end of the tip. The pin width may be the mean width of the pin measured at a plurality of positions along the length of the pin excluding the tip.

The pin width may be the mean width of the pin measured over at least 70 percent of the pin length, over at least 80 percent of the pin length, over at least 90 percent of the pin length, or over at least 95 percent of the pin length.

The pin width may be the pin width measured at the position 50 percent of the pin length from the end of the tip of the pin.

The pin width may be greater than or equal to 0.5 millimetres, greater than or equal to 0.8 millimetres, greater than or equal to 1.0 millimetres, greater than or equal to 1.2 millimetres, greater than or equal to 1.5 millimetres, greater than or equal to 1.8 millimetres, greater than or equal to 2.0 millimetres, greater than or equal to 2.2 millimetres.

The pin width may be greater than or equal to 2.5 millimetres.

The pin width may be greater than or equal to 2.6 millimetres, greater than or equal to 2.7 millimetres, greater than or equal to 2.8 millimetres, or greater than or equal to 2.9 millimetres.

The pin width may be less than or equal to 7.0 millimetres, less than or equal to 6.0 millimetres, less than or equal to 5.0 millimetres, less than or equal to 4.0 millimetres, less than or equal to 3.0 millimetres, less than or equal to 2.9 millimetres, less than or equal to 2.8 millimetres, less than or equal to 2.7 millimetres, or less than or equal to 2.6 millimetres.

The pin width may be between 2.5 millimetres and 7.0 millimetres, between 2.5 millimetres and 6.0 millimetres, or between 2.5 millimetres and 5.0 millimetres In some preferred embodiments, the pin width may be between 2.5 millimetres and 4.0 millimetres. The pin width may be between 2.5 millimetres and 3.5 millimetres. The pin width may be between 2.5 millimetres and 3.0 millimetres.

The ratio of the rod width to the pin width may be less than or equal to 2.8, less than or equal to 2.7, less than or equal to 2.6, less than or equal to 2.5, less than or equal to 2.4, less than or equal to 2.3, less than or equal to 2.2, less than or equal to 2.1, less than or equal to 2.0, less than or equal to 1.9, or less than or equal to 1.8.

The ratio of the rod width to the pin width may be greater than or equal to 1.6, greater than or equal to 1.7, greater than or equal to 1.8, greater than or equal to 1.9, greater than or equal to 2.0, greater than or equal to 2.1, greater than or equal to 2.2, greater than or equal to 2.3, greater than or equal to 2.4, greater than or equal to 2.5, or greater than or equal to 2.6.

The ratio of the rod width to the pin width may be between 1.6 and 2.8.

Advantageously, providing an aerosol-generating system with a rod width and a pin width having a ratio of between 1.6 and 2.8 has been found to provide particularly improved heat transfer from the pin to the outer, peripheral portions of the rod of aerosol-generating substrate. Such improved heat transfer may provide more efficient aerosol delivery, an increased amount of aerosol delivered per unit mass of aerosol-generating substrate, and a more homogenous heating of the rod of aerosol-generating substrate.

The pin may have a minimum transverse pin dimension. The minimum transverse pin dimension is the minimum dimension of the pin in a transverse direction, perpendicular to the longitudinal direction. In other words, the minimum transverse dimension of the pin is the minimum cross-sectional dimension of the pin. The minimum transverse pin dimension may be perpendicular to the pin width.

The minimum transverse pin dimension may be measured at a distance of one of 2 millimetres, 3 millimetres, 4 millimetres, 5 millimetres, or 6 millimetres from the end of the tip. Preferably, the minimum transverse pin dimension may be measured at a distance of 3 millimetres, or 4 millimetres from the end of the tip, and most preferably at a distance of 4 millimetres from the end of the tip.

The minimum transverse pin dimension may be the minimum dimension of the pin in a transverse direction of the pin along the length of the pin excluding the tip.

The minimum transverse pin dimension may be the minimum transverse pin dimension measured at the position along the section of the pin that is configured to be inserted into the rod of aerosol-generating substrate that is the furthest distance from the end of the tip of the pin.

The minimum transverse pin dimension may be the mean minimum transverse pin dimension measured over at least 70 percent of the pin length excluding the tip, over at least 80 percent of the pin length excluding the tip, over at least 90 percent of the pin length excluding the tip, or over at least 95 percent of the pin length excluding the tip.

The minimum transverse pin dimension may be the minimum transverse pin dimension measured at the position 50 percent of the pin length from the end of the tip of the pin.

The minimum transverse pin dimension may be greater than or equal to 1.6 millimetres, greater than or equal to 1.7 millimetres, greater than or equal to 1.8 millimetres, greater than or equal to 1.9 millimetres, greater than or equal to 2.0 millimetres, greater than or equal to 2.1 millimetres, greater than or equal to 2.2 millimetres, greater than or equal to 2.3 millimetres, greater than or equal to 2.4 millimetres, greater than or equal to 2.5 millimetres, greater than or equal to 2.6 millimetres, greater than or equal to 2.7 millimetres, greater than or equal to 2.8 millimetres, or greater than or equal to 2.9 millimetres. The minimum transverse pin dimension may be less than or equal to 3.0 millimetres. The minimum transverse pin dimension may be between 2.5 millimetres and 3.0 millimetres.

The pin has a pin cross-sectional area perpendicular to the pin length.

It is envisioned that the pin cross-sectional area may be measured in various suitable ways.

The pin cross-sectional area may be measured at a distance of one of 2 millimetres, 3 millimetres, 4 millimetres, 5 millimetres, or 6 millimetres from the end of the tip of the pin. Preferably, the pin cross-sectional area may be measured at a distance of 3 millimetres, or 4 millimetres from the end of the tip, and most preferably at a distance of 4 millimetres from the end of the tip.

The pin cross-sectional area may be the maximum pin cross-sectional area. The maximum pin cross-sectional area refers to the largest cross-sectional area of the pin along the length of the pin.

The pin cross-sectional area may be the pin cross-sectional area measured at the position along the section of the pin that is configured to be inserted into the rod of aerosol-generating substrate that is the furthest distance from the end of the tip of the pin.

The pin cross-sectional area may be the mean cross-sectional area of the pin measured over at least 70 percent of the pin length, over at least 80 percent of the pin length, over at least 90 percent of the pin length, or over at least 95 percent of the pin length.

The pin cross-sectional area may be the pin cross-sectional area measured at the position 50 percent of the pin length from the end of the tip.

The pin cross-sectional area may be greater than or equal to 0.2 millimetres squared, greater than or equal to 0.5 millimetres squared, greater than or equal to 0.8 millimetres squared, greater than or equal to 1.1 millimetres squared, greater than or equal to 1.8 millimetres squared, greater than or equal to 2.5 millimetres squared, greater than or equal to 3.1 millimetres squared, or greater than or equal to 3.8 millimetres squared.

The pin cross-sectional area may be greater than or equal to 4.9 millimetres squared.

The pin cross-sectional area may be less than or equal to 38.5 millimetres squared, less than or equal to 28.3 millimetres squared, less than or equal to 19.6 millimetres squared, or less than or equal to 12.6 millimetres squared.

The pin cross-sectional area may be less than or equal to 7.1 millimetres squared. The pin cross-sectional area may be between 4.9 millimetres squared and 7.1 millimetres squared.

The ratio of the rod cross-sectional area to the pin cross sectional area may be less than or equal to 7.9, less than or equal to 7.5, less than or equal to 7.0, less than or equal to 6.5, less than or equal to 6.0, less than or equal to 5.5, less than or equal to 5.0, less than or equal to 4.5, less than or equal to 4.0, less than or equal to 3.5, or less than or equal to 3.0.

The ratio of the rod cross-sectional area to the pin cross sectional area may be greater than or equal to 2.8, greater than or equal to 3.0, greater than or equal to 3.5, greater than or equal to 4.0, greater than or equal to 4.5, greater than or equal to 5.0, greater than or equal to 5.5, greater than or equal to 6.0, greater than or equal to 6.5, greater than or equal to 7.0, or greater than or equal to 7.5.

The ratio of the rod cross-sectional area to the pin cross-sectional area may be between 2.8 and 7.9.

Advantageously, providing an aerosol-generating system with a rod cross-sectional area and a pin cross-sectional area having a ratio of between 1.6 and 2.8 has been found to provide particularly improved heat transfer from the pin to the outer, peripheral portions of the rod of aerosol-generating substrate. Such improved heat transfer may provide more efficient aerosol delivery, an increased amount of aerosol delivered per unit mass of aerosol-generating substrate, and a more homogenous heating of the rod of aerosol-generating substrate.

The cross-sectional area of the pin measured at a distance of 1 millimetre from the end of the tip may be less than or equal to 3.1 millimetres squared, less than or equal to 2.5 millimetres squared, less than or equal to 1.8 millimetres squared, less than or equal to 1.1 millimetres squared, less than or equal to 0.8 millimetres squared, less than or equal to 0.5 millimetres squared, or less than or equal to 0.2 millimetres squared.

Advantageously, providing a cross-sectional area of the pin measured at a distance of 1 millimetre from the end of the tip which is less than or equal to 3.1 millimetres squared may facilitate ease of insertion of the pin into the rod of aerosol-generating substrate.

The rod of aerosol-generating substrate may have one of a polygonal cross-sectional shape, a substantially triangular cross-sectional shape, a substantially oval cross-sectional shape, a substantially rectangular cross-sectional shape, or a substantially circular cross-sectional shape. Preferably, the rod of aerosol-generating substrate has a substantially circular cross-sectional shape.

The rod length may be greater than or equal to 1 millimetre, greater than or equal to 3 millimetres, greater than or equal to 5 millimetres, greater than or equal to 7 millimetres, greater than or equal to 9 millimetres, greater than or equal to 10 millimetres, greater than or equal to 11 millimetres, greater than or equal to 12 millimetres, greater than or equal to 13 millimetres, greater than or equal to 14 millimetres, greater than or equal to 15 millimetres, greater than or equal to 16 millimetres, greater than or equal to 18 millimetres, greater than or equal to 20 millimetres, greater than or equal to 22 millimetres, greater than or equal to 25 millimetres, or greater than or equal to 28 millimetres.

The rod length may be less than or equal to 3 millimetres, less than or equal to 5 millimetres, less than or equal to 7 millimetres, less than or equal to 9 millimetres, less than or equal to 10 millimetres, less than or equal to 11 millimetres, less than or equal to 12 millimetres, less than or equal to 13 millimetres, less than or equal to 14 millimetres, less than or equal to 15 millimetres, less than or equal to 16 millimetres, less than or equal to 18 millimetres, less than or equal to 20 millimetres, less than or equal to 22 millimetres, less than or equal to 25 millimetres, or less than or equal to 30 millimetres. The rod length may be between 1 millimetre and 30 millimetres, between 5 millimetres and 22 millimetres, between 8 millimetres and 16 millimetres, between 9 millimetres and 15 millimetres, between 10 millimetres and 14 millimetres, between 11 millimetres and 13 millimetres, or about 12 millimetres.

The ratio of the rod width and the rod length may be between 0.25 and 0.60, between 0.30 and 0.60, between 0.35 and 0.60, between 0.40 and 0.60, between 0.45 and 0.60, between 0.50 and 0.60, between 0.25 and 0.56, between 0.30 and 0.56, between 0.35 and 0.56, between 0.40 and 0.56, between 0.45 and 0.56, between 0.50 and 0.56, between 0.25 and 0.50, between 0.25 and 0.40 or between 0.35 and 0.50.

The rod of aerosol-generating substrate may have a volume of greater than or equal to 235 cubic millimetres, greater than or equal to 265 cubic millimetres, greater than or equal to 306 cubic millimetres, greater than or equal to 351 cubic millimetres, greater than or equal to 374 cubic millimetres, greater than or equal to 423 cubic millimetres, or greater than or equal to 462 cubic millimetres.

The rod of aerosol-generating substrate may have a volume of less than or equal to 462 cubic millimetres, less than or equal to 423 cubic millimetres, less than or equal to 374 cubic millimetres, less than or equal to 351 cubic millimetres, less than or equal to 306 cubic millimetres, less than or equal to 265 cubic millimetres, or less than or equal to 235 cubic millimetres.

The rod of aerosol-generating substrate may have a volume of between 235 cubic millimetres and 462 cubic millimetres.

The mass of aerosol-generating substrate in the rod of aerosol-generating substrate may be less than or equal to 300 milligrams, less than or equal to 280 milligrams, less than or equal to 270 milligrams, less than or equal to 260 milligrams, or less than or equal to 250 milligrams. Preferably, the mass of aerosol-generating substrate in the rod of aerosol-generating substrate is less than or equal to 220 milligrams, less than or equal to 210 milligrams, or less than or equal to 200 milligrams.

The mass of aerosol-generating substrate in the rod of aerosol-generating substrate may be between 10 milligrams and 300 milligrams, between 50 milligrams and 280 milligrams, or between 100 milligrams and 270 milligrams. Preferably, the mass of aerosol-generating substrate in the rod of aerosol-generating substrate is between 10 milligrams and 220 milligrams, between 50 milligrams and 220 milligrams, between 100 milligrams and 220 milligrams, or between 150 milligrams and 200 milligrams.

As used herein, the mass of aerosol-generating substrate in the rod of aerosol-generating substrate refers to the total mass of aerosol-generating substrate received within the volume defined by the rod of aerosol-generating substrate. To measure the mass of aerosol-generating substrate in the rod of aerosol-generating substrate, the aerosol-generating substrate is removed from the rod of aerosol-generating substrate and is weighed. This may be repeated 20 times for 20 different individual aerosol-generating articles to receive an average value. The mass of aerosol-generating substrate in the rod of aerosol-generating substrate may be the dry mass of aerosol-generating substrate in the rod of aerosol-generating substrate. The mass of the rod of aerosol-generating substrate may be determined after conditioning the aerosol-generating article in accordance with ISO Standard 3402:1999.

The mass of the rod of aerosol-generating substrate may be less than or equal to 300 milligrams, less than or equal to 280 milligrams, less than or equal to 270 milligrams, less than or equal to 260 milligrams, or less than or equal to 250 milligrams. Preferably, the mass of the rod of aerosol-generating substrate is less than or equal to 220 milligrams, less than or equal to 210 milligrams, or less than or equal to 200 milligrams.

The mass of the rod of aerosol-generating substrate may be between 10 milligrams and 300 milligrams, between 50 milligrams and 280 milligrams, or between 100 milligrams and 270 milligrams. Preferably, the mass of the rod of aerosol-generating substrate may be between 10 milligrams and 220 milligrams, between 50 milligrams and 220 milligrams, between 100 milligrams and 220 milligrams, or between 150 milligrams and 200 milligrams.

As used herein, the mass of the rod of aerosol-generating substrate refers to the total mass of material received within the volume defined by the rod of aerosol-generating substrate. This may be repeated 20 times for 20 different individual aerosol-generating articles to receive an average value. For the avoidance of doubt, if the rod of aerosol-generating substrate is circumscribed by one or more wrappers, the mass of the wrapper or wrappers themselves is not taken into account when calculating the mass of the rod of aerosol-generating substrate. The mass of the rod of aerosol-generating substrate may be the dry mass of the rod of aerosol-generating substrate. The mass of the rod of aerosol-generating substrate may be determined after conditioning the aerosol-generating article in accordance with ISO Standard 3402:1999.

The density of aerosol-generating substrate in the rod of aerosol-generating substrate before the pin heating element is inserted into the rod may be less than or equal to 500 kilograms per cubic metre (0.50 milligrams per cubic millimetre), less than or equal to 450 kilograms per cubic metre (0.45 milligrams per cubic millimetre), less than or equal to 400 kilograms per cubic metre (0.40 milligrams per cubic millimetre), or less than or equal to 350 kilograms per cubic metre (0.35 milligrams per cubic millimetre).

The density of aerosol-generating substrate in the rod of aerosol-generating substrate before the pin heating element is inserted into the rod may be greater than or equal to 350 kilograms per cubic metre (0.35 milligrams per cubic millimetre), greater than or equal to 400 kilograms per cubic metre (0.40 milligrams per cubic millimetre), or greater than or equal to 450 kilograms per cubic metre (0.45 milligrams per cubic millimetre).

The density of aerosol-generating substrate in the rod of aerosol-generating substrate before the pin heating element is inserted into the rod may be between 350 kilograms per cubic metre (0.35 milligrams per cubic millimetre) and 400 kilograms per cubic metre (0.40 milligrams per cubic millimetre), between 350 kilograms per cubic metre (0.35 milligrams per cubic millimetre) and 450 kilograms per cubic metre (0.45 milligrams per cubic millimetre), between 350 kilograms per cubic metre (0.35 milligrams per cubic millimetre) and 500 kilograms per cubic metre (0.50 milligrams per cubic millimetre), between 400 kilograms per cubic metre (0.40 milligrams per cubic millimetre) and 450 kilograms per cubic metre (0.45 milligrams per cubic millimetre), between 400 kilograms per cubic metre (0.40 milligrams per cubic millimetre) and 500 kilograms per cubic metre (0.50 milligrams per cubic millimetre), or between 450 kilograms per cubic metre (0.45 milligrams per cubic millimetre) and 500 kilograms per cubic metre (0.50 milligrams per cubic millimetre).

Advantageously, providing a density of aerosol-generating substrate in the rod of aerosol-generating substrate before the pin heating element is inserted into the rod of less than or equal to 500 kilograms per cubic metre (0.50 milligrams per cubic millimetre) may improve the ease of insertion of the heating pin into the rod of aerosol-generating substrate.

Advantageously, providing a density of aerosol-generating substrate in the rod of aerosol-generating substrate before the pin heating element is inserted into the rod of greater than or equal to 350 kilograms per cubic metre (0.35 milligrams per cubic millimetre) may improve heat transfer between the heating pin and the rod of aerosol-generating substrate.

The density of the aerosol-generating substrate in the rod of aerosol-generating substrate before the pin heating element is inserted into the rod is calculated by dividing the sum of the mass of the aerosol-generating substrate in the rod of aerosol-generating substrate by the volume of the rod of aerosol-generating substrate. The volume of the rod of aerosol-generating substrate is calculated using the dimensions of the aerosol-generating substrate. The mass of the aerosol-generating substrate in the rod of aerosol-generating substrate is determined by removing the aerosol-generating substrate from the rod of aerosol-generating substrate, and weighing the aerosol-generating substrate. This may be repeated 20 times for 20 different individual aerosol-generating articles to receive an average value for the density of the aerosol-generating substrate in the rod of aerosol-generating substrate before the pin heating element is inserted into the rod. The density of aerosol-generating substrate in the rod of aerosol-generating substrate before the pin heating element is inserted into the rod may be calculated on a dry weight basis. The density of aerosol-generating substrate in the rod of aerosol-generating substrate before the pin heating element is inserted into the rod may be determined after conditioning the aerosol-generating article in accordance with ISO Standard 3402:1999.

The density of the rod of aerosol-generating substrate before the pin heating element is inserted into the rod may be less than or equal to 500 kilograms per cubic metre (0.50 milligrams per cubic millimetre), less than or equal to 450 kilograms per cubic metre (0.45 milligrams per cubic millimetre), less than or equal to 400 kilograms per cubic metre (0.40 milligrams per cubic millimetre), or less than or equal to 350 kilograms per cubic metre (0.35 milligrams per cubic millimetre).

The density of the rod of aerosol-generating substrate before the pin heating element is inserted into the rod may be greater than or equal to 350 kilograms per cubic metre (0.35 milligrams per cubic millimetre), greater than or equal to 400 kilograms per cubic metre (0.40 milligrams per cubic millimetre), or greater than or equal to 450 kilograms per cubic metre (0.45 milligrams per cubic millimetre).

The density of the rod of aerosol-generating substrate before the pin heating element is inserted into the rod may be between 350 kilograms per cubic metre (0.35 milligrams per cubic millimetre) and 400 kilograms per cubic metre (0.40 milligrams per cubic millimetre), between 350 kilograms per cubic metre (0.35 milligrams per cubic millimetre) and 450 kilograms per cubic metre (0.45 milligrams per cubic millimetre), between 350 kilograms per cubic metre (0.35 milligrams per cubic millimetre) and 500 kilograms per cubic metre (0.50 milligrams per cubic millimetre), between 400 kilograms per cubic metre (0.40 milligrams per cubic millimetre) and 450 kilograms per cubic metre (0.45 milligrams per cubic millimetre), between 400 kilograms per cubic metre (0.40 milligrams per cubic millimetre) and 500 kilograms per cubic metre (0.50 milligrams per cubic millimetre), or between 450 kilograms per cubic metre (0.45 milligrams per cubic millimetre) and 500 kilograms per cubic metre (0.50 milligrams per cubic millimetre).

Advantageously, providing a density of the rod of aerosol-generating substrate before the pin heating element is inserted into the rod of less than or equal to 500 kilograms per cubic metre (0.50 milligrams per cubic millimetre) may improve the ease of insertion of the heating pin into the rod of aerosol-generating substrate.

Advantageously, providing a density of the rod of aerosol-generating substrate before the pin heating element is inserted into the rod of greater than or equal to 350 kilograms per cubic metre (0.35 milligrams per cubic millimetre) may improve heat transfer between the heating pin and the rod of aerosol-generating substrate.

As used herein, the density of the rod of aerosol-generating substrate before the pin heating element is inserted into the rod refers to the total mass of the rod of aerosol-generating substrate, divided by the volume of the rod of aerosol-generating substrate. This may be repeated 20 times for 20 different individual aerosol-generating articles to receive an average value. For the avoidance of doubt, if the rod of aerosol-generating substrate is circumscribed by one or more wrappers, the mass and volume of the wrapper or wrappers themselves is not taken into account when calculating the density of the rod of aerosol-generating substrate before the pin heating element is inserted into the rod. The density of the rod of aerosol-generating substrate before the pin heating element is inserted into the rod may be calculated on a dry weight basis. The density of the rod of aerosol-generating substrate before the pin heating element is inserted into the rod may be determined after conditioning the aerosol-generating article in accordance with ISO Standard 3402:1999.

The increase in density of the aerosol-generating substrate in the rod of aerosol-generating substrate from a state in which the pin heating element is not inserted into the rod to a state in which the pin heating element is fully inserted into the rod may be greater than or equal to 10 kilograms per cubic metre (0.01 milligrams per cubic millimetre), greater than or equal to 20 kilograms per cubic metre (0.02 milligrams per cubic millimetre), greater than or equal to 30 kilograms per cubic metre (0.03 milligrams per cubic millimetre), greater than or equal to 40 kilograms per cubic metre (0.04 milligrams per cubic millimetre), greater than or equal to 50 kilograms per cubic metre (0.05 milligrams per cubic millimetre), greater than or equal to 60 kilograms per cubic metre (0.06 milligrams per cubic millimetre), greater than or equal to 70 kilograms per cubic metre (0.07 milligrams per cubic millimetre), greater than or equal to 80 kilograms per cubic metre (0.08 milligrams per cubic millimetre), greater than or equal to 90 kilograms per cubic metre (0.09 milligrams per cubic millimetre), greater than or equal to 100 kilograms per cubic metre (0.10 milligrams per cubic millimetre), greater than or equal to 150 kilograms per cubic metre (0.15 milligrams per cubic millimetre), greater than or equal to 200 kilograms per cubic metre (0.20 milligrams per cubic millimetre), greater than or equal to 250 kilograms per cubic metre (0.25 milligrams per cubic millimetre), greater than or equal to 300 kilograms per cubic metre (0.30 milligrams per cubic millimetre), greater than or equal to 350 kilograms per cubic metre (0.35 milligrams per cubic millimetre), greater than or equal to 400 kilograms per cubic metre (0.40 milligrams per cubic millimetre), or greater than or equal to 450 kilograms per cubic metre (0.45 milligrams per cubic millimetre).

The increase in density of the aerosol-generating substrate in the rod of aerosol-generating substrate from a state in which the pin heating element is not inserted into the rod to a state in which the pin heating element is fully inserted into the rod may be less than or equal to 500 kilograms per cubic metre (0.50 milligrams per cubic millimetre), less than or equal to 450 kilograms per cubic metre (0.45 milligrams per cubic millimetre), less than or equal to 400 kilograms per cubic metre (0.40 milligrams per cubic millimetre), less than or equal to 350 kilograms per cubic metre (0.35 milligrams per cubic millimetre), less than or equal to 300 kilograms per cubic metre (0.30 milligrams per cubic millimetre), less than or equal to 250 kilograms per cubic metre (0.25 milligrams per cubic millimetre), less than or equal to 200 kilograms per cubic metre (0.20 milligrams per cubic millimetre), less than or equal to 150 kilograms per cubic metre (0.15 milligrams per cubic millimetre), less than or equal to 100 kilograms per cubic metre (0.10 milligrams per cubic millimetre), less than or equal to 90 kilograms per cubic metre (0.09 milligrams per cubic millimetre), less than or equal to 80 kilograms per cubic metre (0.08 milligrams per cubic millimetre), less than or equal to 70 kilograms per cubic metre (0.07 milligrams per cubic millimetre), less than or equal to 60 kilograms per cubic metre (0.06 milligrams per cubic millimetre), less than or equal to 50 kilograms per cubic metre (0.05 milligrams per cubic millimetre), less than or equal to 40 kilograms per cubic metre (0.04 milligrams per cubic millimetre), less than or equal to 30 kilograms per cubic metre (0.03 milligrams per cubic millimetre), or less than or equal to 20 kilograms per cubic metre (0.02 milligrams per cubic millimetre).

The percentage increase in density of the aerosol-generating substrate in the rod of aerosol-generating substrate from a state in which the pin heating element is not inserted into the rod to a state in which the pin heating element is fully inserted into the rod may be greater than or equal to 1 percent, greater than or equal to 2 percent, greater than or equal to 3 percent, greater than or equal to 4 percent, greater than or equal to 5 percent, greater than or equal to 6 percent, greater than or equal to 7 percent, greater than or equal to 8 percent, greater than or equal to 9 percent, greater than or equal to 10 percent, greater than or equal to 11 percent, greater than or equal to 12 percent, greater than or equal to 13 percent, greater than or equal to 14 percent, greater than or equal to 15 percent, greater than or equal to 16 percent, greater than or equal to 17 percent, greater than or equal to 18 percent, greater than or equal to 19 percent, or greater than or equal to 20 percent.

The percentage increase in density of the aerosol-generating substrate in the rod of aerosol-generating substrate from a state in which the pin heating element is not inserted into the rod to a state in which the pin heating element is fully inserted into the rod may be less than or equal to 20 percent, less than or equal to 19 percent, less than or equal to 18 percent, less than or equal to 17 percent, less than or equal to 16 percent, less than or equal to 15 percent, less than or equal to 14 percent, less than or equal to 13 percent, less than or equal to 12 percent, less than or equal to 11 percent, less than or equal to 10 percent, less than or equal to 9 percent, less than or equal to 8 percent, less than or equal to 7 percent, less than or equal to 6 percent, less than or equal to 5 percent, less than or equal to 4 percent, less than or equal to 3 percent, less than or equal to 2 percent, or less than or equal to 1 percent.

The ratio of the density of the aerosol-generating substrate in the rod of aerosol-generating substrate when the pin heating element is not inserted into the rod to the density of the aerosol-generating substrate in the rod of aerosol-generating substrate when the pin heating element is fully inserted into the rod may be greater than or equal to 1:1.02, greater than or equal to 1:1.04, greater than or equal to 1:1.06, greater than or equal to 1:1.08, greater than or equal to 1:1.10, greater than or equal to 1:1.12, greater than or equal to 1:1.14, greater than or equal to 1:1.16, greater than or equal to 1:1.18, or greater than or equal to 1:1.20.

The ratio of the density of the aerosol-generating substrate in the rod of aerosol-generating substrate when the pin heating element is not inserted into the rod to the density of the aerosol-generating substrate in the rod of aerosol-generating substrate when the pin heating element is fully inserted into the rod may be less than or equal to 1:1.20, less than or equal to 1:1.18, less than or equal to 1:1.16, less than or equal to 1:1.14, less than or equal to 1:1.12, less than or equal to 1:1.10, less than or equal to 1:1.08, less than or equal to 1:1.06, less than or equal to 1:1.04, or less than or equal to 1:1.02.

The density of aerosol-generating substrate in the rod of aerosol-generating substrate when the pin heating element is fully inserted into the rod may be less than or equal to 550 kilograms per cubic metre (0.55 milligrams per cubic millimetre), less than or equal to 500 kilograms per cubic metre (0.450 milligrams per cubic millimetre), less than or equal to 450 kilograms per cubic metre (0.45 milligrams per cubic millimetre), less than or equal to 400 kilograms per cubic metre (0.40 milligrams per cubic millimetre), or less than or equal to 350 kilograms per cubic metre (0.35 milligrams per cubic millimetre).

The density of aerosol-generating substrate in the rod of aerosol-generating substrate when the pin heating element is fully inserted into the rod may be greater than or equal to 350 kilograms per cubic metre (0.35 milligrams per cubic millimetre), greater than or equal to 400 kilograms per cubic metre (0.40 milligrams per cubic millimetre), greater than or equal to 450 kilograms per cubic metre (0.45 milligrams per cubic millimetre), or greater than or equal to 500 kilograms per cubic metre (0.450 milligrams per cubic millimetre).

The density of aerosol-generating substrate in the rod of aerosol-generating substrate when the pin heating element is fully inserted into the rod may be between 350 kilograms per cubic metre (0.35 milligrams per cubic millimetre) and 400 kilograms per cubic metre (0.40 milligrams per cubic millimetre), between 350 kilograms per cubic metre (0.35 milligrams per cubic millimetre) and 450 kilograms per cubic metre (0.45 milligrams per cubic millimetre), between 350 kilograms per cubic metre (0.35 milligrams per cubic millimetre) and 500 kilograms per cubic metre (0.50 milligrams per cubic millimetre), between 350 kilograms per cubic metre (0.35 milligrams per cubic millimetre) and 550 kilograms per cubic metre (0.55 milligrams per cubic millimetre), between 400 kilograms per cubic metre (0.40 milligrams per cubic millimetre) and 450 kilograms per cubic metre (0.45 milligrams per cubic millimetre), between 400 kilograms per cubic metre (0.40 milligrams per cubic millimetre) and 500 kilograms per cubic metre (0.50 milligrams per cubic millimetre), between 400 kilograms per cubic metre (0.40 milligrams per cubic millimetre) and 550 kilograms per cubic metre (0.55 milligrams per cubic millimetre), between 450 kilograms per cubic metre (0.45 milligrams per cubic millimetre) and 500 kilograms per cubic metre (0.50 milligrams per cubic millimetre), between 450 kilograms per cubic metre (0.45 milligrams per cubic millimetre) and 550 kilograms per cubic metre (0.55 milligrams per cubic millimetre) or between 500 kilograms per cubic metre (0.50 milligrams per cubic millimetre) and 550 kilograms per cubic metre (0.55 milligrams per cubic millimetre).

The increase in density of aerosol-generating substrate in the rod of aerosol-generating substrate from a state in which the pin heating element is not inserted into the rod to a state in which the pin heating element is fully inserted into the rod may be calculated by subtracting the density of the aerosol-generating substrate in the rod of aerosol-generating substrate before insertion of the pin into the rod from the density of the aerosol-generating substrate in the rod of aerosol-generating substrate following full insertion of the pin into the rod.

The density of the aerosol-generating substrate in the rod of aerosol-generating substrate when the pin heating element is fully inserted into the rod is calculated using substantially the same method as calculating the density of the aerosol-generating substrate in the rod of aerosol-generating substrate before insertion of the pin heating element into the rod—however the volume used in calculating the density of the aerosol-generating substrate in the rod of aerosol-generating substrate when the pin is fully inserted into the rod is the volume of the rod of aerosol-generating substrate minus the volume of the portion of the pin inserted into the rod.

The increase in density of the rod of aerosol-generating substrate from a state in which the pin heating element is not inserted into the rod to a state in which the pin heating element is fully inserted into the rod may be greater than or equal to 10 kilograms per cubic metre (0.01 milligrams per cubic millimetre), greater than or equal to 20 kilograms per cubic metre (0.02 milligrams per cubic millimetre), greater than or equal to 30 kilograms per cubic metre (0.03 milligrams per cubic millimetre), greater than or equal to 40 kilograms per cubic metre (0.04 milligrams per cubic millimetre), greater than or equal to 50 kilograms per cubic metre (0.05 milligrams per cubic millimetre), greater than or equal to 60 kilograms per cubic metre (0.06 milligrams per cubic millimetre), greater than or equal to 70 kilograms per cubic metre (0.07 milligrams per cubic millimetre), greater than or equal to 80 kilograms per cubic metre (0.08 milligrams per cubic millimetre), greater than or equal to 90 kilograms per cubic metre (0.09 milligrams per cubic millimetre), greater than or equal to 100 kilograms per cubic metre (0.10 milligrams per cubic millimetre), greater than or equal to 150 kilograms per cubic metre (0.15 milligrams per cubic millimetre), greater than or equal to 200 kilograms per cubic metre (0.20 milligrams per cubic millimetre), greater than or equal to 250 kilograms per cubic metre (0.25 milligrams per cubic millimetre), greater than or equal to 300 kilograms per cubic metre (0.30 milligrams per cubic millimetre), greater than or equal to 350 kilograms per cubic metre (0.35 milligrams per cubic millimetre), greater than or equal to 400 kilograms per cubic metre (0.40 milligrams per cubic millimetre), or greater than or equal to 450 kilograms per cubic metre (0.45 milligrams per cubic millimetre).

The increase in density of the rod of aerosol-generating substrate from a state in which the pin heating element is not inserted into the rod to a state in which the pin heating element is fully inserted into the rod may be less than or equal to 500 kilograms per cubic metre (0.50 milligrams per cubic millimetre), less than or equal to 450 kilograms per cubic metre (0.45 milligrams per cubic millimetre), less than or equal to 400 kilograms per cubic metre (0.40 milligrams per cubic millimetre), less than or equal to 350 kilograms per cubic metre (0.35 milligrams per cubic millimetre), less than or equal to 300 kilograms per cubic metre (0.30 milligrams per cubic millimetre), less than or equal to 250 kilograms per cubic metre (0.25 milligrams per cubic millimetre), less than or equal to 200 kilograms per cubic metre (0.20 milligrams per cubic millimetre), less than or equal to 150 kilograms per cubic metre (0.15 milligrams per cubic millimetre), less than or equal to 100 kilograms per cubic metre (0.10 milligrams per cubic millimetre), less than or equal to 90 kilograms per cubic metre (0.09 milligrams per cubic millimetre), less than or equal to 80 kilograms per cubic metre (0.08 milligrams per cubic millimetre), less than or equal to 70 kilograms per cubic metre (0.07 milligrams per cubic millimetre), less than or equal to 60 kilograms per cubic metre (0.06 milligrams per cubic millimetre), less than or equal to 50 kilograms per cubic metre (0.05 milligrams per cubic millimetre), less than or equal to 40 kilograms per cubic metre (0.04 milligrams per cubic millimetre), less than or equal to 30 kilograms per cubic metre (0.03 milligrams per cubic millimetre), or less than or equal to 20 kilograms per cubic metre (0.02 milligrams per cubic millimetre).

The percentage increase in density of the rod of aerosol-generating substrate from a state in which the pin heating element is not inserted into the rod to a state in which the pin heating element is fully inserted into the rod may be greater than or equal to 1 percent, greater than or equal to 2 percent, greater than or equal to 3 percent, greater than or equal to 4 percent, greater than or equal to 5 percent, greater than or equal to 6 percent, greater than or equal to 7 percent, greater than or equal to 8 percent, greater than or equal to 9 percent, greater than or equal to 10 percent, greater than or equal to 11 percent, greater than or equal to 12 percent, greater than or equal to 13 percent, greater than or equal to 14 percent, greater than or equal to 15 percent, greater than or equal to 16 percent, greater than or equal to 17 percent, greater than or equal to 18 percent, greater than or equal to 19 percent, or greater than or equal to 20 percent.

The percentage increase in density of the rod of aerosol-generating substrate from a state in which the pin heating element is not inserted into the rod to a state in which the pin heating element is fully inserted into the rod may be less than or equal to 20 percent, less than or equal to 19 percent, less than or equal to 18 percent, less than or equal to 17 percent, less than or equal to 16 percent, less than or equal to 15 percent, less than or equal to 14 percent, less than or equal to 13 percent, less than or equal to 12 percent, less than or equal to 11 percent, less than or equal to 10 percent, less than or equal to 9 percent, less than or equal to 8 percent, less than or equal to 7 percent, less than or equal to 6 percent, less than or equal to 5 percent, less than or equal to 4 percent, less than or equal to 3 percent, less than or equal to 2 percent, or less than or equal to 1 percent.

The ratio of the density of the rod of aerosol-generating substrate when the pin heating element is not inserted into the rod to the density of the rod of aerosol-generating substrate when the pin heating element is fully inserted into the rod may be greater than or equal to 1:1.02, greater than or equal to 1:1.04, greater than or equal to 1:1.06, greater than or equal to 1:1.08, greater than or equal to 1:1.10, greater than or equal to 1:1.12, greater than or equal to 1:1.14, greater than or equal to 1:1.16, greater than or equal to 1:1.18, or greater than or equal to 1:1.20.

The ratio of the density of the rod of aerosol-generating substrate when the pin heating element is not inserted into the rod to the density of the rod of aerosol-generating substrate when the pin heating element is fully inserted into the rod may be less than or equal to 1:1.20, less than or equal to 1:1.18, less than or equal to 1:1.16, less than or equal to 1:1.14, less than or equal to 1:1.12, less than or equal to 1:1.10, less than or equal to 1:1.08, less than or equal to 1:1.06, less than or equal to 1:1.04, or less than or equal to 1:1.02.

The density of the rod of aerosol-generating substrate when the pin heating element is fully inserted into the rod may be less than or equal to 550 kilograms per cubic metre (0.55 milligrams per cubic millimetre), less than or equal to 500 kilograms per cubic metre (0.450 milligrams per cubic millimetre), less than or equal to 450 kilograms per cubic metre (0.45 milligrams per cubic millimetre), less than or equal to 400 kilograms per cubic metre (0.40 milligrams per cubic millimetre), or less than or equal to 350 kilograms per cubic metre (0.35 milligrams per cubic millimetre).

The density of the rod of aerosol-generating substrate when the pin heating element is fully inserted into the rod may be greater than or equal to 350 kilograms per cubic metre (0.35 milligrams per cubic millimetre), greater than or equal to 400 kilograms per cubic metre (0.40 milligrams per cubic millimetre), greater than or equal to 450 kilograms per cubic metre (0.45 milligrams per cubic millimetre), or greater than or equal to 500 kilograms per cubic metre (0.450 milligrams per cubic millimetre).

The density of the rod of aerosol-generating substrate when the pin heating element is fully inserted into the rod may be between 350 kilograms per cubic metre (0.35 milligrams per cubic millimetre) and 400 kilograms per cubic metre (0.40 milligrams per cubic millimetre), between 350 kilograms per cubic metre (0.35 milligrams per cubic millimetre) and 450 kilograms per cubic metre (0.45 milligrams per cubic millimetre), between 350 kilograms per cubic metre (0.35 milligrams per cubic millimetre) and 500 kilograms per cubic metre (0.50 milligrams per cubic millimetre), between 350 kilograms per cubic metre (0.35 milligrams per cubic millimetre) and 550 kilograms per cubic metre (0.55 milligrams per cubic millimetre), between 400 kilograms per cubic metre (0.40 milligrams per cubic millimetre) and 450 kilograms per cubic metre (0.45 milligrams per cubic millimetre), between 400 kilograms per cubic metre (0.40 milligrams per cubic millimetre) and 500 kilograms per cubic metre (0.50 milligrams per cubic millimetre), between 400 kilograms per cubic metre (0.40 milligrams per cubic millimetre) and 550 kilograms per cubic metre (0.55 milligrams per cubic millimetre), between 450 kilograms per cubic metre (0.45 milligrams per cubic millimetre) and 500 kilograms per cubic metre (0.50 milligrams per cubic millimetre), between 450 kilograms per cubic metre (0.45 milligrams per cubic millimetre) and 550 kilograms per cubic metre (0.55 milligrams per cubic millimetre) or between 500 kilograms per cubic metre (0.50 milligrams per cubic millimetre) and 550 kilograms per cubic metre (0.55 milligrams per cubic millimetre).

The increase in density of the rod of aerosol-generating substrate from a state in which the pin heating element is not inserted into the rod to a state in which the pin heating element is fully inserted into the rod may be calculated by subtracting the density of the rod of aerosol-generating substrate before insertion of the pin into the rod from the density of the rod of aerosol-generating substrate following full insertion of the pin into the rod.

The density of the rod of aerosol-generating substrate when the pin heating element is fully inserted into the rod is calculated using substantially the same method as calculating the density of the rod of aerosol-generating substrate before insertion of the pin heating element into the rod—however the volume used in the calculation of the density of the rod of aerosol-generating substrate when the pin is fully inserted into the rod is the volume of the rod of aerosol-generating substrate minus the volume of the portion of the pin inserted into the rod.

The pin may have one of a polygonal cross-sectional shape, a substantially oval cross-sectional shape, a substantially triangular cross-sectional shape, a substantially rectangular cross-sectional shape, or a substantially circular cross-sectional shape. Preferably, the pin has a substantially circular cross-sectional shape.

Preferably, at least the portion of the pin heating element that is configured to be inserted into the rod of aerosol-generating substrate has the same cross-sectional shape as the rod of aerosol-generating substrate. The pin heating element may have the same cross-sectional shape as the rod of aerosol-generating substrate. Advantageously, providing the pin heater with a cross sectional shape that is substantially the same as the cross-sectional shape of the rod of aerosol-generating substrate may result in a more homogenous heat transfer from the pin heating element to all portions of the rod of aerosol-generating substrate. For example, providing a pin heater with a substantially circular cross section inserted in a rod of aerosol-generating substrate with a substantially circular cross section may result in a more homogenous heat transfer from the heating pin around the entire circumference of the rod of aerosol-generating substrate.

As discussed above, the pin may have a tip. The tip may be configured to penetrate the rod of aerosol-generating substrate. The tip may be one of tapered, pointed or sharpened towards the end of the tip.

The pin may have a pin length of greater than or equal to 1 millimetre, greater than or equal to 3 millimetres, greater than or equal to 5 millimetres, greater than or equal to 7 millimetres, greater than or equal to 9 millimetres, greater than or equal to 10 millimetres, greater than or equal to 11 millimetres, greater than or equal to 12 millimetres, greater than or equal to 13 millimetres, greater than or equal to 14 millimetres, greater than or equal to 15 millimetres, greater than or equal to 16 millimetres, greater than or equal to 18 millimetres, greater than or equal to 20 millimetres, greater than or equal to 22 millimetres, greater than or equal to 25 millimetres, or greater than or equal to 28 millimetres.

The pin may have a pin length of less than or equal to 3 millimetres, less than or equal to 5 millimetres, less than or equal to 7 millimetres, less than or equal to 9 millimetres, less than or equal to 10 millimetres, less than or equal to 11 millimetres, less than or equal to 12 millimetres, less than or equal to 13 millimetres, less than or equal to 14 millimetres, less than or equal to 15 millimetres, less than or equal to 16 millimetres, less than or equal to 18 millimetres, less than or equal to 20 millimetres, less than or equal to 22 millimetres, less than or equal to 25 millimetres, or less than or equal to 30 millimetres.

The pin may have a pin length of between 1 millimetre and 30 millimetres, 5 millimetres and 22 millimetres, between 8 millimetres and 16 millimetres, between 9 millimetres and 15 millimetres, between 10 millimetres and 14 millimetres, between 11 millimetres and 13 millimetres, or about 12 millimetres.

The pin length may be less than or equal to the rod length. The pin length may be less than or equal to 99 percent of the rod length, less than or equal to 95 percent of the rod length, less than or equal to 90 percent of the rod length, less than or equal to 85 percent of the rod length, less than or equal to 80 percent of the rod length, less than or equal to 70 percent of the rod length, 60 percent of the rod length, or less than or equal to 50 percent of the rod length.

The pin length may be greater than or equal to 50 percent of the rod length, greater than or equal to 60 percent of the rod length, greater than or equal to 70 percent of the rod length, greater than or equal to 80 percent of the rod length, greater than or equal to 85 percent of the rod length, greater than or equal to 90 percent of the rod length, greater than equal to 95 percent of the rod length, or greater than equal to 99 percent of the rod length.

The pin length may be between 70 percent and 99 percent of the rod length, between 75 percent and 95 percent of the rod length, between 80 percent and 95 percent of the rod length, or between 85 percent and 95 percent of the rod length.

Advantageously, providing a pin length that is less than or equal to the rod length may ensure that the pin remains entirely encompassed by the rod of aerosol-generating substrate when the pin is inserted into the rod of aerosol-generating substrate which improves heating efficiency. Advantageously, providing a pin length that is less than or equal to the rod length may prevent damage to components of the aerosol-generating article which are downstream of the rod of aerosol-generating substrate when the pin is inserted into the rod of aerosol-generating substrate. Advantageously, providing a pin length that is greater than equal to 50 percent of the rod length may result in more homogeneous heating along the length of the rod of aerosol-generating substrate and may reduce unsatisfactory heating of downstream portions of the rod of aerosol-generating substrate when the pin is inserted into the rod of aerosol-generating substrate.

The pin may have a volume of greater than or equal to 59 cubic millimetres, greater than or equal to 64 cubic millimetres, greater than or equal to 69 cubic millimetres, greater than or equal to 74 cubic millimetres, greater than or equal to 79 cubic millimetres or greater than or equal to 84 cubic millimetres.

The pin may have a volume of less than or equal to 84 cubic millimetres, less than or equal to 79 cubic millimetres, less than or equal to 74 cubic millimetres, less than or equal to 69 cubic millimetres, or less than or equal to 64 cubic millimetres.

The pin may have a volume of between 59 cubic millimetres and 84 cubic millimetres.

The rod of aerosol-generating substrate comprises an aerosol-generating substrate.

The rod of aerosol-generating substrate may comprise an aerosol-generating substrate and one or more additional components. For example, the rod of aerosol-generating substrate may comprise a susceptor. For example, the rod of aerosol-generating substrate may comprise a filler material that does not release volatile compounds when heated. The rod of aerosol-generating substrate may comprise a support material onto which the aerosol-generating substrate is deposited, loaded or coated.

The aerosol-generating substrate may be a solid aerosol-generating substrate.

The aerosol-generating substrate may comprise tobacco material.

As used herein, the term “tobacco material” is used to describe any material comprising tobacco, including, but not limited to, tobacco leaf, tobacco rib, tobacco stem, tobacco stalk, tobacco dust, expanded tobacco, reconstituted tobacco material and homogenised tobacco material.

The aerosol-generating substrate in the rod of aerosol-generating substrate the aerosol-generating substrate may comprise homogenised tobacco material. As used herein, the term ‘homogenised tobacco material’ denotes a material formed by agglomerating particulate tobacco.

The aerosol-generating substrate may comprise one or more sheets of homogenised tobacco material. As used herein, the term ‘sheet’ denotes a laminar element having a width and length substantially greater than the thickness thereof.

The one or more sheets of tobacco material may each individually have a length substantially the same as the length of the rod of aerosol-generating substrate.

The aerosol-generating substrate may comprise a gathered sheet of homogenised tobacco material. As used herein, the term ‘gathered’ is used to describe a sheet that is convoluted, folded, or otherwise compressed or constricted substantially transversely to the longitudinal axis of the aerosol-generating article.

The sheet of homogenised tobacco material may be crimped. As used herein, the term ‘crimped’ denotes a sheet having a plurality of substantially parallel ridges or corrugations. The aerosol-generating substrate may comprise a gathered, crimped sheet of homogenised tobacco material. Preferably, when the aerosol-generating article has been assembled, the substantially parallel ridges or corrugations extend along or parallel to the longitudinal axis of the aerosol-generating article.

The sheet of homogenized tobacco material may be a cast sheet. The cast sheet of homogenized tobacco material may comprise, prior to the casting process, tobacco particles having an average particle size (D95) of more than 50 micrometres, between 50 micrometres and 100 micrometres, between 60 micrometres and 80 micrometres, between 65 micrometres and 75 micrometres, or about 70 micrometres.

As used herein, the term “average particle size (D95)” is used to denote the volume-basis median value of the particle size distribution and is the value of the particle diameter at 95% in the cumulative distribution. The particle size of the particles can be analysed by laser diffraction method.

The aerosol-generating substrate preferably comprises an aerosol former. The aerosol former may be any suitable known compound or mixture of compounds that, in use, facilitates formation of a dense and stable aerosol. The aerosol former may be facilitating that the aerosol is substantially resistant to thermal degradation at temperatures typically applied during use of the aerosol-generating article. Suitable aerosol formers are for example: polyhydric alcohols such as, for example, triethylene glycol, 1,3-butanediol, propylene glycol and glycerine; esters of polyhydric alcohols such as, for example, glycerol mono-, di- or triacetate; aliphatic esters of mono-, di- or polycarboxylic acids such as, for example, dimethyl dodecanedioate and dimethyl tetradecanedioate; and combinations thereof.

The aerosol former may comprise one or more of glycerine and propylene glycol. The aerosol former may consist of glycerine or propylene glycol or of a combination of glycerine and propylene glycol.

The aerosol-generating substrate may comprise at least 5 percent, at least 10 percent, or at least 12 percent by weight of aerosol former on a dry weight basis of the aerosol-generating substrate.

The aerosol-generating substrate may comprise less than or equal to 30 percent, less than or equal to 25 percent, or less than or equal to 20 percent by weight of aerosol former on a dry weight basis of the aerosol-generating substrate.

The aerosol-generating substrate may comprise between 5 percent and 30 percent, between 5 percent and 25 percent, or between 5 percent and 20 percent by weight of aerosol former on a dry weight basis of the aerosol-generating substrate.

The aerosol-generating substrate may comprise between about 10 percent and about 30 percent, between about 10 percent and about 25 percent, or between about 10 percent and about 20 percent by weight of aerosol former on a dry weight basis of the aerosol-generating substrate.

The aerosol-generating substrate may comprise between about 12 percent and about 30 percent, between about 12 percent and about 25 percent, or between about 12 percent and about 20 percent by weight of aerosol former on a dry weight basis of the aerosol-generating substrate.

The aerosol-generating substrate may comprise at least one of tobacco material, between about 1 percent to about 5 percent of a binder, and between about 10 percent to about 30 percent of glycerine on a dry weight basis.

The aerosol-generating substrate may comprise tobacco cut filler and preferably an aerosol-former content in the aerosol-generating substrate is at least about 8 percent by weight.

The aerosol-generating substrate may comprise strands of reconstituted or reprocessed tobacco. The aerosol-generating substrate may comprise crimped fibre pieces of reconstituted or reprocessed tobacco.

As used herein, the term “strand” describes an elongate element of material having a length that is substantially greater than the width and thickness thereof. The term “strand” should be considered to encompass strips, shreds and any other homogenised plant material having a similar form. The strands of homogenised plant material may be formed from a sheet of homogenised plant material, for example by cutting or shredding, or by other methods, for example, by an extrusion method.

The aerosol-generating substrate may comprise at least one of a solid aerosol-generating substrate comprising nicotine, one or more cellulose based agents, one or more aerosol formers, and one or more carboxylic acids.

As used herein with reference to the invention, the term “nicotine” is used to describe nicotine, a nicotine base or a nicotine salt. The aerosol-generating film may comprise natural nicotine or synthetic nicotine.

The aerosol-generating film may comprise one or more monoprotic nicotine salts.

As used herein with reference to the invention, the term “monoprotic nicotine salt” is used to describe a nicotine salt of a monoprotic acid.

The solid aerosol-generating substrate may be one of a solid aerosol-generating film or a solid aerosol-generating gel.

As used herein, the term “film” is used to describe a solid laminar element having a thickness that is less than the width or length thereof. The film may be self-supporting. In other words, a film may have cohesion and mechanical properties such that the film, even if obtained by casting a film-forming formulation on a support surface, can be separated from the support surface. Alternatively, the film may be disposed on a support or sandwiched between other materials. This may enhance the mechanical stability of the film.

The aerosol-generating substrate may comprise a plurality of shreds of tobacco material, such as tobacco cut filler or shreds of homogenised tobacco material.

As used herein, the term “shred” denotes an element having a length substantially greater than a width and a thickness thereof.

Shreds of homogenised tobacco material may be formed from a sheet of homogenised tobacco material, for example, by cutting or shredding. Shreds of homogenised tobacco material may be formed by other methods, for example, by extrusion.

The shreds of tobacco material may have a width of at least about 0.3 millimetres, at least about 0.5 millimetres, or at least about 0.6 millimetres.

The shreds of tobacco material may have a width of less than or equal to about 2 millimetres, less than or equal to about 1.2 millimetres, or less than about 0.9 millimetres.

The shreds of tobacco material may have a width of between about 0.3 millimetres and about 2 millimetres, between about 0.3 millimetres and about 1.2 millimetres, or between about 0.3 millimetres and about 0.9 millimetres.

The shreds of tobacco material may have a width of between about 0.5 millimetres and about 2 millimetres, between about 0.5 millimetres and about 1.2 millimetres, or between about 0.5 millimetres and about 0.9 millimetres.

The shreds of tobacco material may have a width of between about 0.6 millimetres and about 2 millimetres, between about 0.6 millimetres and about 1.2 millimetres, or between about 0.6 millimetres and about 0.9 millimetres.

The shreds of tobacco material may have a length of at least about 10 millimetres.

The shreds of tobacco material may have a length of less than or equal to about 40 millimetres.

The shreds of tobacco material may have a length of between about 10 millimetres and about 40 millimetres.

At least about 20 percent by weight of the plurality of shreds of tobacco material on a dry weight basis may extend along the entire length of the rod of aerosol-generating substrate. At least about 20 percent by weight of the plurality of shreds of tobacco material on a dry weight basis may have a length substantially the same as the length of the rod of aerosol-generating substrate.

Less than or equal to about 60 percent by weight of the plurality of shreds of tobacco material on a dry weight basis may extend along the entire length of the rod of aerosol-generating substrate. Less than or equal to about 60 percent by weight of the plurality of shreds of tobacco material on a dry weight basis may have a length substantially the same as the length of the rod of aerosol-generating substrate.

Between about 20 percent and 60 percent by weight of the plurality of shreds of tobacco material on a dry weight basis may extend along the entire length of the rod of aerosol-generating substrate. Between about 20 percent and 60 percent by weight of the plurality of shreds of tobacco material on a dry weight basis may have a length substantially the same as the length of the rod of aerosol-generating substrate.

The aerosol-generating substrate may comprise a plurality of pellets or granules of tobacco material, such as homogenised tobacco material.

At least about 60 percent by weight of the plurality of pellets or granules may have a largest dimension greater than about 1 millimetre, at least about 70 percent by weight of the plurality of pellets or granules may have a largest dimension greater than about 1 millimetre, or at least about 80 percent by weight of the plurality of pellets or granules may have a largest dimension greater than about 1 millimetre.

Where the homogenised plant material is in the form of a plurality of pellets or granules, at least about 70 percent by weight of the plurality of pellets or granules may have a largest dimension greater than about 0.5 millimetres, at least about 80 percent by weight of the plurality of pellets or granules may have a largest dimension greater than about 0.5 millimetres, or at least about 90 percent by weight of the plurality of pellets or granules may have a largest dimension greater than about 0.5 millimetres.

For example, at least about 80 percent by weight of the plurality of pellets or granules may have a largest dimension greater than about 1 millimetre and at least about 90% by weight of the plurality of pellets or granules may have a largest dimension greater than about 0.5 millimetres.

The aerosol-generating article has an article length.

The article length may be between 50 millimetres and 90 millimetres, between 60 millimetres and 90 millimetres, between 70 millimetres and 90 millimetres, between 50 millimetres and 85 millimetres, between 60 millimetres and 85 millimetres, between 70 millimetres and 85 millimetres, between 50 millimetres and 80 millimetres, between 60 millimetres and 80 millimetres, between 70 millimetres and 80 millimetres, or about 75 millimetres.

The article length may be between 40 millimetres and 70 millimetres, between 45 millimetres and 70 millimetres, between 40 millimetres and 60 millimetres, between 45 millimetres and 60 millimetres, between 40 millimetres and 50 millimetres, between 45 millimetres and 50 millimetres, or about 45 millimetres.

The ratio between the rod length and the article length may be between 0.20 and 0.60, between 0.20 and 0.55, between 0.20 and 0.50, between 0.25 and 0.60, between 0.25 and 0.55, between 0.25 and 0.50, between 0.30 and 0.60, between 0.30 and 0.55, or between 0.30 and 0.50.

The aerosol-generating article may comprise ventilation. The aerosol-generating article may comprise ventilation holes.

The aerosol-generating article may have a ventilation level of at least 40 percent, at least 45 percent, at least 50 percent, at least 50 percent, at least 60 percent, or at least 70 percent. The aerosol-generating article may have a ventilation level of less than or equal to 90 percent, less than or equal to 85 percent, or less than 80 percent. The aerosol-generating article may have a ventilation level of between 40 percent and 90 percent, between 50 percent and 90 percent, between 60 percent and 90 percent, or about 75 percent.

As used herein, the term “ventilation level” denotes a volume ratio between of the airflow admitted into the aerosol-generating article via the ventilation zone (ventilation airflow) and the sum of the aerosol airflow and the ventilation airflow. The greater the ventilation level, the higher the dilution of the aerosol flow delivered to the consumer.

The resistance to draw of the aerosol-generating article may be between 10 millimetres of water gauge and 70 millimetres of water gauge, between 20 millimetres of water gauge and 65 millimetres of water gauge, between 30 millimetres of water gauge and 60 millimetres of water gauge, between 35 millimetres of water gauge and 55 millimetres of water gauge, or between 40 millimetres of water gauge and 50 millimetres of water gauge.

Unless otherwise specified, the resistance to draw (RTD) of a component or the aerosol-generating article is measured in accordance with ISO 6565-2015. The RTD refers the pressure required to force air through the full length of a component. The terms “pressure drop” or “draw resistance” of a component or article may also refer to the “resistance to draw”. Such terms generally refer to the measurements in accordance with ISO 6565-2015 normally carried out at a volumetric flow rate of 17.5 millilitres per second at the output or downstream end of the measured component at a temperature of 22 degrees Celsius, a pressure of 101 kPa (about 760 Torr) and a relative humidity of 60%. Conditions for smoking and smoking machine specifications are set out in ISO Standard 3308 (ISO 3308:2000). Atmosphere for conditioning and testing are set out in ISO Standard 3402 (ISO 3402:1999).

The resistance to draw (RTD) may be expressed with the units of pressure “millimetre(s) of water gauge” (mmWG).

The aerosol-generating article may further comprising a downstream section located downstream of the rod of aerosol-generating substrate. The downstream section may extend between the rod of aerosol-generating substrate and the downstream end of the aerosol-generating article. The downstream section may comprise one or more elements.

The downstream section has a downstream section length. The downstream section length may be greater than or equal to 10 millimetres, greater than or equal to 20 millimetres, greater than or equal to 25 millimetres, or greater than or equal to 30 millimetres.

The downstream section length may be less than or equal to 70 millimetres, less than or equal to 60 millimetres, or less than or equal to 50 millimetres.

The downstream section length may be between 20 millimetres and 70 millimetres, between 20 millimetres and 60 millimetres, or between 30 millimetres and 50 millimetres.

The resistance to draw of the downstream section may be at least 0 millimetres of water gauge, at least 3 millimetres of water gauge, or at least 6 millimetres of water gauge.

The resistance to draw of the downstream section may be less than or equal to 12 millimetres of water gauge, less than or equal to 11 millimetres of water gauge, or less than or equal to 10 millimetres of water gauge.

The resistance to draw of the downstream section may be between 0 millimetres of water gauge and 12 millimetres of water gauge, between 3 millimetres of water gauge and 11 millimetres of water gauge, or between 6 millimetres of water gauge and 10 millimetres of water gauge.

The aerosol-generating article may comprise one or more hollow tubular elements. The downstream section may comprise one or more hollow tubular elements. The one or more hollow tubular elements may be provided downstream of the rod of aerosol-forming substrate. One of the one or more hollow tubular elements may abut a downstream end of the rod of aerosol-generating substrate.

As used herein, the term “hollow tubular element” is used to denote an elongate element defining a lumen or airflow passage along a longitudinal axis thereof.

One of the one or more hollow tubular elements has a hollow tubular element length. The hollow tubular element length may be between 15 millimetres and 50 millimetres, between 20 millimetres and 45 millimetres, between 20 millimetres and 40 millimetres, between 20 millimetres and 30 millimetres, between 25 millimetres and 40 millimetres, or about 26 millimetres.

One of the one or more hollow tubular element has a wall thickness. The wall thickness of the hollow tubular element may be between 100 micrometres and 2 millimetres, between 150 micrometres and 1.5 millimetres, or between 200 micrometres and 1.25 millimetres.

The aerosol-generating article has an article external width. One of the hollow tubular elements has a hollow tubular element external width. The hollow tubular element external width may be approximately equal to the article external width.

One of the one or more hollow tubular elements may have a lumen. The lumen of the one or more hollow tubular elements may have a substantially circular cross sectional shape. The width of the lumen of a hollow tubular element may be referred to as an inner width.

In some embodiments, the aerosol-generating article may comprise a ventilation zone at a location along the one or more hollow tubular elements. The ventilation zone may comprise a plurality of perforations or holes through the wall of one or more of the one or more hollow tubular elements.

In some embodiments, the aerosol-generating article may be an aerosol-generating article which does not comprise a ventilation zone.

One of the one or more hollow tubular elements may be formed from at least one of: cardboard, paper, a polymeric material, a cellulosic material, cellulose acetate low density polyethylene (LDPE), and polyhydroxyalkanoate (PHA). Where the hollow tubular element is formed from paper, the paper may be crimped paper, such as crimped heat resistant paper or crimped parchment paper.

The one or more hollow tubular elements may comprise a first hollow tubular element and a second hollow tubular element. The first hollow tubular element may be a hollow acetate tube or a cardboard tube. The second hollow tubular element may be a hollow acetate tube or a cardboard tube. The inner width of the second hollow tubular element may be larger than the inner width of the first hollow tubular element. The wall thickness of the second hollow tubular element may be smaller than the wall thickness of the first hollow tubular element. The second hollow tubular element may be arranged downstream of the first hollow tubular element. One or both of the first hollow tubular element and the second hollow tubular element comprise a ventilation zone. Preferably, the second hollow tubular element comprises a ventilation zone at a location along the second hollow tubular element.

The one or more hollow tubular elements may comprise one or both of a hollow acetate tube (HAT) and a fine hollow acetate tube (FHAT).

The one or more hollow tubular elements may comprise a HAT and a FHAT. The FHAT may be arranged downstream of the HAT. The inner width of the FHAT may be larger than the inner width of the HAT. The HAT has a HAT length. The wall thickness of the HAT may be larger than the wall thickness of the FHAT. The FHAT has a FHAT length. The HAT length may be between 3 millimetres and 13 millimetres, between 6 millimetres and 10 millimetres, between 7 millimetres and 9 millimetres, or about 8 millimetres. The FHAT length may be between 3 millimetres and 13 millimetres, between 6 millimetres and 10 millimetres, between 7 millimetres and 9 millimetres, or about 8 millimetres. One or both of the HAT and the FHAT may comprise a ventilation zone. Preferably, the FHAT comprises a ventilation zone at a location along the FHAT.

The resistance to draw of the hollow tubular element may be less than or equal to 10 millimetres of water gauge, less than or equal to 5 millimetres of water gauge, less than or equal to 2.5 millimetres of water gauge, less than or equal to 2 millimetres of water gauge, or less than or equal to 1 millimetre of water gauge.

The resistance to draw of the hollow tubular element may be at least 0 millimetres of water gauge, at least 0.25 millimetres of water gauge, at least 0.5 millimetres of water gauge or at least 1 millimetre of water gauge.

The aerosol-generating article may further comprise a PLA (poly lactic acid) plug. The PLA plug may be downstream of one of the one or more hollow tubular elements. In embodiments of the aerosol-generating article which comprise a first hollow tubular element and a second tubular element, the PLA plug may be omitted.

One of the one or more hollow tubular elements may comprises a hollow tubular cooling element. One of the one or more hollow tubular elements comprises a hollow tubular support element.

The one or more hollow tubular elements may comprise a hollow tubular support element upstream of a hollow tubular cooling element. The hollow tubular support element may abut the downstream end of the rod of aerosol-generating substrate. The hollow tubular support element may abut the upstream end of the hollow tubular cooling element.

The hollow tubular support element may be formed from one or more materials selected from the group consisting of: cellulose acetate; cardboard; crimped paper, such as crimped heat resistant paper or crimped parchment paper; and polymeric materials, such as low density polyethylene (LDPE).

The aerosol-generating article may comprise a tubular element positioned upstream or downstream of the rod of aerosol-generating substrate. The tubular element may comprise: a tubular body defining a cavity extending from a first end of the tubular body to a second end of the tubular body; and a folded end portion forming a first end wall at the first end of the tubular body, the first end wall delimiting an opening for airflow between the cavity and the exterior of the tubular element. The first end wall may be adjacent to the rod of aerosol-generating substrate.

It has been surprisingly found through experimental data that providing a tubular element having folded end portion downstream of a rod of aerosol-generating substrate having a rod width to rod length ratio of between 0.5 to 0.56 can improve aerosol delivery, when compared to example known downstream cooling elements. This improved aerosol delivery can be particularly appreciable when the total dry weight of the rod of aerosol-generating substrate is less than or equal to 220 milligrams.

In the context of the present application, the tubular body of the tubular element provides an unrestricted flow channel. This means that the tubular body portion of the tubular element provides a negligible level of resistance to draw (RTD). The flow channel should therefore be free from any components that would obstruct the flow of air in a longitudinal direction. Preferably, the flow channel is substantially empty. In such a case, the tubular body of the tubular element defines an empty cavity.

The tubular element of the present disclosure provides an improved component for an aerosol-generating article. By forming the tubular element from a tubular body defining a cavity extending from a first end of the tubular body to a second end of the tubular body, a relatively large proportion of the tubular element can be empty and permit unimpeded airflow. Where the tubular element is downstream of an aerosol-generating substrate, this may help to improve cooling and nucleation of the aerosol. Furthermore, such a configuration may also help to minimise filtration of any compounds released from the aerosol-generating substrate, particularly when compared to prior art hollow acetate tubes.

By providing the tubular element with a folded end portion forming a first end wall at the first end of the tubular body, the tubular element can be configured to have a desired RTD through configuration of the size and shape of the first end wall. In particular, the tubular element and its first end wall can be manufactured efficiently and at high speed, with a satisfactory RTD and low RTD variability from one article to another. Furthermore, the configuration of the tubular element and its first end wall means that RTD can be localised at a specific longitudinal position of the tubular element, rather than being continuously distributed along the length of the tubular element.

Where the first end wall of the tubular element is adjacent to an aerosol-generating substrate, the first end wall may provide a barrier which may restrict movement of the aerosol-generating substrate. This arrangement can also advantageously enable one or both of air and aerosol to flow through the opening into the cavity.

The barrier provided by the first end wall of the tubular element may be more effective than a barrier provided by an end of a hollow acetate tube, since the first end wall may be less deformable than the end of the hollow acetate tube. The construction of the tubular element may also be better suited to withstanding the temperatures generated by a heating element, such as a pin of an aerosol-generating device.

The term ‘adjacent to’ is used herein in respect of the tubular element and rod of aerosol-generating substrate to indicate that the tubular element is longitudinally positioned next to the rod of aerosol-generating substrate in the rod of assembled elements. In particular, this term indicates that there are no other elements of the assembled rod disposed between the rod of aerosol-generating substrate and the tubular element in the longitudinal direction.

The rod of aerosol-generating substrate and tubular element may be adjacent to one another and in contact with one another. For example, the first end wall of the tubular element may be adjacent to the rod of aerosol-generating substrate and in contact with the rod of aerosol-generating substrate.

The rod of aerosol-generating substrate and tubular element may be adjacent to one another but not in contact with one another because a small gap of empty space separates the rod of aerosol-generating substrate from the tubular element in the longitudinal direction of the aerosol-generating article. For example, the first end wall of the tubular element may be adjacent to the aerosol-generating substrate but not in contact with the aerosol-generating substrate. The gap may be 2 millimetres or less. The gap may be 1 millimetre or less.

The tubular element may be positioned fully upstream of the rod of aerosol-generating substrate. In such embodiments, the tubular element may be referred to as an upstream tubular element.

The tubular element may be positioned fully downstream of the rod of aerosol-generating substrate. In such embodiments, the tubular element may be referred to as a downstream tubular element.

The aerosol-generating article may comprise two tubular elements, one being a first tubular element positioned fully downstream of the rod of aerosol-generating substrate and the other being a second tubular element positioned fully upstream of the rod of aerosol-generating substrate. The first and second tubular elements may each have any feature or combination of features, which are described above or below in respect of the tubular element of the disclosure.

For example, the tubular element may be a first tubular element, which is positioned downstream of the aerosol forming substrate with the first end wall of the first tubular element being adjacent to the downstream end of the aerosol-generating substrate. In such embodiments, the aerosol-generating article may further comprise a second tubular element. The second tubular element may be positioned upstream of the rod of aerosol-generating substrate. The second tubular element may comprise a tubular body defining a cavity extending from a first end of the tubular body to a second end of the tubular body; and a folded end portion forming a first end wall at the first end of the tubular body, the first end wall delimiting an opening for airflow between the cavity and the exterior of the second tubular element. The first end wall of the second tubular element may be adjacent to the upstream end of the aerosol-generating substrate. Therefore, in such embodiments, the rod of aerosol-generating substrate may be sandwiched between first and second tubular elements, where each tubular element has a folded end portion which provides a respective end wall adjacent to the upstream or downstream end of the rod of aerosol-generating substrate. In such embodiments, the second tubular element may be referred to as an upstream tubular element, and the first tubular element may be referred to as a downstream tubular element.

The second tubular element may further comprise a folded end portion forming a second end wall at the second end of its tubular body. The second end wall of the second tubular element may delimit an opening for airflow between the cavity and the exterior of the second tubular element. The opening delimited by the second end wall of the second tubular element may be smaller than the opening delimited by the first end wall of the second tubular element. For example, the size of the opening delimited by the second end wall of the second tubular element may be between about 20 percent and about 80 percent of the size of the opening delimited by the first end wall of the second tubular element. The size of the opening delimited by the second end wall of the second tubular element may be between about 40 percent and about 60 percent of the size of the opening delimited by the first end wall of the second tubular element, more preferably between about 45 percent and about 55 percent of the size of the opening delimited by the first end wall of the second tubular element.

As will be described in more detail below, the aerosol-generating article may further comprise a ventilation zone at a location along the tubular element. Where the aerosol-generating article comprises the first and second tubular elements described above, the ventilation zone is preferably located along the first tubular element.

The first end wall may extend substantially transverse to the longitudinal direction of the aerosol generating article. The first end wall may extend substantially transverse to the longitudinal direction of the tubular body.

The first end wall may extend partially into the cavity of the tubular body and forms an angle of less than 90 degrees with the inner surface of the tubular body, more preferably an angle of less than 80 degrees with the inner surface of the tubular body, even more preferably angle of less than 70 degrees with the inner surface of the tubular body. This may be achieved by ensuring that, during manufacture of the tubular element, a folding force is applied to the tubular element such that at least part of the first end portion of the tubular element is pushed into the cavity of the tubular body. Such arrangements may advantageously increase the likelihood of the first end wall remaining stationary with respect to the tubular body after the tubular element has been manufactured. In particular, such arrangements may help to overcome any natural resilience in the material forming the tubular element, such that the folded end portion of the tubular element is less likely to revert towards its pre-folded condition after manufacture.

The opening delimited by the first end wall may be the only opening in the first end wall. The opening may be disposed in a generally radially central position of the tubular element. The first end wall may be generally annular shaped.

The first end wall may extend from a fold point on the tubular element and towards a radially central position of the tubular element. The fold point may generally correspond to the first end of the tubular body of the tubular element.

Preferably, at least the first portion of the tubular element forming the first end wall is substantially air impermeable. Put another way, preferably the first end wall is substantially non-porous. Preferably the first end wall does not comprise any perforations. The material forming the first end wall may have a porosity of less than 2000 Coresta units. The material forming the first end wall may have a porosity of less than 1000 Coresta units. The material forming the first end wall may have a porosity of less than 500 Coresta units.

Preferably, the tubular element has an equivalent internal diameter of at least about 5.5 millimetres. More preferably, the tubular element has an equivalent internal diameter of at least about 6 millimetres. Even more preferably, the tubular element has an equivalent internal diameter of at least about 7 millimetres. The term “equivalent internal diameter” is used herein to denote the diameter of a circle having the same surface area of a cross-section of the airflow conduit internally defined by the hollow tubular segment. A cross-section of the airflow conduit may have any suitable shape. However, as described briefly above, a circular cross-section is preferred-that is, the hollow tubular segment is effectively a cylindrical tube. In that case, the equivalent internal diameter of the hollow tubular segment effectively coincides with the internal diameter of the cylindrical tube.

The equivalent internal diameter of the hollow tubular segment is preferably less than about 10 millimetres. More preferably, the equivalent internal diameter of the hollow tubular segment is less than about 9.5 millimetres, even more preferably less than 9 millimetres.

Preferably, the tubular element has a wall thickness of at least about 0.1 millimetres, more preferably at least about 0.2 millimetres.

Preferably, the tubular element has a wall thickness of less than about 1.5 millimetres, preferably less than about 1.25 millimetres. In a preferred embodiment, the tubular element has a wall thickness of less than about 1 millimetre.

The tubular element therefore preferably has a wall thickness of between about 0.1 millimetres and about 1.5 millimetres, or between about 0.2 millimetres and about 1.25 millimetres, or between about 0.5 millimetres and about 1 millimetre.

Providing the tubular element with such wall thickness can help to improve the tubular body's resistance to collapse or deformation, whilst still enabling the first end wall to be formed by a folded end portion of the tubular element.

The wall thickness of the tubular element may be the same as the wall thickness of one or both of the tubular body and the first end wall.

The length of the tubular element may be substantially the same as the length of the tubular body.

Preferably, the tubular element has a length of at least about 10 millimetres, more preferably at least about 15 millimetres.

Preferably, the tubular element has a length of less than about 30 millimetres, preferably less than about 25 millimetres, even more preferably less than about 20 millimetres.

The tubular element may have a length of from about 10 millimetres to about 30 millimetres, preferably from about 15 millimetres to about 25 millimetres, more preferably from about 15 millimetres to about 20 millimetres. For example, in one particularly preferred embodiment, the tubular element has a length of 18 millimetres. Such lengths may be particularly preferred in embodiments where the tubular element is positioned downstream of the aerosol-generating substrate with the first end wall of the tubular element being adjacent to the downstream end of the aerosol-generating substrate.

The tubular element may have a length of from about 5 millimetres to about 20 millimetres, preferably from about 8 millimetres to about 15 millimetres, more preferably from about 10 millimetres to about 13 millimetres. For example, in one particularly preferred embodiment, the tubular element has a length of 12 millimetres. Such lengths may be particularly preferred in embodiments where the tubular element is positioned upstream of the aerosol-generating substrate with the first end wall of the tubular element being adjacent to the upstream end of the aerosol-generating substrate.

Preferably, the tubular element is adapted to generate a RTD between approximately 0 millimetres H2O (about 0 Pa) to approximately 20 millimetres H2O (about 100 Pa), more preferably between approximately 0 millimetres H2 (about 0 Pa) to approximately 10 millimetres H2O (about 100 Pa).

The tubular element is preferably formed from a paper material, such as paper, paperboard or cardboard. The tubular element may be formed from a plurality of overlapping paper layers, such as a plurality of parallel wound paper layers or a plurality of spirally wound paper layers. Forming the tubular element from a plurality of overlapping paper layers can help to improve the tubular body's resistance to collapse or deformation, whilst still enabling the first end wall to be formed by a folded end portion of the tubular element.

The tubular element may comprise at least two paper layers. The tubular element may comprise fewer than eleven paper layers.

Where the tubular element is formed from a paper material, the paper material may have a basis weight of at least about 90 grams per square metre. The paper material may have a basis weight of less than about 300 grams per square metre. The paper material may have a basis weight of from about 100 to about 200 grams per square metre. Providing the tubular element with such wall basis weight can help to improve the tubular body's resistance to collapse or deformation, whilst still enabling the first end wall to be formed by a folded end portion of the tubular element.

The aerosol-generating article may comprise a mouthpiece element. The downstream section may comprise a mouthpiece element. The mouthpiece element may be located downstream of at least one of the one or more hollow tubular elements. The mouthpiece element may be located at the downstream end of the aerosol-generating article.

The mouthpiece element may be a mouthpiece filter. The mouthpiece element may be formed from a fibrous filtration material. The mouthpiece element may be formed from cellulose acetate.

The mouthpiece element may have a mouthpiece length of greater than or equal to 5 millimetres, or greater than or equal to 10 millimetres.

The mouthpiece element may has a mouthpiece length of less than 25 millimetres, or less than 20 millimetres.

The mouthpiece element may have a mouthpiece length of between 5 millimetres and 25 millimetres, between 10 millimetres and 25 millimetres, between 5 millimetres and 20 millimetres, between 10 millimetres and 20 millimetres, between 10 millimetres and 14 millimetres, between 11 millimetres and 13 millimetres, or about 12 millimetres.

The mouthpiece element may have a length of between 5 millimetres and 10 millimetres, between 6 millimetres and 8 millimetres, or about 7 millimetres.

The resistance to draw of the mouthpiece element per millimetre length along a longitudinal direction of the aerosol-generating article may be between 0.1 millimetre of water gauge and 20 millimetres of water gauge, between 0.2 millimetre of water gauge and 10 millimetres of water gauge, between 0.5 millimetre of water gauge and 5 millimetres of water gauge, between 1 millimetre of water gauge and 2 millimetres of water gauge, between 1.3 millimetres of water gauge and 1.7 millimetres of water gauge, between 1.4 millimetre of water gauge and 1.6 millimetres of water gauge or about 1.5 millimetres of water gauge.

The resistance to draw of the mouthpiece element may be between 1 millimetre of water gauge and 100 millimetres of water gauge, between 2 millimetres of water gauge and 50 millimetres of water gauge, between 5 millimetres of water gauge and 40 millimetres of water gauge, between 10 millimetres of water gauge and 30 millimetres of water gauge, between 16 millimetres of water gauge and 20 millimetres of water gauge, between 17 millimetres of water gauge and 19 millimetres of water gauge, or about 18 millimetres of water gauge.

The resistance to draw of the mouthpiece element may be between 1 millimetre of water gauge and 60 millimetres of water gauge, between 2 millimetres of water gauge and 30 millimetres of water gauge, between 4 millimetres of water gauge and 25 millimetres of water gauge, between 5 millimetres of water gauge and 18 millimetres of water gauge, between 6 millimetres of water gauge and 13 millimetres of water gauge, between 9 millimetres of water gauge and 12 millimetres of water gauge, or about 10.5 millimetres of water gauge.

The mouthpiece element may comprise a flavourant, which may be provided in any suitable form. For example, the mouthpiece element may comprise one or more capsules, beads or granules of a flavourant, or one or more flavour loaded threads or filaments.

The aerosol-generating article may comprise a flavour capsule. Preferably the flavour capsule is in the mouthpiece element.

The aerosol-generating article may further comprise a substrate wrapper at least partly circumscribing the rod of aerosol-generating substrate. The substrate wrapper may comprise one or more layers having the same length as the aerosol-generating article.

The substrate wrapper may have a thickness of at least 50 micrometres, at least 60 micrometres, at least 70 micrometres, at least 75 micrometres, at least 80 micrometres, at least 90 micrometres, at least 100 micrometres, at least 110 micrometres, at least 120 micrometres, at least 130 micrometres, at least 140 micrometres, at least 145 micrometres, or at least 150 micrometres.

Advantageously, a substrate wrapper having a thickness of greater than or equal to 50 micrometres may advantageously replace non-satisfactorily heated portions of aerosol-generating substrate. An amount of aerosol-generating substrate may thus be saved. A more efficient aerosol-generating article may be provided.

The thickness of the substrate wrapper may be determined in accordance with ISO 534:2011.

The ratio of substrate wrapper thickness to the rod width may be between 1:120 and 1:20 (0.0083 and 0.050), between 1:100 and 1:30 (0.010 and 0.030), between 1:80 and 1:35 (0.013 and 0.029), and between 1:60 and 1:40 (0.017 and 0.025).

The substrate wrapper may have a density of less than or equal to 800 kilograms per cubic metre, less than or equal to 750 kilograms per cubic metre, less than or equal to 700 kilograms per cubic metre, less than or equal to 650 kilograms per cubic metre, less than or equal to 600 kilograms per cubic metre, less than or equal to 550 kilograms per cubic metre, less than or equal to 500 kilograms per cubic metre, less than or equal to 450 kilograms per cubic metre, less than or equal to 400 kilograms per cubic metre, less than or equal to 350 kilograms per cubic metre, or about 320 kilograms per cubic metre.

Advantageously, a substrate wrapper with a thickness of at least 50 micrometres and a density of less than or equal to 800 kilograms per cubic metre may be more rigid than a conventional thin wrapper. Therefore, a mechanically more robust aerosol-generating article may be provided. A mechanically more robust aerosol-generating article may be particularly advantageous when the aerosol-generating article is arranged to be inserted into a device cavity of an aerosol-generating device.

The density of the substrate wrapper may be determined in accordance with ISO 534:2011. The thickness of the substrate wrapper may be determined in accordance with ASTM E252-06(2021)e1. Generally, for embossed wrappers, the local thickness at a position of an embossment may be less than the thickness at a position without an embossment. As used herein, for embossed wrappers, the thickness of the wrapper refers to the thickness at positions without embossments. For embossed wrappers, the thickness of the wrapper may be determined before the wrapper is being embossed.

Unless defined otherwise, all measurements described herein are performed after conditioning the samples in accordance with ISO Standard 3402:1999.

The density of the substrate wrapper may be calculated by dividing the basis weight of the substrate wrapper by the thickness of the substrate wrapper. The basis weight, also called grammage, refers to the mass of the substrate wrapper per sheet size, usually expressed in grams per square metre. The basis weight may be obtained, for example, by weighing a 1 square metre sized sheet of the substrate wrapper.

The substrate wrapper may comprise one or more of cardboard, plastics, and metal foil. The substrate wrapper may comprise a cellulosic material. The substrate wrapper may comprise cellulosic material selected from one or more of paper, wood, textile, natural fibres, and artificial fibres.

The aerosol-generating article may further comprise an outer wrapper at least partly circumscribing the other elements of the aerosol-generating article. The outer wrapper may extend along only a part of the length of the aerosol-generating article. For example, in some embodiments the outer wrapper may not extend along the mouthpiece element. The outer wrapper may extend the entire length of the aerosol-generating article. The outer wrapper may comprise tipping paper.

The aerosol-generating device may further comprise a device cavity configured to receive at least a part of the aerosol-generating article. The device cavity may have a closed end and an open end. The aerosol-generating article may be insertable into the device cavity via the open end. The device cavity may have substantially the same cross-sectional shape as the aerosol-generating article.

The device cavity has a device cavity length. The device cavity length may be substantially the same as or greater than the rod length. The device cavity length may be such that when the aerosol-generating article is received with the aerosol-generating device at least 75 percent of the rod length is received within the device cavity, at least 80 percent of the rod length is received within the device cavity, or at least 90 percent of the rod length is received within the device cavity.

Advantageously, providing a device cavity length which is substantially the same as or greater than the rod length may ensure that the entire rod of aerosol-generating substrate can be received in the device cavity which may reduce unsatisfactory heating of downstream portions of the rod of aerosol-generating substrate and may result in more homogeneous heating along the length of the rod.

When the aerosol-generating article is received by the aerosol-generating device, the pin may penetrate the rod of aerosol-generating substrate substantially through the centre of a cross-sectional face of the rod perpendicular to the rod length.

Advantageously, providing a pin that penetrates the rod of aerosol-generating substrate substantially through the centre of a cross-sectional face of the rod perpendicular to the rod length may result in more homogeneous heating of the rod of aerosol-generating substrate.

The pin may comprise one of a resistive heating element and a susceptor element.

The pin may comprise a resistive heating element. The pin may be a resistive heating element.

The pin may comprise an electrically resistive material. Suitable electrically resistive materials include but are not limited to: semiconductors such as doped ceramics, electrically “conductive” ceramics (such as, for example, molybdenum disilicide), carbon, graphite, metals, metal alloys and composite materials made of a ceramic material and a metallic material. Such composite materials may comprise doped or undoped ceramics. Examples of suitable doped ceramics include doped silicon carbides. Examples of suitable metals include titanium, zirconium, tantalum and metals from the platinum group. Examples of suitable metal alloys include stainless steel, Constantan, nickel-, cobalt-, chromium-, aluminium-,titanium-, zirconium-, hafnium-, niobium-, molybdenum-, tantalum-, tungsten-, tin-, gallium-, manganese- and iron-containing alloys, and super-alloys based on nickel, iron, cobalt, stainless steel, Timetal®, iron-aluminium based alloys and iron-manganese-aluminium based alloys. Timetal® is a registered trade mark of Titanium Metals Corporation, 1999 Broadway Suite 4300, Denver Colorado. In composite materials, the electrically resistive material may optionally be embedded in, encapsulated or coated with an insulating material or vice-versa, depending on the kinetics of energy transfer and the external physicochemical properties required. The heating element may comprise a metallic etched foil insulated between two layers of an inert material. In that case, the inert material may comprise Kapton®, all-polyimide or mica foil. Kapton® is a registered trade mark of E.I. du Pont de Nemours and Company, 1007 Market Street, Wilmington, Delaware 19898, United States of America.

The pin may comprise a susceptor element. The pin may be a susceptor element. As used herein, the term “susceptor” denotes a material that is capable of being heated when penetrated by a varying magnetic field.

The aerosol-generating device may be capable of generating a fluctuating magnetic field of between 1 and 30 MHz, for example, between 2 and 10 MHz, for example between 5 and 7 MHz. The device may be capable of generating a fluctuating magnetic field having a field strength (H-field) of between 1 and 5 kA/m, for example between 2 and 3 kA/m, for example about 2.5 kA/m.

The susceptor may be formed from any material that can be inductively heated to a temperature sufficient to generate an aerosol from the aerosol-generating substrate. For example, the susceptor may comprise a metal or carbon.

The susceptor may comprise or consist of a ferromagnetic material, for example a ferromagnetic alloy, ferritic iron, or a ferromagnetic steel or stainless steel. A suitable susceptor may be, or comprise, aluminium. The susceptor may be formed from 400 series stainless steels, for example grade 410, or grade 420, or grade 430 stainless steel.

Different materials will dissipate different amounts of energy when positioned within electromagnetic fields having similar values of frequency and field strength. Thus, parameters of the susceptor such as material type, length, width, and thickness may all be altered to provide a desired power dissipation within a known electromagnetic field. The susceptor may be heated to a temperature in excess of 250 degrees Celsius.

Where the pin comprises a susceptor element, the aerosol-generating device may comprise an inductor coil arranged to inductively heat the pin. The aerosol-generating device may comprise an inductor coil. Where the aerosol-generating device comprises a device cavity, the inductor coil may at least partly circumscribe the device cavity. The inductor coil may be arranged to coaxially circumscribe the device cavity.

The aerosol-generating device may further comprise a controller.

During use, the heating element may be controlled to operate such that the operating temperature range of the heating element is between 150 degrees Celsius and 350 degrees Celsius, between 200 degrees Celsius and 330 degrees Celsius, or between 260 degrees Celsius and 320 degrees Celsius.

During use, the heating element may be controlled to heat to a peak temperature of less than or equal to 350 degrees Celsius, less than or equal to 335 degrees Celsius, or less than or equal to 320 degrees Celsius.

During use, the heating element may be controlled to heat to a peak temperature of between 220 degrees Celsius and 350 degrees Celsius, between 240 degrees Celsius and 335 degrees Celsius, or between 260 degrees Celsius and 320 degrees Celsius.

The aerosol-generating device may further comprise a power supply. The power supply may be a DC power supply. The power supply may a battery. The power supply may be a nickel-metal hydride battery, a nickel cadmium battery, or a lithium based battery, for example a lithium-cobalt, a lithium-iron-phosphate or a lithium-polymer battery. The power supply may be another form of charge storage device, such as a capacitor. The power supply may require recharging and may have a capacity that allows for the storage of enough energy for one or more user operations, for example one or more aerosol-generating experiences.

Below, there is provided a non-exhaustive list of non-limiting examples. Any one or more of the features of these examples may be combined with any one or more features of another example, embodiment, or aspect described herein.

Example Ex 1: An aerosol-generating system comprising:
an aerosol-generating article, the aerosol-generating article comprising a rod of aerosol-generating substrate; and
an aerosol-generating device, the aerosol-generating device comprising a heating element in the form of a pin configured for insertion into the rod of aerosol-generating substrate of the aerosol-generating article.

Example Ex2: The aerosol-generating system according to example Ex1, wherein the rod of aerosol-generating substrate has a rod width.

Example Ex3: The aerosol-generating system according to example Ex2, wherein the rod of aerosol-generating substrate has a rod length, and optionally wherein the rod width is substantially uniform along the rod length.

Example Ex4: The aerosol-generating system according to example Ex3, wherein the rod width is measured at a position 50% along the rod length from an end of the rod.

Example Ex5: The aerosol-generating system according to any one of examples Ex2 to Ex4, wherein the rod width is greater than or equal to 5 millimetres, optionally greater than or equal to 5.3 millimetres, optionally greater than or equal to 5.5 millimetres, optionally greater than or equal to 5.7 millimetres, optionally greater than or equal to 6.1 millimetres, optionally greater than or equal to 6.3 millimetres, or optionally greater than or equal to 6.7 millimetres.

Example Ex6: The aerosol-generating system according to any one of examples Ex2 to Ex5, wherein the rod width is less than or equal to 7 millimetres, optionally less than or equal to 6.7 millimetres, optionally less than or equal to 6.3 millimetres, optionally less than or equal to 6.1 millimetres, optionally less than or equal to 5.7 millimetres, optionally less than or equal to 5.5 millimetres, or optionally less than or equal to 5.3 millimetres.

Example Ex7: The aerosol-generating system according to any one of examples Ex2 to Ex6, wherein the rod width is between 5 millimetres and 7 millimetres, optionally between 5 millimetres and 6.7 millimetres, optionally between 5 millimetres and 6.3 millimetres, optionally between 5 millimetres and 6.1 millimetres, optionally between 5 millimetres and 5.7 millimetres, optionally between 5 millimetres and 5.5 millimetres, optionally between 5 millimetres and 5.3 millimetres, optionally between 5.3 millimetres and 7 millimetres, optionally between 5.3 millimetres and 6.7 millimetres, optionally between 5.3 millimetres and 6.3 millimetres, optionally between 5.3 millimetres and 6.1 millimetres, optionally between 5.3 millimetres and 5.7 millimetres, optionally between 5.3 millimetres and 5.5 millimetres, optionally between 5.5 millimetres and 7 millimetres, optionally between 5.5 millimetres and 6.7 millimetres, optionally between 5.5 millimetres and 6.3 millimetres, optionally between 5.5 millimetres and 6.1 millimetres, optionally between 5.5 millimetres and 5.7 millimetres, optionally between 5.7 millimetres and 7 millimetres, optionally between 5.7 millimetres and 6.7 millimetres, optionally between 5.7 millimetres and 6.3 millimetres, optionally between 5.7 millimetres and 6.1 millimetres, optionally between 6.1 millimetres and 7 millimetres, optionally between 6.1 millimetres and 6.7 millimetres, optionally between 6.1 millimetres and 6.3 millimetres, optionally between 6.3 millimetres and 7 millimetres, optionally between 6.3 millimetres and 6.7 millimetres, or optionally between 6.7 millimetres and 7 millimetres.

Example Ex8: The aerosol-generating system according to any of the preceding examples, wherein the rod of aerosol-generating substrate has a rod length, and wherein the rod of aerosol-generating substrate has a rod cross-sectional area perpendicular to the rod length.

Example Ex9: The aerosol-generating system according to example Ex8, wherein the rod cross-sectional area is measured at a position 50 percent along the length of the rod from an end of the rod.

Example Ex10: The aerosol-generating system according to example Ex8 or Ex9, wherein the rod cross-sectional area is substantially uniform along the rod length.

Example Ex11: The aerosol-generating system according to any one of examples Ex8 to Ex10, wherein the rod cross-sectional area is less than or equal to 38.5 millimetres squared, optionally less than or equal to 35.3 millimetres squared, optionally t less than or equal to 31.2 millimetres squared, optionally less than or equal to 29.2 millimetres squared, optionally less than or equal to 25.5 millimetres squared, optionally less than or equal to 23.8 millimetres squared, optionally less than or equal to 22.1 millimetres squared, or optionally less than or equal to 19.6 millimetres squared.

Example Ex12: The aerosol-generating system according to any one of examples Ex8 to Ex11, wherein the rod cross-sectional area is greater than or equal to 19.6 millimetres squared, optionally greater than or equal to 22.1 millimetres squared, optionally greater than or equal to 23.8 millimetres squared, optionally greater than or equal to 25.5 millimetres squared, optionally greater than or equal to 29.2 millimetres squared, optionally greater than or equal to 31.2 millimetres squared, or optionally greater than or equal to 35.3 millimetres squared.

Example Ex13: The aerosol-generating system according to any one of examples Ex8 to Ex12, wherein the rod cross-sectional area is between 19.6 millimetres squared and 38.5 millimetres squared, optionally between 19.6 millimetres squared and 35.3 millimetres squared, optionally between 19.6 millimetres squared and 31.2 millimetres squared, optionally between 19.6 millimetres squared and 29.2 millimetres squared, optionally between 19.6 millimetres squared and 25.5 millimetres squared, optionally between 19.6 millimetres squared and 23.8 millimetres squared, optionally between 19.6 millimetres squared and 22.1 millimetres squared, optionally between 22.1 millimetres squared and 38.5 millimetres squared, optionally between 22.1 millimetres squared and 35.3 millimetres squared, optionally between 22.1 millimetres squared and 31.2 millimetres squared, optionally between 22.1 millimetres squared and 29.2 millimetres squared, optionally between 22.1 millimetres squared and 25.5 millimetres squared, optionally between 22.1 millimetres squared and 23.8 millimetres squared, optionally between 23.8 millimetres squared and 38.5 millimetres squared, optionally between 23.8 millimetres squared and 35.3 millimetres squared, optionally between 23.8 millimetres squared and 31.2 millimetres squared, optionally between 23.8 millimetres squared and 29.2 millimetres squared, optionally between 23.8 millimetres squared and 25.5 millimetres squared, optionally between 25.5 millimetres squared and 38.5 millimetres squared, optionally between 25.5 millimetres squared and 35.3 millimetres squared, optionally between 25.5 millimetres squared and 31.2 millimetres squared, optionally between 25.5 millimetres squared and 29.2 millimetres squared, optionally between 29.2 millimetres squared and 38.5 millimetres squared, optionally between 29.2 millimetres squared and 35.3 millimetres squared, optionally between 29.2 millimetres squared and 31.2 millimetres squared, optionally between 31.2 millimetres squared and 38.5 millimetres squared, optionally between 31.2 millimetres squared and 35.3 millimetres squared, or optionally between 35.3 millimetres squared and 38.5 millimetres squared.

Example Ex14: The aerosol-generating system according to any of the preceding examples, wherein the pin has a pin width, and optionally wherein the pin has a tip.

Example Ex15: The aerosol-generating system according to example Ex14, wherein the pin width is measured at a distance of 2 millimetres from the end of the tip, or optionally 3 millimetres, 4 millimetres, 5 millimetres, or 6 millimetres from the end of the tip, preferably at a distance of 3 millimetres, or 4 millimetres from the end of the tip.

Example Ex16: The aerosol-generating system according to example Ex14 or Ex15, wherein the pin width is measured at a distance of 4 millimetres from the end of the tip.

Example Ex17: The aerosol-generating system according to any one of examples Ex14 to Ex16, wherein the pin width is the maximum pin width.

Example Ex18: The aerosol-generating system according to any one of examples Ex14 to Ex17, wherein the pin width is the pin width measured at the position along the section of the pin configured to be inserted into the rod of aerosol-generating substrate which is the furthest distance from the end of the tip.

Example Ex19: The aerosol-generating system according to any one of examples Ex14 to Ex18, wherein the pin width is the pin width measured at the position 50 percent of the pin length from end of the tip.

Example Ex20: The aerosol-generating system according to any one of examples Ex14 to Ex19, wherein the pin has a pin length, and wherein the pin width is a mean pin width measured over at least 70 percent of the pin length, optionally over at least 80 percent of the pin length, optionally over at least 90 percent of the pin length, or optionally over at least 95 percent of the pin length.

Example Ex21: The aerosol-generating system according to any one of examples Ex14 to Ex20, wherein the pin width is greater than or equal to 2.5 millimetres, optionally greater than or equal to 2.6 millimetres, optionally greater than or equal to 2.7 millimetres, optionally greater than or equal to 2.8 millimetres, or optionally greater than or equal to 2.9 millimetres.

Example Ex22: The aerosol-generating system according to any one of examples Ex14 to Ex21, wherein the pin width is less than or equal to 3.0 millimetres, optionally less than or equal to 2.9 millimetres, optionally less than or equal to 2.8 millimetres, optionally less than or equal to 2.7 millimetres, or optionally less than or equal to 2.6 millimetres.

Example Ex23: The aerosol-generating system according to any one of examples Ex14 to Ex22, wherein the pin width is between 2.5 millimetres and 4.0 millimetres, or wherein the pin width is between 2.5 millimetres and 3.0 millimetres

Example Ex24: The aerosol-generating system according to any one of examples Ex14 to Ex23, wherein the ratio of the rod width to the pin width is less than or equal to 2.8, optionally less than or equal to 2.7, optionally less than or equal to 2.6, optionally less than or equal to 2.5, optionally less than or equal to 2.4, optionally less than or equal to 2.3, optionally less than or equal to 2.2, optionally less than or equal to 2.1, optionally less than or equal to 2.0, optionally less than or equal to 1.9, or optionally less than or equal to 1.8.

Example Ex25: The aerosol-generating system according to any one of examples Ex14 to Ex24, wherein the ratio of the rod width to the pin width is greater than or equal to 1.6, optionally greater than or equal to 1.7, optionally greater than or equal to 1.8, optionally greater than or equal to 1.9, optionally greater than or equal to 2.0, optionally greater than or equal to 2.1, optionally greater than or equal to 2.2, optionally greater than or equal to 2.3, optionally greater than or equal to 2.4, optionally greater than or equal to 2.5, or optionally greater than or equal to 2.6.

Example Ex26: The aerosol-generating system according to any one of examples Ex14 to Ex25, wherein the ratio of the rod width to the pin width is between 1.6 and 2.8.

Example Ex27: The aerosol-generating system according to any one of examples Ex14 to Ex26, wherein the pin has a minimum transverse pin dimension perpendicular to the pin width.

Example Ex28: The aerosol-generating system according to example Ex27, wherein the minimum transverse pin dimension is measured at a distance of 2 millimetres from the end of the tip, or optionally at a distance of 3 millimetres, 4 millimetres, 5 millimetres, or 6 millimetres from the end of the tip, or preferably at a distance of 3 millimetres, or 4 millimetres from the end of the tip, or most preferably at a distance of 4 millimetres from the end of the tip.

Example Ex29: The aerosol-generating system according to example Ex27 or Ex28, wherein the minimum transverse pin dimension is greater than or equal to 1.6 millimetres, optionally greater than or equal to 1.7 millimetres, optionally greater than or equal to 1.8 millimetres, optionally greater than or equal to 1.9 millimetres, optionally greater than or equal to 2.0 millimetres, optionally greater than or equal to 2.1 millimetres, optionally greater than or equal to 2.2 millimetres, optionally greater than or equal to 2.3 millimetres, optionally greater than or equal to 2.4 millimetres, optionally greater than or equal to 2.5 millimetres, optionally greater than or equal to 2.6 millimetres, optionally greater than or equal to 2.7 millimetres, optionally greater than or equal to 2.8 millimetres, or optionally greater than or equal to 2.9 millimetres.

Example Ex30: The aerosol-generating system according to any one of examples Ex27 to Ex29, wherein the minimum transverse pin dimension is less than or equal to 3.0 millimetres.

Example Ex31: The aerosol-generating system according to any one of examples Ex27 to Ex30, wherein the minimum transverse pin dimension is between 2.5 millimetres and 3.0 millimetres.

Example Ex32: The aerosol-generating system according to any of the preceding examples, wherein the pin has a pin length, and wherein the pin has a pin cross-sectional area perpendicular to the pin length.

Example Ex33: The aerosol-generating system according to example Ex32, wherein the pin cross-sectional area is measured at a distance of 2 millimetres from the end of the tip, or optionally at a distance of 3 millimetres, 4 millimetres, 5 millimetres, or 6 millimetres from the end of the tip, or preferably at a distance of 3 millimetres, or 4 millimetres from the end of the tip, or most preferably at a distance of 4 millimetres from the end of the tip.

Example Ex34: The aerosol-generating system according to example Ex32 or Ex33, wherein the pin cross-sectional area is the maximum pin cross-sectional area.

Example Ex35: The aerosol-generating system according to any one of examples Ex32 to Ex34, wherein the pin cross-sectional area is the pin cross-sectional area measured at the position along the section of the pin configured to be inserted into the rod of aerosol-generating substrate which is the furthest distance from the end of the tip.

Example Ex36: The aerosol-generating system according to any one of examples Ex32 to Ex35, wherein the pin cross-sectional area is a mean pin cross-sectional area measured over at least 70 percent of the pin length, optionally over at least 80 percent of the pin length, optionally over at least 90 percent of the pin length, or optionally over at least 95 percent of the pin length.

Example Ex37: The aerosol-generating system according to any one of examples Ex32 to Ex36, wherein the pin cross-sectional area is the pin cross-sectional area measured at the position 50% of the pin length from the end of the tip.

Example Ex38: The aerosol-generating system according to any one of examples Ex32 to Ex37, wherein the pin cross-sectional area is greater than or equal to 4.9 millimetres squared.

Example Ex39: The aerosol-generating system according to any one of examples Ex32 to Ex38, wherein the pin cross-sectional area is less than or equal to 7.1 millimetres squared.

Example Ex40: The aerosol-generating system according to any one of examples Ex32 to Ex39, wherein the pin cross-sectional area is between 4.9 millimetres squared and 7.1 millimetres squared.

Example Ex41: The aerosol-generating system according to any one of examples Ex32 to Ex40, wherein the ratio of the rod cross-sectional area to the pin cross sectional area is less than or equal to 7.9, optionally less than or equal to 7.5, optionally less than or equal to 7.0, optionally less than or equal to 6.5, optionally less than or equal to 6.0, optionally less than or equal to 5.5, optionally less than or equal to 5.0, optionally less than or equal to 4.5, optionally less than or equal to 4.0, optionally less than or equal to 3.5, or optionally less than or equal to 3.0.

Example Ex42: The aerosol-generating system according to any one of examples Ex32 to Ex41, wherein the ratio of the rod cross-sectional area to the pin cross sectional area is greater than or equal to 2.8, optionally greater than or equal to 3.0, optionally greater than or equal to 3.5, optionally greater than or equal to 4.0, optionally greater than or equal to 4.5, optionally greater than or equal to 5.0, optionally greater than or equal to 5.5, optionally greater than or equal to 6.0, optionally greater than or equal to 6.5, optionally greater than or equal to 7.0, or optionally greater than or equal to 7.5.

Example Ex43: The aerosol-generating system according to any one of examples Ex32 to Ex42, wherein the ratio of the rod cross-sectional area to the pin cross-sectional area is between 2.8 and 7.9.

Example Ex44: The aerosol-generating system according to any of the preceding examples, wherein the rod of aerosol-generating substrate has one of: a polygonal cross-sectional shape, a substantially triangular cross-sectional shape, a substantially oval cross-sectional shape, a substantially rectangular cross-sectional shape, and a substantially circular cross-sectional shape, and preferably the rod of aerosol-generating substrate has a substantially circular cross-sectional shape.

Example Ex45: The aerosol-generating system according to any of the preceding examples, wherein the rod of aerosol-generating substrate has a rod length, and wherein the rod length is greater than or equal to 1 millimetre, optionally greater than or equal to 3 millimetres, optionally greater than or equal to 5 millimetres, optionally greater than or equal to 7 millimetres, optionally greater than or equal to 9 millimetres, optionally greater than or equal to 10 millimetres, optionally greater than or equal to 11 millimetres, optionally greater than or equal to 12 millimetres, optionally greater than or equal to 13 millimetres, optionally greater than or equal to 14 millimetres, optionally greater than or equal to 15 millimetres, optionally greater than or equal to 16 millimetres, optionally greater than or equal to 18 millimetres, optionally greater than or equal to 20 millimetres, optionally greater than or equal to 22 millimetres, optionally greater than or equal to 25 millimetres, or optionally greater than or equal to 28 millimetres.

Example Ex46: The aerosol-generating system according to any of the preceding examples, wherein the rod of aerosol-generating substrate has a rod length, and wherein the rod length is less than or equal to 3 millimetres, optionally less than or equal to 5 millimetres, optionally less than or equal to 7 millimetres, optionally less than or equal to 9 millimetres, optionally less than or equal to 10 millimetres, optionally less than or equal to 11 millimetres, optionally less than or equal to 12 millimetres, optionally less than or equal to 13 millimetres, optionally less than or equal to 14 millimetres, optionally less than or equal to 15 millimetres, optionally less than or equal to 16 millimetres, optionally less than or equal to 18 millimetres, optionally less than or equal to 20 millimetres, optionally less than or equal to 22 millimetres, optionally less than or equal to 25 millimetres, or optionally less than or equal to 30 millimetres.

Example Ex47: The aerosol-generating system according to any of the preceding examples, wherein the rod of aerosol-generating substrate has a rod length, and wherein the rod length is between 1 millimetre and 30 millimetres, optionally between 5 millimetre and 22 millimetres, optionally between 8 millimetres and 16 millimetres, optionally between 9 millimetres and 15 millimetres, optionally between 10 millimetres and 14 millimetres, optionally between 11 millimetres and 13 millimetres, or optionally about 12 millimetres.

Example Ex48: The aerosol-generating system according to any of the preceding examples, wherein the rod of aerosol-generating substrate has a rod width and a rod length, and wherein the ratio of the rod width and the rod length is between 0.25 and 0.60, optionally between 0.30 and 0.60, optionally between 0.35 and 0.60, optionally between 0.40 and 0.60, optionally between 0.45 and 0.60, optionally between 0.50 and 0.60, optionally between 0.25 and 0.56, optionally between 0.30 and 0.56, optionally between 0.35 and 0.56, optionally between 0.40 and 0.56, optionally between 0.45 and 0.56, optionally between 0.50 and 0.56, optionally between 0.25 and 0.50, optionally between 0.25 and 0.40, or optionally between 0.35 and 0.50.

Example Ex49: The aerosol-generating system according to any of the preceding examples, wherein the rod of aerosol-generating substrate has a rod volume of greater than or equal to 235 cubic millimetres, optionally greater than or equal to 265 cubic millimetres, greater than or equal to 306 cubic millimetres, optionally greater than or equal to 351 cubic millimetres, optionally greater than or equal to 374 cubic millimetres, optionally greater than or equal to 423 cubic millimetres, or optionally greater than or equal to 462 cubic millimetres.

Example Ex50: The aerosol-generating system according to any of the preceding examples, wherein the rod of aerosol-generating substrate has a rod volume of less than or equal to 462 cubic millimetres, optionally less than or equal to 423 cubic millimetres, optionally less than or equal to 374 cubic millimetres, optionally less than or equal to 351 cubic millimetres, optionally less than or equal to 306 cubic millimetres, optionally less than or equal to 265 cubic millimetres, or optionally less than or equal to 235 cubic millimetres.

Example Ex51: The aerosol-generating system according to any of the preceding examples, wherein the rod of aerosol-generating substrate has a rod volume of between 235 cubic millimetres and 462 cubic millimetres.

Example Ex52: The aerosol-generating system according to any of the preceding examples, wherein the mass of aerosol-generating substrate in the rod of aerosol-generating substrate is less than or equal to 300 milligrams, optionally less than or equal to 280 milligrams, optionally less than or equal to 270 milligrams, optionally less than or equal to 260 milligrams, optionally less than or equal to 250 milligrams, and preferably wherein the mass of aerosol-generating substrate in the rod of aerosol-generating substrate is less than or equal to 220 milligrams, optionally less than or equal to 210 milligrams, or optionally less than or equal to 200 milligrams.

Example Ex53: The aerosol-generating system according to any of the preceding examples, wherein the mass of aerosol-generating substrate in the rod of aerosol-generating substrate is between 10 milligrams and 300 milligrams, optionally between 50 milligrams and 280 milligrams, optionally between 100 milligrams and 270 milligrams, and preferably wherein the mass of aerosol-generating substrate in the rod of aerosol-generating substrate is between 10 milligrams and 220 milligrams, optionally between 50 milligrams and 220 milligrams, optionally between 100 milligrams and 220 milligrams, or optionally between 150 milligrams and 200 milligrams.

Example Ex54: The aerosol-generating system according to any of the preceding examples, wherein the mass of the rod of aerosol-generating substrate is less than or equal to 300 milligrams, optionally less than or equal to 280 milligrams, optionally less than or equal to 270 milligrams, optionally less than or equal to 260 milligrams, optionally less than or equal to 250 milligrams, and preferably wherein the mass of the rod of aerosol-generating substrate is less than or equal to 220 milligrams, more preferably less than or equal to 210 milligrams, and more preferably less than or equal to 200 milligrams.

Example Ex55: The aerosol-generating system according to any of the preceding examples, wherein the mass of the rod of aerosol-generating substrate is between 10 milligrams and 300 milligrams, optionally between 50 milligrams and 280 milligrams, optionally between 100 milligrams and 270 milligrams, and preferably wherein the mass of the rod of aerosol-generating substrate is between 10 milligrams and 220 milligrams, more preferably between 50 milligrams and 220 milligrams, more preferably between 100 milligrams and 220 milligrams, and more preferably between 150 milligrams and 200 milligrams.

Example Ex56: The aerosol-generating system according to any of the preceding examples, wherein the density of aerosol-generating substrate in the rod of aerosol-generating substrate before the pin heating element is inserted into the rod is at least one of:
less than or equal to 500 kilograms per cubic metre (0.50 milligrams per cubic millimetre), optionally less than or equal to 450 kilograms per cubic metre (0.45 milligrams per cubic millimetre), optionally less than or equal to 400 kilograms per cubic metre (0.40 milligrams per cubic millimetre), or optionally less than or equal to 350 kilograms per cubic metre (0.35 milligrams per cubic millimetre), and
greater than or equal to 350 kilograms per cubic metre (0.35 milligrams per cubic millimetre), optionally greater than or equal to 400 kilograms per cubic metre (0.40 milligrams per cubic millimetre), or optionally greater than or equal to 450 kilograms per cubic metre (0.45 milligrams per cubic millimetre).

Example Ex57: The aerosol-generating system according to any of the preceding examples, wherein the density of aerosol-generating substrate in the rod of aerosol-generating substrate before the pin heating element is inserted into the rod is between 350 kilograms per cubic metre (0.35 milligrams per cubic millimetre) and 400 kilograms per cubic metre (0.40 milligrams per cubic millimetre), optionally between 350 kilograms per cubic metre (0.35 milligrams per cubic millimetre) and 450 kilograms per cubic metre (0.45 milligrams per cubic millimetre), optionally between 350 kilograms per cubic metre (0.35 milligrams per cubic millimetre) and 500 kilograms per cubic metre (0.50 milligrams per cubic millimetre), optionally between 400 kilograms per cubic metre (0.40 milligrams per cubic millimetre) and 450 kilograms per cubic metre (0.45 milligrams per cubic millimetre), optionally between 400 kilograms per cubic metre (0.40 milligrams per cubic millimetre) and 500 kilograms per cubic metre (0.50 milligrams per cubic millimetre), or optionally between 450 kilograms per cubic metre (0.45 milligrams per cubic millimetre) and 500 kilograms per cubic metre (0.50 milligrams per cubic millimetre).

Example Ex58: The aerosol-generating system according to any of the preceding examples, wherein the density of the rod of aerosol-generating substrate before the pin heating element is inserted into the rod is at least one of:
less than or equal to 500 kilograms per cubic metre (0.50 milligrams per cubic millimetre), optionally less than or equal to 450 kilograms per cubic metre (0.45 milligrams per cubic millimetre), optionally less than or equal to 400 kilograms per cubic metre (0.40 milligrams per cubic millimetre), or optionally less than or equal to 350 kilograms per cubic metre (0.35 milligrams per cubic millimetre), and
greater than or equal to 350 kilograms per cubic metre (0.35 milligrams per cubic millimetre), optionally greater than or equal to 400 kilograms per cubic metre (0.40 milligrams per cubic millimetre), or optionally greater than or equal to 450 kilograms per cubic metre (0.45 milligrams per cubic millimetre).

Example Ex59: The aerosol-generating system according to any of the preceding examples, wherein the density of the rod aerosol-generating substrate before the pin heating element is inserted into the rod is between 350 kilograms per cubic metre (0.35 milligrams per cubic millimetre) and 400 kilograms per cubic metre (0.40 milligrams per cubic millimetre), optionally between 350 kilograms per cubic metre (0.35 milligrams per cubic millimetre) and 450 kilograms per cubic metre (0.45 milligrams per cubic millimetre), optionally between 350 kilograms per cubic metre (0.35 milligrams per cubic millimetre) and 500 kilograms per cubic metre (0.50 milligrams per cubic millimetre), optionally between 400 kilograms per cubic metre (0.40 milligrams per cubic millimetre) and 450 kilograms per cubic metre (0.45 milligrams per cubic millimetre), optionally between 400 kilograms per cubic metre (0.40 milligrams per cubic millimetre) and 500 kilograms per cubic metre (0.50 milligrams per cubic millimetre), or optionally between 450 kilograms per cubic metre (0.45 milligrams per cubic millimetre) and 500 kilograms per cubic metre (0.50 milligrams per cubic millimetre).

Example Ex60: The aerosol-generating system according to any of the preceding examples, wherein the increase in density of the aerosol-generating substrate in the rod of aerosol-generating substrate from a state in which the pin heating element is not inserted into the rod to a state in which the pin heating element is fully inserted into the rod is greater than or equal to 10 kilograms per cubic metre (0.01 milligrams per cubic millimetre), optionally greater than or equal to 20 kilograms per cubic metre (0.02 milligrams per cubic millimetre), optionally greater than or equal to 30 kilograms per cubic metre (0.03 milligrams per cubic millimetre), optionally greater than or equal to 40 kilograms per cubic metre (0.04 milligrams per cubic millimetre), optionally greater than or equal to 50 kilograms per cubic metre (0.05 milligrams per cubic millimetre), optionally greater than or equal to 60 kilograms per cubic metre (0.06 milligrams per cubic millimetre), optionally greater than or equal to 70 kilograms per cubic metre (0.07 milligrams per cubic millimetre), optionally greater than or equal to 80 kilograms per cubic metre (0.08 milligrams per cubic millimetre), optionally greater than or equal to 90 kilograms per cubic metre (0.09 milligrams per cubic millimetre), optionally greater than or equal to 100 kilograms per cubic metre (0.10 milligrams per cubic millimetre), optionally greater than or equal to 150 kilograms per cubic metre (0.15 milligrams per cubic millimetre), optionally greater than or equal to 200 kilograms per cubic metre (0.20 milligrams per cubic millimetre), optionally greater than or equal to 250 kilograms per cubic metre (0.25 milligrams per cubic millimetre), optionally greater than or equal to 300 kilograms per cubic metre (0.30 milligrams per cubic millimetre), optionally greater than or equal to 350 kilograms per cubic metre (0.35 milligrams per cubic millimetre), optionally greater than or equal to 400 kilograms per cubic metre (0.40 milligrams per cubic millimetre), or optionally greater than or equal to 450 kilograms per cubic metre (0.45 milligrams per cubic millimetre).

Example Ex61: The aerosol-generating system according to any of the preceding examples, wherein the increase in density of the aerosol-generating substrate in the rod of aerosol-generating substrate from a state in which the pin heating element is not inserted into the rod to a state in which the pin heating element is fully inserted into the rod is less than or equal to 500 kilograms per cubic metre (0.50 milligrams per cubic millimetre), optionally less than or equal to 450 kilograms per cubic metre (0.45 milligrams per cubic millimetre), optionally less than or equal to 400 kilograms per cubic metre (0.40 milligrams per cubic millimetre), optionally less than or equal to 350 kilograms per cubic metre (0.35 milligrams per cubic millimetre), optionally less than or equal to 300 kilograms per cubic metre (0.30 milligrams per cubic millimetre), optionally less than or equal to 250 kilograms per cubic metre (0.25 milligrams per cubic millimetre), optionally less than or equal to 200 kilograms per cubic metre (0.20 milligrams per cubic millimetre), optionally less than or equal to 150 kilograms per cubic metre (0.15 milligrams per cubic millimetre), optionally less than or equal to 100 kilograms per cubic metre (0.10 milligrams per cubic millimetre), optionally less than or equal to 90 kilograms per cubic metre (0.09 milligrams per cubic millimetre), optionally less than or equal to 80 kilograms per cubic metre (0.08 milligrams per cubic millimetre), optionally less than or equal to 70 kilograms per cubic metre (0.07 milligrams per cubic millimetre), optionally less than or equal to 60 kilograms per cubic metre (0.06 milligrams per cubic millimetre), optionally less than or equal to 50 kilograms per cubic metre (0.05 milligrams per cubic millimetre), optionally less than or equal to 40 kilograms per cubic metre (0.04 milligrams per cubic millimetre), optionally less than or equal to 30 kilograms per cubic metre (0.03 milligrams per cubic millimetre), or optionally less than or equal to 20 kilograms per cubic metre (0.02 milligrams per cubic millimetre).

Example Ex62: The aerosol-generating system according to any of the preceding examples, wherein the density of aerosol-generating substrate in the rod of aerosol-generating substrate when the pin heating element is fully inserted into the rod is at least one of:
less than or equal to 550 kilograms per cubic metre (0.55 milligrams per cubic millimetre), less than or equal to 500 kilograms per cubic metre (0.50 milligrams per cubic millimetre), optionally less than or equal to 450 kilograms per cubic metre (0.45 milligrams per cubic millimetre), optionally less than or equal to 400 kilograms per cubic metre (0.40 milligrams per cubic millimetre), or optionally less than or equal to 350 kilograms per cubic metre (0.35 milligrams per cubic millimetre), and
greater than or equal to 350 kilograms per cubic metre (0.35 milligrams per cubic millimetre), optionally greater than or equal to 400 kilograms per cubic metre (0.40 milligrams per cubic millimetre), optionally greater than or equal to 450 kilograms per cubic metre (0.45milligrams per cubic millimetre), optionally greater than or equal to 500 kilograms per cubic metre (0.50 milligrams per cubic millimetre).

Example Ex63: The aerosol-generating system according to any of the preceding examples, wherein the increase in density of the rod of aerosol-generating substrate from a state in which the pin heating element is not inserted into the rod to a state in which the pin heating element is fully inserted into the rod is greater than or equal to 10 kilograms per cubic metre (0.01 milligrams per cubic millimetre), optionally greater than or equal to 20 kilograms per cubic metre (0.02 milligrams per cubic millimetre), optionally greater than or equal to 30 kilograms per cubic metre (0.03 milligrams per cubic millimetre), optionally greater than or equal to 40 kilograms per cubic metre (0.04 milligrams per cubic millimetre), optionally greater than or equal to 50 kilograms per cubic metre (0.05 milligrams per cubic millimetre), optionally greater than or equal to 60 kilograms per cubic metre (0.06 milligrams per cubic millimetre), optionally greater than or equal to 70 kilograms per cubic metre (0.07 milligrams per cubic millimetre), optionally greater than or equal to 80 kilograms per cubic metre (0.08 milligrams per cubic millimetre), optionally greater than or equal to 90 kilograms per cubic metre (0.09 milligrams per cubic millimetre), optionally greater than or equal to 100 kilograms per cubic metre (0.10 milligrams per cubic millimetre), optionally greater than or equal to 150 kilograms per cubic metre (0.15 milligrams per cubic millimetre), optionally greater than or equal to 200 kilograms per cubic metre (0.20 milligrams per cubic millimetre), optionally greater than or equal to 250 kilograms per cubic metre (0.25 milligrams per cubic millimetre), optionally greater than or equal to 300 kilograms per cubic metre (0.30 milligrams per cubic millimetre), optionally greater than or equal to 350 kilograms per cubic metre (0.35 milligrams per cubic millimetre), optionally greater than or equal to 400 kilograms per cubic metre (0.40 milligrams per cubic millimetre), or optionally greater than or equal to 450 kilograms per cubic metre (0.45 milligrams per cubic millimetre).

Example Ex64: The aerosol-generating system according to any of the preceding examples, wherein the increase in density of the rod of aerosol-generating substrate from a state in which the pin heating element is not inserted into the rod to a state in which the pin heating element is fully inserted into the rod is less than or equal to 500 kilograms per cubic metre (0.50 milligrams per cubic millimetre), optionally less than or equal to 450 kilograms per cubic metre (0.45 milligrams per cubic millimetre), optionally less than or equal to 400 kilograms per cubic metre (0.40 milligrams per cubic millimetre), optionally less than or equal to 350 kilograms per cubic metre (0.35 milligrams per cubic millimetre), optionally less than or equal to 300 kilograms per cubic metre (0.30 milligrams per cubic millimetre), optionally less than or equal to 250 kilograms per cubic metre (0.25 milligrams per cubic millimetre), optionally less than or equal to 200 kilograms per cubic metre (0.20 milligrams per cubic millimetre), optionally less than or equal to 150 kilograms per cubic metre (0.15 milligrams per cubic millimetre), optionally less than or equal to 100 kilograms per cubic metre (0.10 milligrams per cubic millimetre) optionally less than or equal to 90 kilograms per cubic metre (0.09 milligrams per cubic millimetre), optionally less than or equal to 80 kilograms per cubic metre (0.08 milligrams per cubic millimetre), optionally less than or equal to 70 kilograms per cubic metre (0.07 milligrams per cubic millimetre), optionally less than or equal to 60 kilograms per cubic metre (0.06 milligrams per cubic millimetre), optionally less than or equal to 50 kilograms per cubic metre (0.05 milligrams per cubic millimetre), optionally less than or equal to 40 kilograms per cubic metre (0.04 milligrams per cubic millimetre), optionally less than or equal to 30 kilograms per cubic metre (0.03 milligrams per cubic millimetre), or optionally less than or equal to 20 kilograms per cubic metre (0.02 milligrams per cubic millimetre).

Example Ex65: The aerosol-generating system according to any of the preceding examples, wherein the density of the rod of aerosol-generating substrate when the pin heating element is fully inserted into the rod is at least one of:
less than or equal to 550 kilograms per cubic metre (0.55 milligrams per cubic millimetre), less than or equal to 500 kilograms per cubic metre (0.50 milligrams per cubic millimetre), optionally less than or equal to 450 kilograms per cubic metre (0.45 milligrams per cubic millimetre), optionally less than or equal to 400 kilograms per cubic metre (0.40 milligrams per cubic millimetre), or optionally less than or equal to 350 kilograms per cubic metre (0.35 milligrams per cubic millimetre), and
greater than or equal to 350 kilograms per cubic metre (0.35 milligrams per cubic millimetre), optionally greater than or equal to 400 kilograms per cubic metre (0.40 milligrams per cubic millimetre), optionally greater than or equal to 450 kilograms per cubic metre (0.45 milligrams per cubic millimetre), or optionally greater than or equal to 500 kilograms per cubic metre (0.50 milligrams per cubic millimetre).

Example Ex66: The aerosol-generating system according to any of the preceding examples, wherein the pin has one of: a polygonal cross-sectional shape, a substantially oval cross-sectional shape, a substantially triangular cross-sectional shape, a substantially rectangular cross-sectional shape, and a substantially circular cross-sectional shape, and wherein preferably the pin has a substantially circular cross-sectional shape.

Example Ex67: The aerosol-generating system according to any of the preceding examples, wherein the pin has a tip, and optionally the tip is one of tapered, pointed or sharpened towards the end of the tip.

Example Ex68: The aerosol-generating system according to example Ex67, wherein the tip is configured to penetrate the rod of aerosol-generating substrate.

Example Ex69: The aerosol-generating system according to any of the preceding examples, wherein the pin has a pin length of greater than or equal to 1 millimetre, optionally greater than or equal to 3 millimetres, optionally greater than or equal to 5 millimetres, optionally greater than or equal to 7 millimetres, optionally greater than or equal to 9 millimetres, optionally greater than or equal to 10 millimetres, optionally greater than or equal to 11 millimetres, optionally greater than or equal to 12 millimetres, optionally greater than or equal to 13 millimetres, optionally greater than or equal to 14 millimetres, optionally greater than or equal to 15 millimetres, optionally greater than or equal to 16 millimetres, optionally greater than or equal to 18 millimetres, optionally greater than or equal to 20 millimetres, optionally greater than or equal to 22 millimetres, optionally greater than or equal to 25 millimetres, or optionally greater than or equal to 28 millimetres.

Example Ex70: The aerosol-generating system according to any of the preceding examples, wherein the pin has a pin length of less than or equal to 3 millimetres, optionally less than or equal to 5 millimetres, optionally less than or equal to 7 millimetres, optionally less than or equal to 9 millimetres, optionally less than or equal to 10 millimetres, optionally less than or equal to 11 millimetres, optionally less than or equal to 12 millimetres, optionally less than or equal to 13 millimetres, optionally less than or equal to 14 millimetres, optionally less than or equal to 15 millimetres, optionally less than or equal to 16 millimetres, optionally less than or equal to 18 millimetres, optionally less than or equal to 20 millimetres, optionally less than or equal to 22 millimetres, optionally less than or equal to 25 millimetres, or optionally less than or equal to 30 millimetres.

Example Ex71: The aerosol-generating system according to any of the preceding examples, wherein the pin has a pin length of between 1 millimetre and 30 millimetres, optionally between 5 millimetres and 22 millimetres,, optionally between 8 millimetres and 16 millimetres, optionally between 9 millimetres and 15 millimetres, optionally between 10 millimetres and 14 millimetres, optionally between 11 millimetres and 13 millimetres or optionally about 12 millimetres.

Example Ex72: The aerosol-generating system according to any of the preceding examples, wherein the pin has a pin length and the rod of aerosol-generating substrate has a rod length, and wherein the pin length is less than or equal to the rod length.

Example Ex73: The aerosol-generating system according to any of the preceding examples, wherein the rod of aerosol-generating substrate has a rod length, and wherein the pin has a pin length of less than or equal to 99 percent of the rod length, optionally less than or equal to 95 percent of the rod length, optionally less than or equal to 90 percent of the rod length, optionally less than or equal to 85 percent of the rod length, optionally less than or equal to 80 percent of the rod length, optionally less than or equal to 70 percent of the rod length, optionally less than or equal to 60 percent of the rod length, or optionally less than or equal to 50 percent of the rod length.

Example Ex74: The aerosol-generating system according to any of the preceding examples, wherein the rod of aerosol-generating substrate has a rod length, and wherein the pin has a pin length greater than or equal to 50 percent of the rod length, optionally greater than or equal to 60 percent of the rod length, optionally greater than or equal to 70 percent of the rod length, optionally greater than or equal to 80 percent of the rod length, optionally greater than or equal to 85 percent of the rod length, optionally greater than or equal to 90 percent of the rod length, optionally greater than equal to 95 percent of the rod length, or optionally greater than equal to 99 percent of the rod length.

Example Ex75: The aerosol-generating system according to any of the preceding examples, wherein the rod of aerosol-generating substrate has a rod length, and wherein the pin has a pin length is between 70 percent and 99 percent of the rod length, optionally between 75 percent and 95 percent of the rod length, optionally between 80 percent and 95 percent of the rod length, or optionally between 85 percent and 95 percent of the rod length.

Example Ex76: The aerosol-generating system according to any of the preceding examples, wherein the pin has a pin volume of greater than or equal to 59 cubic millimetres, optionally greater than or equal to 64 cubic millimetres, optionally greater than or equal to 69 cubic millimetres, optionally greater than or equal to 74 cubic millimetres, optionally greater than or equal to 79 cubic millimetres or optionally greater than or equal to 84 cubic millimetres.

Example Ex77: The aerosol-generating system according to any of the preceding examples, wherein the pin has a pin volume of less than or equal to 84 cubic millimetres, optionally less than or equal to 79 cubic millimetres, optionally less than or equal to 74 cubic millimetres, optionally less than or equal to 69 cubic millimetres, or optionally less than or equal to 64 cubic millimetres.

Example Ex78: The aerosol-generating system according to any of the preceding examples, wherein the pin has a pin volume of between 59 cubic millimetres and 84 cubic millimetres.

Example Ex79: The aerosol-generating system according to any of the preceding examples, wherein the aerosol-generating substrate comprises homogenised tobacco material, optionally the aerosol-generating substrate comprises a gathered sheet of homogenised tobacco material, optionally wherein the homogenized tobacco material is a cast sheet.

Example Ex80: The aerosol-generating system according to any of the preceding examples, wherein the aerosol-generating substrate comprises a gathered, crimped sheet of homogenised tobacco material.

Example Ex81: The aerosol-generating system according to example Ex79 or Ex80, wherein the homogenized tobacco material is formed in a casting process, and comprises, prior to the casting process, tobacco particles having an average particle size (D95) of more than 50 micrometres, optionally between 50 micrometres and 100 micrometres, optionally between 60 micrometres and 80 micrometres, optionally between 65 micrometres and 75 micrometres, and optionally about 70 micrometres.

Example Ex82: The aerosol-generating system according to any of the preceding examples, wherein the aerosol-generating substrate comprises tobacco material, between about 1 percent and about 5 percent of a binder, and between about 10 percent and about 30 percent of glycerine, on a dry weight basis.

Example Ex83: The aerosol-generating system according to any of the preceding examples, wherein the aerosol-generating substrate comprises tobacco cut filler and optionally an aerosol-former content in the aerosol-generating substrate is at least about 8 percent on a dry weight basis.

Example Ex84: The aerosol-generating system according to any of the preceding examples, wherein the aerosol-generating substrate comprises at least one of strands and crimped fibre pieces of reconstituted or reprocessed tobacco.

Example Ex85: The aerosol-generating system according to any of the preceding examples, wherein the aerosol-generating substrate comprises: a solid aerosol-generating substrate comprising nicotine, one or more cellulose based agents, one or more aerosol formers, and one or more carboxylic acids.

Example Ex86: The aerosol-generating system according to any of the preceding examples, wherein the solid aerosol-generating substrate is one of a solid aerosol-generating film or a solid aerosol-generating gel.

Example Ex87: The aerosol-generating system according to any of the preceding examples, wherein the aerosol-generating article has an article length of between 40 millimetres and 90 millimetres, optionally between 50 millimetres and 90 millimetres, optionally between 60 millimetres and 90 millimetres, optionally between 70 millimetres and 90 millimetres, optionally between 50 millimetres and 85 millimetres, optionally between 60 millimetres and 85 millimetres, optionally between 70 millimetres and 85 millimetres, optionally between 50 millimetres and 80 millimetres, optionally between 60 millimetres and 80 millimetres, optionally between 70 millimetres and 80 millimetres, or optionally about 75 millimetres.

Example Ex88: The aerosol-generating system according to any of the preceding examples, wherein the aerosol-generating article has an article length of between 40 millimetres and 70 millimetres, optionally between 45 millimetres and 70 millimetres, optionally between 40 millimetres and 60 millimetres, optionally between 45 millimetres and 60 millimetres, optionally between 40 millimetres and 50 millimetres, optionally between 45 millimetres and 50 millimetres, or optionally about 45 millimetres.

Example Ex89: The aerosol-generating system according to any of the preceding examples, wherein the rod of aerosol-generating substrate has a rod length and the aerosol-generating article has an article length, and wherein the ratio between the rod length and the article length is between 0.20 and 0.60, optionally between 0.20 and 0.55, optionally between 0.20 and 0.50, optionally between 0.25 and 0.60, optionally between 0.25 and 0.55, optionally between 0.25 and 0.50, optionally between 0.30 and 0.60, optionally between 0.30 and 0.55, or optionally between 0.30 and 0.50.

Example Ex90: The aerosol-generating system according to any of the preceding examples, wherein the aerosol-generating article comprises ventilation holes.

Example Ex91: The aerosol-generating system according to any of the preceding examples, wherein the aerosol-generating article has a ventilation level of at least 40 percent, optionally at least 45 percent, optionally at least 50 percent, optionally at least 50 percent, optionally at least 60 percent, optionally at least 70 percent, optionally less than or equal to 90 percent, optionally less than or equal to 85 percent, optionally less than 80 percent, optionally between 40 percent and 90 percent, optionally between 50 percent and 90 percent or optionally between 60 percent and 90 percent, or optionally about 75 percent.

Example Ex92: The aerosol-generating system according to any of the preceding examples, wherein the resistance to draw of the aerosol-generating article is between 10 millimetres of water gauge and 70 millimetres of water gauge, optionally between 20 millimetres of water gauge and 65 millimetres of water gauge, optionally between 30 millimetres of water gauge and 60 millimetres of water gauge, optionally between 35 millimetres of water gauge and 55 millimetres of water gauge, and optionally between 40 millimetres of water gauge and 50 millimetres of water gauge.

Example Ex93: The aerosol-generating system according to any of the preceding examples, wherein the aerosol-generating article further comprises a downstream section located downstream of the rod of aerosol-generating substrate, wherein optionally the downstream section extends between the rod of aerosol-generating substrate and a downstream end of the aerosol-generating article, and optionally wherein the downstream section comprises one or more elements.

Example Ex94: The aerosol-generating system according to example Ex93, wherein the downstream section has a downstream section length that is greater than or equal to 10 millimetres, optionally greater than or equal to 20 millimetres, optionally greater than or equal to 25 millimetres, or optionally greater than or equal to 30 millimetres.

Example Ex95: The aerosol-generating system according to example Ex93 or Ex94, wherein the downstream section has a downstream section length that is less than or equal to 70 millimetres, optionally less than or equal to 60 millimetres, or optionally less than or equal to 50 millimetres.

Example Ex96: The aerosol-generating system according to any one of examples Ex93 to Ex95, wherein the downstream section has a downstream section length that is between 10 millimetres and 70 millimetres, optionally between 20 millimetres and 60 millimetres, or optionally between 30 millimetres and 50 millimetres.

Example Ex97: The aerosol-generating system according to any one of examples Ex93 to Ex96, wherein the resistance to draw of the downstream section is at least 0 millimetres of water gauge, optionally at least 3 millimetres of water gauge, or optionally at least 6 millimetres of water gauge.

Example Ex98: The aerosol-generating system according to any one of examples Ex93 to Ex97, wherein the resistance to draw of the downstream section is less than or equal to 12 millimetres of water gauge, optionally less than or equal to 11 millimetres of water gauge, or optionally less than or equal to 10 millimetres of water gauge.

Example Ex99: The aerosol-generating system according to any one of examples Ex93 to Ex98, wherein the resistance to draw of the downstream section is between 0 millimetres of water gauge and 12 millimetres of water gauge, optionally between 3 millimetres of water gauge and 11 millimetres of water gauge, or optionally between 6 millimetres of water gauge and 10 millimetres of water gauge.

Example Ex100: The aerosol-generating system according to any one of examples Ex93 to Ex99, wherein the downstream section comprises one or more hollow tubular elements.

Example Ex101: The aerosol-generating system according to any of the preceding examples, wherein the aerosol-generating article comprises one or more hollow tubular elements, and optionally wherein the one or more hollow tubular elements is provided downstream of the rod of aerosol-forming substrate.

Example Ex102: The aerosol-generating system according to example Ex100 or Ex101, wherein one of the one or more hollow tubular elements abuts a downstream end of the rod of aerosol-generating substrate.

Example Ex103: The aerosol-generating system according to any one of examples Ex100 to Ex102, wherein one of the one or more hollow tubular elements has a hollow tubular element length that is between 15 millimetres and 50 millimetres, optionally between 20 millimetres and 45 millimetres, optionally between 20 millimetres and 40 millimetres, optionally between 20 millimetres and 30 millimetres, optionally between 25 millimetres and 40 millimetres, or optionally about 26 millimetres.

Example Ex104: The aerosol-generating system according to any one of examples Ex100 to Ex103, wherein one of the one or more hollow tubular element has a wall thickness, and wherein the wall thickness of the hollow tubular element is between 100 micrometres and 2 millimetres, optionally between 150 micrometres and 1.5 millimetres, or optionally between 200 micrometres and 1.25 millimetres.

Example Ex105: The aerosol-generating system according to any one of examples Ex100 to Ex104, wherein the aerosol-generating article has an article external width, one of the one or more hollow tubular elements has a hollow tubular element external width, and the hollow tubular element external width is approximately equal to the article external width.

Example Ex106: The aerosol-generating system according to any one of examples Ex100 to Ex105, wherein one of the one or more hollow tubular elements has a lumen, and optionally wherein the lumen of the hollow tubular element has a substantially circular cross sectional shape.

Example Ex107: The aerosol-generating system according to any one of examples Ex100 to Ex106, wherein one of the one or more hollow tubular elements is formed from at least one of: cardboard, paper, a polymeric material, a cellulosic material, cellulose acetate, low density polyethylene (LDPE), and polyhydroxyalkanoate (PHA).

Example Ex108: The aerosol-generating system according to any one of examples Ex100 to Ex107, wherein the one or more hollow tubular elements comprise one or both of a hollow acetate tube (HAT) and a fine hollow acetate tube (FHAT).

Example Ex109: The aerosol-generating system according to any one of examples Ex100 to Ex108, wherein the one or more hollow tubular elements comprise a HAT and a FHAT, optionally wherein the FHAT is arranged downstream of the HAT, and optionally wherein the inner diameter of the FHAT is larger than the inner diameter of the HAT.

Example Ex110: The aerosol-generating system according to example Ex109, wherein the HAT has a HAT length, and wherein the HAT length is between 6 millimetres and 10 millimetres, optionally between 7 millimetres and 9 millimetres, or optionally about 8 millimetres.

Example Ex111: The aerosol-generating system according to any one of examples Ex100 to Ex110, wherein the resistance to draw of one of the one or more hollow tubular elements is less than or equal to 10 millimetres of water gauge, optionally less than or equal to 5 millimetres of water gauge, optionally less than or equal to 2.5 millimetres of water gauge, optionally less than or equal to 2 millimetres of water gauge, or optionally less than or equal to 1 millimetre of water gauge.

Example Ex112: The aerosol-generating system according to any one of examples Ex100 to Ex111, wherein the resistance to draw of one of the one or more hollow tubular elements is at least 0 millimetres of water gauge, optionally at least 0.25 millimetres of water gauge, optionally at least 0.5 millimetres of water gauge or optionally at least 1 millimetre of water gauge.

Example Ex113: The aerosol-generating system according to any one of examples Ex100 to Ex112, wherein the aerosol-generating article further comprises a PLA (poly lactic acid) plug, and optionally wherein the PLA plug is downstream of one of the one or more hollow tubular elements.

Example Ex114: The aerosol-generating system according to any one of examples Ex100 to Ex113, wherein one of the one or more hollow tubular elements comprises a hollow tubular cooling element.

Examples EX115: The aerosol-generating system according to any one of examples Ex100 to Ex114, wherein one of the one or more hollow tubular elements comprises a hollow tubular support element.

Example Ex116: The aerosol-generating system according to any one of examples Ex100 to Ex115, wherein the one or more hollow tubular elements comprise a hollow tubular support element upstream of a hollow tubular cooling element, optionally the hollow tubular support element abuts the downstream end of the rod of aerosol-generating substrate, and optionally the hollow tubular support element abuts the upstream end of the hollow tubular cooling element.

Example Ex117: The aerosol-generating system according to example Ex115 or Ex116, wherein the hollow tubular support element is formed from one or more materials selected from the group consisting of: cellulose acetate; cardboard; crimped paper, such as crimped heat resistant paper or crimped parchment paper; and polymeric materials, such as low density polyethylene (LDPE).

Example Ex118: The aerosol-generating system according to any one of examples Ex100 to Ex117, wherein the aerosol-generating article comprises a ventilation zone at a location along the one or more hollow tubular elements, optionally wherein the ventilation zone comprises a plurality of perforations or holes through the wall of one or more of the one or more hollow tubular elements.

Example Ex119: The aerosol-generating system according to any of the preceding examples, wherein the aerosol-generating article comprises a tubular element comprising: a tubular body defining a cavity extending from a first end of the tubular body to a second end of the tubular body; and a folded end portion forming a first end wall at the first end of the tubular body, the first end wall delimiting an opening for airflow between the cavity and the exterior of the tubular element.

Example Ex120: The aerosol-generating system according to any of the preceding examples, wherein the aerosol-generating article comprises a mouthpiece element.

Example Ex121: The aerosol-generating system according to example Ex120, wherein the mouthpiece element is located at the downstream end of the aerosol-generating article.

Example Ex122: The aerosol-generating system according to any one of examples Ex93 to Ex121, wherein the downstream section comprises a mouthpiece element.

Example Ex123: The aerosol-generating system according to any one of examples Ex120 to Ex122, wherein the mouthpiece element is located downstream of at least one of the one or more hollow tubular elements.

Example Ex124: The aerosol-generating system according to any one of examples Ex120 to Ex123, wherein the mouthpiece element is formed of a fibrous filtration material, and optionally wherein the mouthpiece element is formed of cellulose acetate.

Example Ex125: The aerosol-generating system according to any one of examples Ex120 to Ex124, wherein the mouthpiece element has a length of greater than or equal to 5 millimetres, or preferably greater than or equal to 10 millimetres.

Example Ex126: The aerosol-generating system according to any one of examples Ex120 to Ex125, wherein the mouthpiece element has a length of less than 25 millimetres, or preferably less than 20 millimetres.

Example Ex127: The aerosol-generating system according to any one of examples Ex120 to Ex126, wherein the mouthpiece element has a mouthpiece length of between 5 millimetres and 25 millimetres, between 10 millimetres and 25 millimetres, between 5 millimetres and 20 millimetres, between 10 millimetres and 20 millimetres, between 10 millimetres and 14 millimetres, between 11 millimetres and 13 millimetres, or about 12 millimetres.

Example Ex128: The aerosol-generating system according to any one of examples Ex120 to Ex127, wherein the mouthpiece element has a mouthpiece length of between 5 millimetres and 10 millimetres, between 6 millimetres and 8 millimetres, or about 7 millimetres.

Example Ex129: The aerosol-generating system according to any one of examples Ex120 to Ex128, wherein the resistance to draw of the mouthpiece element per millimetre length along a longitudinal direction of the aerosol-generating article is between 0.1 millimetre of water gauge and 20 millimetres of water gauge, optionally between 0.2 millimetre of water gauge and 10 millimetres of water gauge, optionally between 0.5 millimetre of water gauge and 5 millimetres of water gauge, optionally between 1 millimetre of water gauge and 2 millimetres of water gauge, optionally between 1.3 millimetres of water gauge and 1.7 millimetres of water gauge, optionally between 1.4 millimetre of water gauge and 1.6 millimetres of water gauge or optionally about 1.5 millimetres of water gauge.

Example Ex130: The aerosol-generating system according to any one of examples Ex120 to Ex129, wherein the resistance to draw of the mouthpiece element is between 1 millimetre of water gauge and 100 millimetres of water gauge, optionally between 2 millimetres of water gauge and 50 millimetres of water gauge, optionally between 5 millimetres of water gauge and 40 millimetres of water gauge, optionally between 10 millimetres of water gauge and 30 millimetres of water gauge, optionally between 16 millimetres of water gauge and 20 millimetres of water gauge, optionally between 17 millimetres of water gauge and 19 millimetres of water gauge, or optionally about 18 millimetres of water gauge.

Example Ex131: The aerosol-generating system according to any one of examples Ex120 to Ex130, wherein the resistance to draw of the mouthpiece element is between 1 millimetre of water gauge and 60 millimetres of water gauge, optionally between 2 millimetres of water gauge and 30 millimetres of water gauge, optionally between 4 millimetres of water gauge and 25 millimetres of water gauge, optionally between 5 millimetres of water gauge and 18 millimetres of water gauge, optionally between 6 millimetres of water gauge and 13 millimetres of water gauge, optionally between 9 millimetres of water gauge and 12 millimetres of water gauge, or optionally about 10.5 millimetres of water gauge.

Example Ex132: The aerosol-generating system according to any of the preceding examples, wherein the aerosol-generating article further comprising a substrate wrapper at least partly circumscribing the rod of aerosol-generating substrate, and optionally the substrate wrapper comprises one or more layers having the same length in a longitudinal direction of the aerosol-generating article.

Example Ex133: The aerosol-generating system according to example Ex132, wherein the substrate wrapper has a thickness of at least 50 micrometres, optionally at least 60 micrometres, optionally at least 70 micrometres, optionally at least 75 micrometres, optionally at least 80 micrometres, optionally at least 90 micrometres, optionally at least 100 micrometres, optionally at least 110 micrometres, optionally at least 120 micrometres, optionally at least 130 micrometres, optionally at least 140 micrometres, optionally at least 145 micrometres, or optionally at least 150 micrometres.

Example Ex134: The aerosol-generating system according to example Ex132 or Ex133, wherein the ratio of substrate wrapper thickness to the rod width is between 1:120 and 1:20 (0.0083 and 0.050), optionally between 1:100 and 1:30 (0.010 and 0.030), optionally between 1:80 and 1:35 (0.013 and 0.029), and optionally between 1:60 and 1:40 (0.017 and 0.025).

Example Ex135: The aerosol-generating system according to any one of examples Ex132 to Ex134, wherein the wrapper has a density of less than or equal to 800 kilograms per cubic metre, optionally less than or equal to 750 kilograms per cubic metre, optionally less than or equal to 700 kilograms per cubic metre, optionally less than or equal to 650 kilograms per cubic metre, optionally less than or equal to 600 kilograms per cubic metre, optionally less than or equal to 550 kilograms per cubic metre, optionally less than or equal to 500 kilograms per cubic metre, optionally less than or equal to 450 kilograms per cubic metre, optionally less than or equal to 400 kilograms per cubic metre, optionally less than or equal to 350 kilograms per cubic metre, or optionally is about 320 kilograms per cubic metre.

Example Ex136: The aerosol-generating system according to any one of examples Ex132 to Ex135, wherein the substrate wrapper comprises one or more of cardboard, plastics, and metal foil.

Example Ex137: The aerosol-generating system according to any one of examples Ex132 to Ex136, wherein the substrate wrapper comprises a cellulosic material, preferably selected from one or more of paper, wood, textile, natural fibres, and artificial fibres.

Example Ex138: The aerosol-generating system according to any of the preceding examples, wherein the aerosol-generating article further comprising an outer wrapper at least partly circumscribing the other elements of the aerosol-generating article, optionally the outer wrapper extends the entire length of the aerosol-generating article, optionally the outer wrapper comprises tipping paper.

Example Ex139: The aerosol-generating system according to any of the preceding examples, wherein the aerosol-generating device further comprises a device cavity configured to receive at least a part of the aerosol-generating article.

Example Ex140: The aerosol-generating system according to example Ex139, wherein the device cavity has a closed end and an open end, wherein optionally wherein the aerosol-generating article is insertable into the device cavity via the open end, and optionally the device cavity has substantially the same cross-sectional shape as the aerosol-generating article.

Example Ex141: The aerosol-generating system according to example Ex139 or Ex140, wherein the rod of aerosol-generating substrate has a rod length, and wherein the device cavity has a cavity length that is the same as or greater than the rod length, and optionally the cavity length is such that when the aerosol-generating article is received with the aerosol-generating device at least 75 percent of the rod length is received within the device cavity, optionally at least 80 percent, or at least 90 percent of the length of the rod of aerosol-generating substrate is received within the device cavity.

Example Ex142: The aerosol-generating system according to any of the preceding examples, wherein when the aerosol-generating article is received by the aerosol-generating device, the pin penetrates the rod of aerosol-generating substrate substantially through the centre of a cross-sectional face of the rod perpendicular to the rod length.

Example Ex143: The aerosol-generating system according to any of the preceding examples, wherein the pin comprises one of a resistive heating element and a susceptor element.

Example Ex144: The aerosol-generating system according to any of the preceding examples, wherein the pin comprises a resistive heating element.

Example Ex145: The aerosol-generating system according to any one of examples Ex1 to Ex143, wherein the aerosol-generating device comprises an inductor coil, optionally wherein the inductor coil at least partly circumscribes the device cavity, and optionally wherein the inductor coil is arranged to coaxially circumscribe the device cavity.

Example Ex146: The aerosol-generating system according to example Ex145, wherein the pin comprises a susceptor element and the inductor coil is arranged to inductively heat the pin.

Example Ex147: The aerosol-generating system according to any of the preceding examples, wherein, the aerosol-generating device further comprises a controller.

Example Ex148: The aerosol-generating system according to example Ex147, wherein during use, the controller is configured to control the heating element such that the operating temperature range of the heating element is between 150 degrees Celsius and 350 degrees Celsius, and optionally wherein the operating temperature range of the heating element is between 200 degrees Celsius and 330 degrees Celsius, and optionally wherein the operating temperature range is between 260 degrees Celsius and 320 degrees Celsius.

Example Ex149: The aerosol-generating system according to example Ex147 or Ex148, wherein during use, the controller is configured to control the heating element such that the heating element is heated to a peak temperature of less than or equal to 350 degrees Celsius, optionally less than or equal to 335 degrees Celsius, or optionally less than or equal to 320 degrees Celsius.

Example Ex150: The aerosol-generating system according to any one of examples Ex147 to Ex149, wherein during use, the controller is configured to control the heating element such that the heating element is heated to a peak temperature of between 220 degrees Celsius and 350 degrees Celsius, optionally between 240 degrees Celsius and 335 degrees Celsius, or optionally between 260 degrees Celsius and 320 degrees Celsius.

Example Ex151: The aerosol-generating system according to any of the preceding examples, wherein, the aerosol-generating device further comprises a power supply, and optionally wherein the power supply is a battery.

The invention will now be further described, by way of example only, with reference to the accompanying drawings in which:

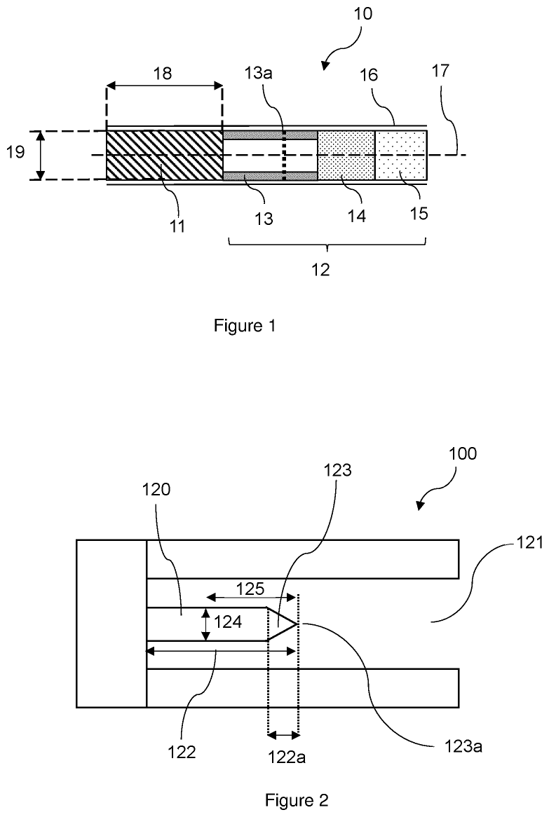

FIG. 1 is a cross-sectional view of an aerosol-generating article according to a first embodiment of the disclosure.

FIG. 2 is a cross-sectional view of an aerosol-generating device according to a first embodiment of the disclosure.

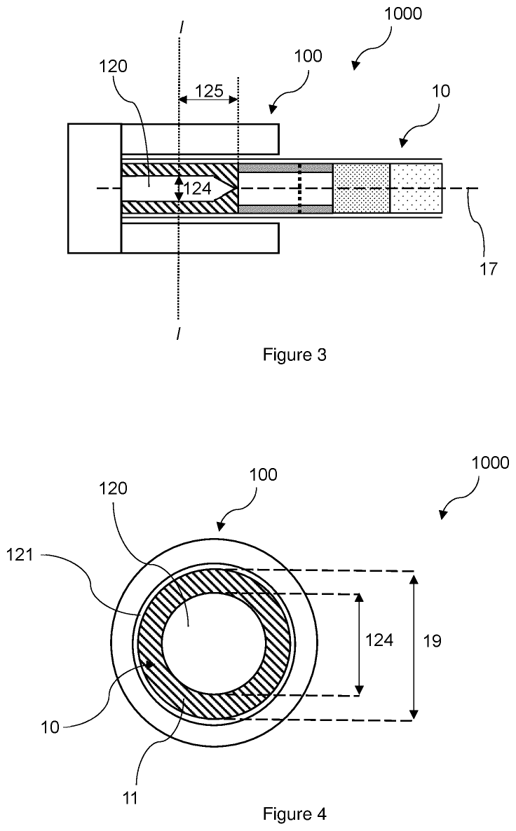

FIG. 3 is a cross-sectional view of an aerosol-generating system comprising the aerosol-generating article of FIG. 1 and the aerosol-generating device of FIG. 2.

FIG. 4 is a cross-sectional view of the aerosol-generating system of FIG. 3 along the plane I-I.

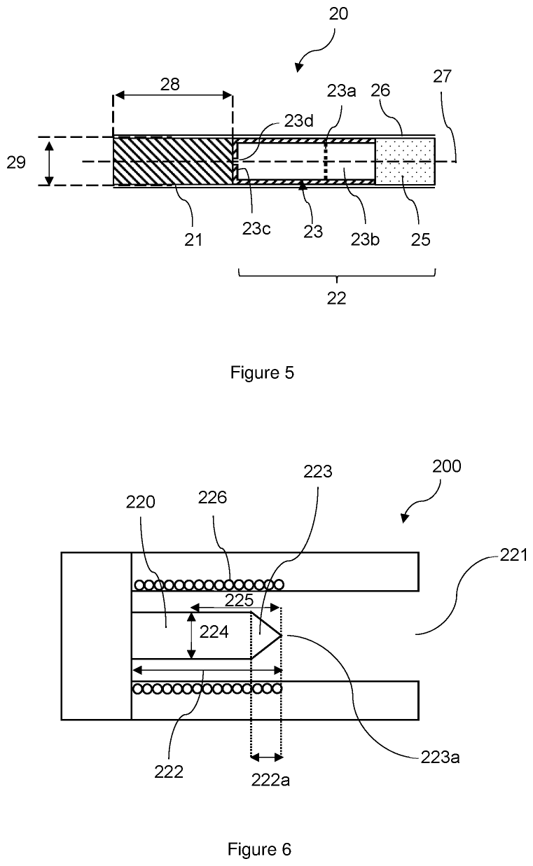

FIG. 5 is a cross-sectional view of an aerosol-generating article according to a second embodiment of the disclosure.

FIG. 6 is a cross-sectional view of an aerosol-generating device according to a second embodiment of the disclosure.

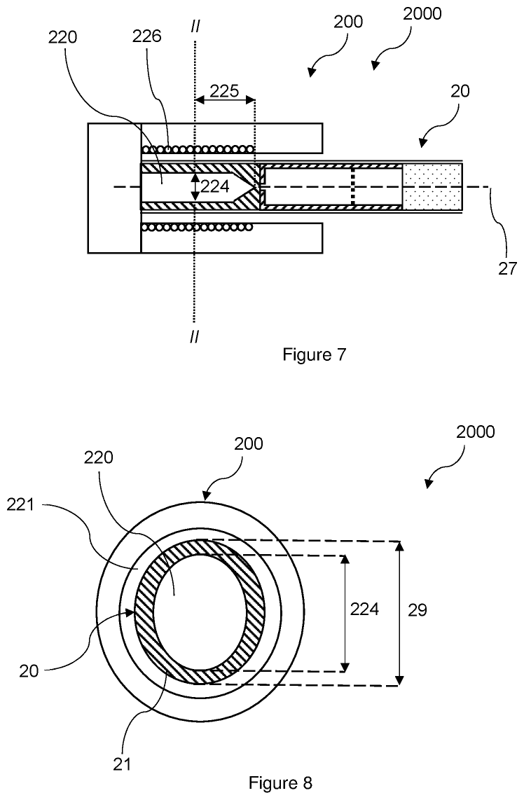

FIG. 7 is a cross-sectional view of an aerosol-generating system comprising the aerosol-generating article of FIG. 5 and the aerosol-generating device of FIG. 6.

FIG. 8 is a cross-sectional view of the aerosol-generating system of FIG. 7 along the plane II-II.

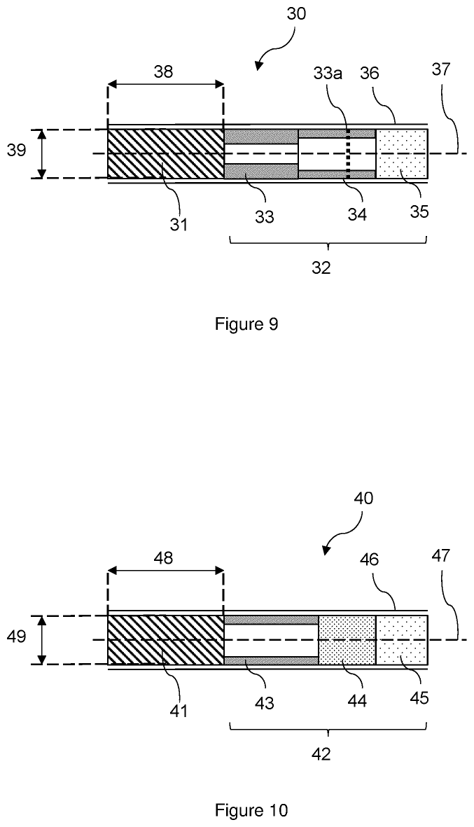

FIG. 9 is a cross-sectional view of an aerosol-generating article according to a third embodiment of the disclosure.

FIG. 10 is a cross-sectional view of an aerosol-generating article according to a fourth embodiment of the disclosure.

FIG. 1 shows a schematic cross-sectional view of an aerosol-generating article 10. The aerosol-generating article 10 has a substantially cylindrical shape along its length. The aerosol-generating article 10 comprises a rod of aerosol-generating substrate 11 at a distal end of the article 10. The rod of aerosol-generating substrate 11 has a substantially cylindrical shape along its length, and comprises a gathered sheet of homogenised tobacco. The article further comprises a downstream section 12, located downstream of the rod of aerosol-forming substrate 11. The downstream section 12 comprises a hollow tubular cooling element 13, a PLA (poly lactic acid) plug 14, and a mouth end filter 15. The mouth-end filter 15 is at a proximal end of the article 10. A longitudinal axis 17 extends centrally along a longitudinal direction of the aerosol-generating article 10. The rod of aerosol-forming substrate 11, the hollow tubular cooling element 13, the PLA plug 14, and the mouth-end filter 15 are arranged end-to-end along the longitudinal axis 17, and are circumscribed by an outer wrapper 16, which extends along the entire length of the aerosol-generating article 10. It will be appreciated that in other embodiments the outer wrapper may not extend along the entire length of the aerosol-generating article and, for example, may not circumscribe the mouth-end filter. The downstream section 12 and the outer wrapper 16 are described in more detail below.

The rod of aerosol-generating substrate 11 has a rod length 18 parallel to the longitudinal axis 17 of the aerosol-generating article 10. The rod of aerosol-generating substrate 11 has a rod width 19 perpendicular to the longitudinal axis 17 of the aerosol-generating article 10. The rod width 19 is measured at a position 50% along the rod length 18 from an end of the rod of aerosol-generating substrate 11. In other words, the rod width 19 is measured at a position halfway along the length of the rod of aerosol-generating substrate 11. The rod width 19 is substantially uniform along the rod length 18. In this example, the rod width 19 is 7 millimetres. In this example, the rod length 18 is 12 millimetres. In this example, the ratio of the rod width 19 to the rod length 18 is 0.583. In this example, the mass of the rod of aerosol-generating substrate 11 is 220 milligrams, and the density of the rod of aerosol-generating substrate 11 before the pin 120 is inserted into the rod of aerosol-generating substrate 11 is 476 kilograms per cubic metre (0.48 milligrams per cubic millimetre). The length of the aerosol-generating article is 45 millimetres. The ratio of the rod length 18 to the length of the aerosol-generating article 10 is 0.267.

As mentioned above, the downstream section 12 comprises a mouth-end filter 15, PLA (poly lactic acid) plug 14, and a hollow tubular cooling element 13. The downstream section 12 extends between the rod of aerosol-generating substrate 11 and the downstream end of the aerosol-generating article 10. The downstream section 12 has a length of 33 millimetres.

The PLA plug 14 is downstream of the hollow tubular cooling element 13. The hollow tubular cooling element 13 is a hollow acetate tube. The hollow tubular cooling element 13 abuts the downstream end of the rod of aerosol-generating substrate 11. The combined length of the hollow tubular cooling element 13 and the PLA plug 14 is about 26 millimetres. The hollow tubular cooling element 13 comprises a lumen. The lumen of the hollow tubular cooling element 13 has a substantially circular cross-sectional shape. The wall thickness of the hollow tubular cooling element 13 is 0.25 millimetres. The external diameter of the hollow tubular cooling element 13 is 7 millimetres. The RTD of the hollow tubular cooling element 13 is about 0 millimetres of water gauge. The hollow tubular cooling element 13 comprises a ventilation zone at a location along the hollow tubular cooling element 13. The ventilation zone comprises one or more rows of ventilation holes 13a arranged circumferentially around the hollow tubular cooling element 13 in a cross-section that is substantially perpendicular to the longitudinal axis 17 of the aerosol-generating article 10. The ventilation holes 13a are perforations through the wall of the hollow tubular cooling element 13. A ventilation level of the aerosol-generating article 10 is about 75 percent. Each circumferential row of ventilation holes 13a comprises from 8 to 30 holes.

The mouth-end filter 15 is located at a downstream end of the aerosol-generating article 10. The mouth-end filter 15 abuts the downstream end of the PLA plug 14. The mouth-end filter 15 comprises a low-density, cellulose acetate filter segment. The RTD of the mouth-end filter 15 is about 8 millimetres of water gauge. The length of the mouth-end filter 15 is about 7 millimetres.

The outer wrapper 16 is made of a tipping paper. The outer wrapper 16 does not extend beyond the ends of the aerosol-generating article 10 in a direction parallel to the longitudinal axis 17. The ventilation holes 13a extend through the outer wrapper 16 in a direction perpendicular to the longitudinal axis 17.

FIG. 2 shows a schematic cross-sectional view of a portion an aerosol-generating device 100 comprising a heating element in the form of a pin 120. The pin 120 is a resistive heating element. The pin 120 is mounted within a device cavity 121. The device cavity 121 is configured to receive at least a part of the aerosol-generating article 10. The distal end of the device cavity 121 has a closed end. The proximal end of the device cavity 121 has an open end. The aerosol-generating article 10 is insertable into the device cavity 121 via the open end of the device cavity 121.

In use, the user inserts the aerosol-generating article 10 into the device cavity 121 of the aerosol-generating device 100, such that the pin 120 is inserted into the rod of aerosol-generating substrate 11 of the aerosol-generating article 10.

The pin 120 has a pin length 122 which extends from the end 123a of a tip 123 of the pin 120 to a base of the pin 120, at the opposite end. The pin length 122 is substantially the same as the rod length 18. The pin length 122 is about 12 millimetres. The tip of the pin has a tip length 122a. In this example, the tip length 122a is 1.5 millimetres.

The pin 120 has a pin width 124 perpendicular to the pin length 122. The pin width 124 is measured at a distance 125 from the end of the tip 123 of the pin 120. In this example, the distance 125 from the end of the tip 123 of the pin 120 is 4 millimetres. In this example, the pin width 124 at a distance of 4 millimetres from the end of the tip 123 is 2.5 millimetres. The pin width 124 is substantially uniform along the length of the pin 120, when the tip 123 of the pin 120 is excluded.

The tip 123 of the pin 120 is tapered towards the end of the pin 123a, such that the tip 123 of the pin 120 is configured to penetrate the rod of aerosol-generating substrate 11 (as shown in FIG. 3).

The aerosol-generating device 100 further comprises a power supply (not shown) and electronics (not shown) that allow the pin 120 to be actuated to heat the rod of aerosol-forming substrate 11 when the aerosol-generating article 10 is received in the device cavity 121. Such actuation may be manually operated or may occur automatically in response to a user drawing on the aerosol-generating article 10 when the aerosol-generating article 10 is inserted into the device cavity 121.

FIG. 3 shows a cross-sectional view of a portion of an aerosol-generating system 1000 comprising the aerosol-generating article 10 of FIG. 1 and the aerosol-generating device 100 of FIG. 2. In FIG. 3, a portion of the aerosol-generating article 10 is received in the device cavity 121 of the aerosol-generating device 10, and the pin 120 penetrates the rod of aerosol-generating substrate 11 along the longitudinal axis 17 of the aerosol-generating article. The device cavity 121 has a length parallel to the longitudinal axis 17 that is greater than the rod length 13. The entire length of the rod of aerosol-generating substrate 11 is received in the device cavity 121. The ventilation holes 13a of the hollow tubular element 13 are not received in the device cavity 121. During use, the pin 120 is controlled to operate within a defined operating temperature range, below a maximum operating temperature. The operating temperature range of the pin 120 is about 350 degrees Celsius.

FIG. 4 shows a cross-sectional view of the portion of the aerosol-generating system 1000 of FIG. 3 along the plane I-I. The rod width 19 and the pin width 124 are also shown in FIG. 4. The rod of aerosol-generating substrate 11 has a rod cross-sectional area perpendicular to the rod length 18. The rod cross-sectional area is measured at a position 50% along the rod length 18 from an end of the rod of aerosol-generating substrate 11. In this example, the rod cross-sectional area is 38.5 millimetres squared. In this example, the rod of aerosol-generating substrate 11 has a substantially circular cross-sectional shape along its entire length 18, and so the rod cross-sectional area is substantially uniform along the rod length 18.

The pin 120 has a pin cross-sectional area perpendicular to the pin length 122. The pin cross-sectional area is measured at a distance 125 from the end 123a of the tip 123 of the pin 120. As discussed above, the pin width 124 at a distance of 4 millimetres from the end 123a of the tip 123 is 2.5 millimetres. In this example, the pin cross-sectional area at a distance of 4 millimetres from the end 123a of the tip 123 is 4.91 millimetres squared. The pin 120 has a substantially circular cross-sectional shape at a distance of 4 millimetres from the end 123a of the tip 123. Therefore, in this example, the minimum transverse pin dimension is equal to the pin width. In this example, the ratio of the rod width 19 to the pin width 124 is 2.8. In this example, the ratio of the rod cross-sectional area to the pin cross-sectional area is 7.84. The cross-sectional shape of the pin at a distance of 4 millimetres from the end 123a of the tip 123 is substantially the same as the rod cross-sectional shape.

The device cavity 121 has a substantially circular cross-sectional shape. The device cavity 121 has substantially the same cross-sectional shape as the rod of aerosol-generating substrate 11. As shown in FIG. 4, when the pin 120 penetrates the rod of aerosol-generating substrate 11, the pin 120 penetrates the rod of aerosol-generating substrate 11 substantially through the centre of the cross-section of the rod of aerosol-generating substrate 11.

FIG. 5 shows a schematic cross-sectional view of an aerosol-generating article 20. The aerosol-generating article 20 has a substantially oval cross-sectional shape along its length. It will be appreciated that articles having other cross-sectional shapes along their length are possible, such as a substantially circular cross-sectional shapes, substantially square cross-sectional shapes, and substantially triangular cross-sectional shapes.

The aerosol-generating article 20 comprises a rod of aerosol-generating substrate 21 at a distal end of the article 20. The rod of aerosol-generating substrate 21 has a substantially cylindrical shape with an oval cross-section along its length, similar to the cross-section of the article 20, and comprises a gathered, crimped sheet of homogenised tobacco.

The article 20 further comprises a downstream section 22, located downstream of the rod of aerosol-forming substrate 21. The downstream section 22 comprises a mouth end filter 25. The mouth-end filter 25 is at a proximal end of the article 20. A longitudinal axis 27 extends centrally along a longitudinal direction of the aerosol-generating article 20. The downstream section 22 also comprises a tubular element 23 comprising a tubular body defining a cavity 23b extending from an upstream end of the tubular body to a downstream end of the tubular body. The tubular element (hereinafter referred to as a flanged tube 23) also comprises a folded end portion forming an upstream end wall 23c at the upstream end of the tubular body.

The rod of aerosol-forming substrate 21, the flanged tube 23 and the mouth-end filter 25 are arranged end-to-end along the longitudinal axis 27, and are circumscribed by an outer wrapper 26, which extends along the entire length of the aerosol-generating article 20. It will be appreciated that in other embodiments the outer wrapper may not extend along the entire length of the aerosol-generating article and, for example, may not circumscribe the mouth-end filter. The downstream section 22 and the outer wrapper 26 are described in more detail below.

The rod of aerosol-generating substrate 21 has a rod length 28 parallel to the longitudinal axis 27 of the aerosol-generating article 20. The rod of aerosol-generating substrate 21 has a rod width 29 perpendicular to the longitudinal axis 27 of the aerosol-generating article 20. The rod width 29 is measured at a position 50% along the rod length 28 from an end of the rod of aerosol-generating substrate 21. In other words, the rod width 29 is measured at a position halfway along the length of the rod of aerosol-generating substrate 21. As will be discussed in greater detail with reference to FIG. 8, the rod of aerosol-generating substrate 21 has a substantially oval cross-sectional shape. In other words, the rod width 29 refers to the maximum dimension of the rod of aerosol-generating substrate 21 parallel to the major axis of the oval cross-section of the rod of aerosol-generating substrate 21 measured at a position 50% along the rod length 28 from an end of the rod of aerosol-generating substrate 21. The rod width 29 is substantially uniform along the rod length 28. In this example, the rod width 29 is 6.3 millimetres. As will be discussed in further detail below, the cross-sectional dimension of the rod of aerosol-generating substrate 21 perpendicular to the rod width 29 is 6.1 millimetres. In this example, the rod length 28 is 12 millimetres. In this example, the ratio of the rod width 29 to the rod length 28 is 0.525. In this example, the mass of the rod of aerosol-generating substrate 21 is 180 milligrams, and the density of the rod of aerosol-generating substrate 21 before the pin 220 is inserted into the rod of aerosol-generating substrate 21 is 497 kilograms per cubic metre (0.50 milligrams per cubic millimetre). The length of the aerosol-generating article is 45 millimetres. The ratio of the rod length 28 to the length of the aerosol-generating article 20 is 0.267.

As mentioned above, the downstream section 22 comprises a mouth-end filter 25 and a flanged tube 23. The downstream section 22 extends between the rod of aerosol-generating substrate 21 and the downstream end of the aerosol-generating article 20. The downstream section 22 has a length of 33 millimetres.

The flanged tube 23 abuts the downstream end of the rod of aerosol-generating substrate 21. The upstream end wall 23c of the flanged tube 23 delimits an opening 23d, which permits airflow between the cavity 23b and the exterior of the flanged tube 23. In particular, aerosol may flow from the rod of aerosol-generating substrate 21 through the opening 23d into the cavity 23b. The cavity 23b of the flanged tube 23 is substantially empty, and so substantially unrestricted airflow is enabled along the cavity 23b. Consequently, the RTD of the flanged tube 23 can be localised at a specific longitudinal position of the flanged tube 23—namely, at the upstream end wall 23c—and can be controlled through the chosen configuration of the upstream end wall 23c and its corresponding opening 23d. In this example, the RTD of the flanged tube 23 (which is essentially the RTD of the upstream end wall 23c) is about 10 millimetres of water gauge.

The upstream end wall 23c extends substantially transverse to the longitudinal axis 27 of the aerosol-generating article 20. The opening 23d is the only opening in the upstream end wall 23c and the opening 23d is positioned in a generally radially central position of the flanged tube 23. Consequently, the upstream end wall 23c is generally annular shaped. The combination of the upstream end wall 23c and its corresponding opening 23d provide an effective barrier arrangement which may restrict movement of the rod of aerosol-generating substrate 21, whilst also enabling aerosol to flow from the rod of aerosol-generating substrate 21 through the opening 23d into the cavity 23b.

The flanged tube 23 has a length of about 26 millimetres, an external width of about 6.3 millimetres, and an internal width of about 5.6 millimetres. Thus, a thickness of a peripheral wall of flanged tube 23 is about 0.7 millimetres. The flanged tube 23 is formed from a paper material, such as paper, paperboard or cardboard. In this example, the cavity 23b of the flanged tube 23 has a substantially oval cross-sectional shape. It will be appreciated that other cross-sectional shapes are possible for the flanged tube, such as a substantially circular cross-sectional shape. The flanged tube 23 comprises a ventilation zone at a location along the flanged tube 23. The ventilation zone comprises one or more rows of ventilation holes 23a arranged circumferentially around the hollow tube in a cross-section that is substantially perpendicular to the longitudinal axis 27 of the aerosol-generating article 20. The ventilation holes 23a are perforations through the wall of the flanged tube 23. A ventilation level of the aerosol-generating article 20 is about 75 percent. Each circumferential row of ventilation holes 23a comprises from 8 to 30 holes.

The mouth-end filter 25 is located at a downstream end of the aerosol-generating article 10. The mouth-end filter 25 abuts the flanged tube 23. The mouth-end filter 25 comprises a low-density, cellulose acetate filter segment. The RTD of the mouth-end filter 25 is about 8 millimetres of water gauge. The length of the mouth-end filter 25 is about 7 millimetres.

The outer wrapper 26 is made of a tipping paper. The outer wrapper 26 does not extend beyond the ends of the aerosol-generating article 20 in a direction parallel to the longitudinal axis 27. The ventilation holes 23a extend through the outer wrapper 26 in a direction perpendicular to the longitudinal axis 27.

FIG. 6 shows a schematic cross-sectional view of a portion an aerosol-generating device 200 comprising a heating element in the form of a pin 220. In this embodiment, the pin 220 is a susceptor element that is configured to be heated when penetrated by a varying magnetic field. The pin 220 is mounted within a device cavity 221. The aerosol-generating device 200 further comprises an inductor coil 226 which circumscribes the device cavity 221, and surrounds the susceptor pin 220. The inductor coil 226 is arranged to generate a varying magnetic field in the device cavity 221, which penetrates the susceptor pin 220 to inductively heat the susceptor element pin 220. The device cavity 221 is configured to receive at least a part of the aerosol-generating article 20. The distal end of the device cavity 221 has a closed end. The proximal end of the device cavity 221 has an open end. The aerosol-generating article 20 is insertable into the device cavity 221 via the open end of the device cavity 221.

In use, the user inserts the aerosol-generating article 20 into the device cavity 221 of the aerosol-generating device 200, such that the pin 220 is inserted into the rod of aerosol-generating substrate 21 of the aerosol-generating article 20.

The pin 220 has a pin length 222 which extends from an end 223a of the tip 223 of the pin 220 to a base of the pin 220, at the opposite end. The pin length 222 is substantially the same as the rod length 28. The pin length 222 is about 12 millimetres. The tip of the pin has a tip length 222a. In this example, the tip length 222a is 1.5 millimetres.

The pin 220 has a pin width 224 perpendicular to the pin length 222. The pin width 224 is measured at a distance 225 from the end 223a of the tip 223 of the pin 220. In this example, the distance 225 from the end 223a of the tip 223 of the pin 220 is 4 millimetres. In this example, the pin width 224 at a distance of 4 millimetres from the end 223a of the tip 223 is 3 millimetres. As will be discussed in greater detail with reference to FIG. 8, the pin 220 has a substantially oval cross-sectional shape. In other words, the pin width 224 refers to the maximum dimension of the pin 220 parallel to the major axis of the oval cross-section of the pin 220 at a distance of 4 millimetres from the end 223a of the tip 223. The pin width 224 is substantially uniform along the length of the pin 220, when the tip 223 of the pin 220 is excluded.

The tip 223 of the pin 220 is tapered towards the end of the pin 223a, such that the tip 223 of the pin 220 is configured to penetrate the rod of aerosol-generating substrate 21 (as shown in FIG. 7).

The aerosol-generating device 200 further comprises a power supply (not shown) and electronics (not shown) that are arranged to supply power to the inductor coil 226 to generate a varying magnetic field in the device cavity 221 to inductively heat the susceptor pin 220. The susceptor pin 220 heats the rod of aerosol-forming substrate 21 when the aerosol-generating article 20 is received in the device cavity 221. Such actuation of the inductor coil 226 may be manually operated or may occur automatically in response to a user drawing on the aerosol-generating article 20 when the aerosol-generating article 20 is inserted into the device cavity 221.

FIG. 7 shows a cross-sectional view of a portion of an aerosol-generating system 2000 comprising the aerosol-generating article 20 of FIG. 5 and the aerosol-generating device 200 of FIG. 6. In FIG. 7, a portion of the aerosol-generating article 20 is received in the device cavity 221 of the aerosol-generating device 20, and the pin 220 penetrates the rod of aerosol-generating substrate 21 along the longitudinal axis 27 of the aerosol-generating article. The device cavity 221 has a length parallel to the longitudinal axis 27 that is greater than the rod length 23. The entire length of the rod of aerosol-generating substrate 21 is received in the device cavity 221. The ventilation holes 23a of the flanged tube 23 are not received in the device cavity 221. During use, the inductor coil 226 is controlled to heat the susceptor pin 220 within a defined operating temperature range, below a maximum operating temperature. The operating temperature of the susceptor pin 220 is about 350 degrees Celsius.

FIG. 8 shows a cross-sectional view of the portion of the aerosol-generating system 2000 of FIG. 7 along the plane I-I. The rod width 29 and the pin width 224 are also shown in FIG. 8. The rod of aerosol-generating substrate 21 has a rod cross-sectional area perpendicular to the rod length 28. The rod cross-sectional area is measured at a position 50% along the rod length 28 from an end of the rod of aerosol-generating substrate 21. In this example, the rod of aerosol-generating substrate 21 has a substantially oval cross-sectional shape along its entire length 28, and so the rod cross-sectional area is substantially uniform along the rod length 28. In this example, the cross-sectional dimension of the rod of aerosol-generating substrate 21 perpendicular to the width 29 is 6.1 millimetres (that is the dimension of the rod of aerosol-generating substrate 21 parallel to the minor axis of the oval cross-section of the rod of aerosol-generating substrate 21 is 6.1 millimetres). As stated above, the rod width 29 is 6.3 millimetres. Therefore, the rod cross-sectional area is 30.2 millimetres squared. It will be appreciated that in other embodiments the rod may have other cross-sectional shapes, such as a substantially circular shape, triangular shape, or square shape along the length of the rod of aerosol-generating substrate 21.

The pin 220 has a pin cross-sectional area perpendicular to the pin length 222. The pin 220 has a substantially oval cross-sectional shape at a distance of 4 millimetres from the end 223a of the tip 223, but it will be appreciated that other cross-sectional shapes are possible, such as a substantially circular shape at a distance of 4 millimetres from the end 223a of the tip 223. The pin cross-sectional area is measured at a distance 225 from the end 223a of the tip 223 of the pin 220. As discussed above, the pin width 224 at a distance of 4 millimetres from the end 223a of the tip 223 is 3 millimetres. In this example, the minimum transverse pin dimension is the cross-sectional dimension of the pin 220 perpendicular to the pin width 224. In this example, the minimum transverse pin dimension is 2.9 millimetres (that is the dimension of the pin 220 parallel to the minor axis of the oval cross-section of the pin 220 at a distance of 4 millimetres from the end of the tip 223 is 2.9 millimetres). Therefore, the pin cross-sectional area at a distance of 4 millimetres from the end 223a of the tip 223 is 6.83 millimetres squared. In this example, the ratio of the rod width 29 to the pin width 224 is 2.1. In this example, the ratio of the rod cross-sectional area to the pin cross-sectional area is 4.42. The cross-sectional shape of the pin at a distance of 4 millimetres from the end 223a of the tip 223 is substantially the same as the rod cross-sectional shape.

In this embodiment, the device cavity 221 has a substantially oval cross-sectional shape, but it will be appreciated that in other embodiments the device cavity may have other cross-sectional shapes, such as a substantially circular shape, triangular shape, or square shape of the device cavity 221. The device cavity 221 has substantially the same cross-sectional shape as the rod of aerosol-generating substrate 21. As shown in FIG. 8, when the pin 220 penetrates the rod of aerosol-generating substrate 21, the pin 220 penetrates the rod of aerosol-generating substrate 21 substantially through the centre of the cross-section of the rod of aerosol-generating substrate 21.

FIG. 9 shows a schematic cross-sectional view of an aerosol-generating article 30. The aerosol-generating article 30 has a substantially cylindrical shape along its length. The aerosol-generating article 30 comprises a rod of aerosol-generating substrate 31 at a distal end of the article 30. The rod of aerosol-generating substrate 31 has a substantially cylindrical shape along its length, and comprises a gathered sheet of homogenised tobacco. The article further comprises a downstream section 32, located downstream of the rod of aerosol-forming substrate 31. The downstream section 32 comprises a first hollow tubular cooling element 33, a second hollow tubular cooling element 34, and a mouth end filter 35. The mouth-end filter 35 is at a proximal end of the article 30. A longitudinal axis 37 extends centrally along a longitudinal direction of the aerosol-generating article 30. The rod of aerosol-forming substrate 31, the first tubular cooling element 33, the second tubular cooling element 34, and the mouth-end filter 35 are arranged end-to-end along the longitudinal axis 37, and are circumscribed by an outer wrapper 36, which extends along the entire length of the aerosol-generating article 30. The downstream section 32 and the outer wrapper 36 are described in more detail below.

The rod of aerosol-generating substrate 31 has a rod length 38 parallel to the longitudinal axis 37 of the aerosol-generating article 30. The rod of aerosol-generating substrate 31 has a rod width 39 perpendicular to the longitudinal axis 37 of the aerosol-generating article 30. The rod width 39 is measured at a position 50% along the rod length 38 from an end of the rod of aerosol-generating substrate 31. In other words, the rod width 39 is measured at a position halfway along the length of the rod of aerosol-generating substrate 31. The rod width 39 is substantially uniform along the rod length 38. In this example, the rod width 39 is 7 millimetres. In this example, the rod length 38 is 12 millimetres. In this example, the ratio of the rod width 39 to the rod length 38 is 0.583. In this example, the mass of the rod of aerosol-generating substrate 31 is 162 milligrams, and the density of the rod of aerosol-generating substrate 31 before the pin 120 is inserted into the rod of aerosol-generating substrate 31 is 351 kilograms per cubic metre (0.35 milligrams per cubic millimetre). The length of the aerosol-generating article 30 is 45 millimetres. The ratio of the rod length 38 to the length of the aerosol-generating article 30 is 0.267.

As mentioned above, the downstream section 32 comprises a mouth-end filter 35, a second hollow tubular cooling element 34, and a first hollow tubular cooling element 33. The downstream section 32 extends between the rod of aerosol-generating substrate 31 and the downstream end of the aerosol-generating article 30. The downstream section 32 has a length of 33 millimetres.

The second hollow tubular cooling element 34 is downstream of the first hollow tubular cooling element 33. The first hollow tubular cooling element 33 is a hollow acetate tube. The second hollow tubular cooling element 34 is a hollow acetate tube. The first hollow tubular cooling element 33 abuts the downstream end of the rod of aerosol-generating substrate 31. The combined length of the first hollow tubular cooling element 13 and the second hollow tubular cooling element 34 is about 26 millimetres. The first hollow tubular cooling element 33 comprises a lumen. The lumen of the first hollow tubular cooling element 33 has a substantially circular cross-sectional shape. The second hollow tubular cooling element 34 comprises a lumen. The lumen of the second hollow tubular cooling element 34 has a substantially circular cross-sectional shape. The width of the lumen of the second tubular cooling element 34 is larger than the width of the lumen of the first tubular cooling element 33. The wall thickness of the second hollow tubular cooling element 34 is smaller than the wall thickness of the first hollow tubular cooling element 33. The second hollow tubular cooling element may be referred to as a fine hollow acetate tube (FHAT). The wall thickness of the second hollow tubular cooling element 34 is 0.15 millimetres. The wall thickness of the second hollow tubular cooling element 33 is 0.25 millimetres. The external diameter of both the first hollow tubular cooling element 33 and the second hollow tubular cooling element 34 is 7 millimetres. The RTD of the first hollow tubular cooling element 33 and the second hollow tubular cooling element 34 is about 0 millimetres of water gauge. The second hollow tubular cooling element 34 comprises a ventilation zone at a location along the second hollow tubular cooling element 34. It will be appreciated that the ventilation zone could alternatively or in addition be provided at a location along the first hollow tubular cooling element 33. The ventilation zone comprises one or more rows of ventilation holes 33a arranged circumferentially around the second hollow tubular cooling element 34 in a cross-section that is substantially perpendicular to the longitudinal axis 37 of the aerosol-generating article 30. The ventilation holes 33a are perforations through the wall of the second hollow tubular cooling element 34. A ventilation level of the aerosol-generating article 30 is about 75 percent. Each circumferential row of ventilation holes 33a comprises from 8 to 30 holes.

The mouth-end filter 35 is located at a downstream end of the aerosol-generating article 30. The mouth-end filter 35 abuts the downstream end of the second hollow tubular cooling element 34. The mouth-end filter 35 comprises a low-density, cellulose acetate filter segment. The RTD of the mouth-end filter 35 is about 8 millimetres of water gauge. The length of the mouth-end filter 35 is about 7 millimetres.

The outer wrapper 36 is made of a tipping paper. The outer wrapper 36 does not extend beyond the ends of the aerosol-generating article 30 in a direction parallel to the longitudinal axis 37. The ventilation holes 33a extend through the outer wrapper 36 in a direction perpendicular to the longitudinal axis 37.

FIG. 10 shows a schematic cross-sectional view of an aerosol-generating article 40. The aerosol-generating article 40 is substantially the same as the aerosol-generating article 10. The only difference between the aerosol-generating article 40 and the aerosol-generating article 10 is that the aerosol-generating article 40 does not comprise a ventilation zone. Therefore, the aerosol-generating article 40 does not comprise one or more rows of ventilation holes arranged circumferentially around the hollow tubular cooling element 43. The aerosol-generating article 40 comprises a rod of aerosol-generating substrate 41 at a distal end of the article and a downstream section 42 comprising a first hollow tubular cooling element 43, a second hollow tubular cooling element 44, and a mouth end filter 45 at a proximal end of the article 40. A longitudinal axis 47 extends centrally along a longitudinal direction of the aerosol-generating article 40 The rod of aerosol-forming substrate 41, the first tubular cooling element 43, the second tubular cooling element 44, and the mouth-end filter 45 are arranged end-to-end along the longitudinal axis 47, and are circumscribed by an outer wrapper 46, which extends along the entire length of the aerosol-generating article 40.

The rod of aerosol-generating substrate 41 has a rod length 48 parallel to the longitudinal axis 47 of the aerosol-generating article 40. The rod of aerosol-generating substrate 41 has a rod width 49 perpendicular to the longitudinal axis 47 of the aerosol-generating article 40. The rod width 49 is measured at a position 50% along the rod length 48 from an end of the rod of aerosol-generating substrate 41. In other words, the rod width 49 is measured at a position halfway along the length of the rod of aerosol-generating substrate 41. The rod width 49 is substantially uniform along the rod length 48. In this example, the rod width 49 is 7 millimetres. In this example, the rod length 48 is 12 millimetres. In this example, the ratio of the rod width 49 to the rod length 48 is 0.583.

1.-15. (canceled)

16. An aerosol-generating system, comprising:
an aerosol-generating article comprising a rod of aerosol-generating substrate having a rod width of less than or equal to 7 millimetres; and
an aerosol-generating device comprising a heating element in the form of a pin configured for insertion into the rod of aerosol-generating substrate of the aerosol-generating article,
wherein the pin has a pin width that is greater than or equal to 2.5 millimetres.

17. The aerosol-generating system according to claim 16, wherein the rod width is greater than or equal to 5 millimetres.

18. The aerosol-generating system according to claim 16,
wherein the rod of aerosol-generating substrate has a rod length, and
wherein the rod width is measured at a position 50% along the rod length from an end of the rod.

19. The aerosol-generating system according to claim 16,
wherein the rod of aerosol-generating substrate has a rod length, and
wherein the rod of aerosol-generating substrate has a rod-cross-sectional area perpendicular to the rod length.

20. The aerosol-generating system according to claim 19, wherein the rod cross-sectional area is less than or equal to 38.5 millimetres squared.

21. The aerosol-generating system according to claim 19, wherein the rod of aerosol-generating substrate has a rod cross-sectional area that is greater than or equal to 19.6 millimetres squared.

22. The aerosol-generating system according to claim 19, wherein the rod cross-sectional area is measured at a position 50 percent along the length of the rod from an end of the rod.

23. The aerosol-generating system according to claim 16, wherein the pin width is less than or equal to 3.0 millimetres.

24. The aerosol-generating system according to claim 16,
wherein the pin has a tip, and
wherein the pin width is measured at a distance of 4 millimetres from the end of the tip.

25. The aerosol-generating system according to claim 16, wherein at least one of:
a ratio of the rod width to the pin width is greater than or equal to 1.6, and
a ratio of the rod width to the pin width is less than or equal to 2.8.

26. The aerosol-generating system according to claim 16,
wherein the pin has a pin length, and
wherein the pin has a pin cross-sectional area perpendicular to the pin length.

27. The aerosol-generating system according to claim 26, wherein the pin cross-sectional area is greater than or equal to 4.9 millimetres squared.

28. The aerosol-generating system according to claim 26, wherein the pin cross-sectional area is less than or equal to 7.1 millimetres squared.

29. The aerosol-generating system according to claim 26,
wherein the pin has a tip, and
wherein the pin cross-sectional area is measured at a distance of 4 millimetres from the end of the tip.

30. The aerosol-generating system according to claim 16,
wherein the rod of aerosol-generating substrate has a rod length,
wherein the rod of aerosol-generating substrate has a rod-cross-sectional area perpendicular to the rod length,
wherein the pin has a pin length,
wherein the pin has a pin cross-sectional area perpendicular to the pin length, and
wherein at least one of:
a ratio of the rod cross-sectional area to the pin cross sectional area is greater than or equal to 2.8; and
a ratio of the rod cross-sectional area to the pin cross sectional area is less than or equal to 7.9.
